(19) United States
(12) Patent Application Publication
(10) Pub. No.: US 2014/0036032 A1
(43) Pub. Date: Feb. 6, 2014

(54) IMAGE PROCESSING DEVICE, IMAGE PROCESSING METHOD, AND PROGRAM

(71) Applicants: Yoshitomo Takahashi, Kanagawa (JP); Shinobu Hattori, Tokyo (JP)

(72) Inventors: Yoshitomo Takahashi, Kanagawa (JP); Shinobu Hattori, Tokyo (JP)

(73) Assignee: Sony Corporation, Minato-ku (JP)

(21) Appl. No.: 14/004,596

(22) PCT Filed: Mar. 19, 2012
(86) PCT No.: PCT/JP2012/056974

§ 371 Date: Oct. 28, 2013

(30) Foreign Application Priority Data
Mar. 18, 2011 (JP) 2011-061793

(51) Int. Cl. H04N 13/00; H04N 7/26; H04N 7/32

(52) U.S. Cl. CPC H04N 13/0048; H04N 19/00769; H04N 19/0009
USPC 348/43

(57) ABSTRACT

This technology relates to an image processing device, an image processing method, and a program capable of improving an image quality of a decoded image. A correcting unit corrects a pixel value of a decoded image obtained by at least quantizing and inversely quantizing a depth image having a value corresponding to predetermined data such as parallax as a pixel value being the depth image in which a possible value as the pixel value is defined to a predetermined defined value according to a maximum value and a minimum value of the predetermined data to the defined value, for example. This technology is applicable to encoding and decoding of the depth image and the like having depth information regarding the parallax of each pixel of a color image as the pixel value, for example.

### TECHNICAL FIELD

This technology relates to an image processing device, an image processing method, and a program and relates to the image processing device, the image processing method, and the program capable of improving an image quality of a decoded image obtained by at least quantizing and inversely quantizing an image, for example.

### BACKGROUND ART

A coding system to encode images of a plurality of viewpoints such as a 3D (Dimension) image includes an MVC (Multiview Video Coding) system and the like, which is an expanded AVC (Advanced Video Coding) (H.264/AVC) system, for example.

In the MVC system, the image to be encoded is a color image having a value corresponding to light from a subject as a pixel value and each of the color images of a plurality of viewpoints are encoded with reference not only to the color image of the viewpoint but also to the color image of another viewpoint as needed.

That is to say, in the MVC system, the color image of one viewpoint out of the color images of a plurality of viewpoints is made the image of a base view and the color image of another viewpoint is made the image of a dependent view.

The image (color image) of the base view is encoded with reference only to the image of the base view and the image (color image) of the dependent view is encoded with reference not only to the image of the dependent view but also to the image of another dependent view as needed.

Recently, a standard such as MPEG3DV system, for example, is being developed as the coding system to encode the color image of each viewpoint and a parallax information image of each viewpoint by adopting the parallax information image having parallax information regarding parallax of each pixel of the color image of each viewpoint as a pixel value in addition to the color image of each viewpoint as the images of a plurality of viewpoints.

In the MPEG3DV system, it is suggested to encode each of the color image of each viewpoint and the parallax information image of each viewpoint as in the MVC system in principle. In the MPEG3DV system, various types of handling of the parallax information image are suggested (for example, refer to Non-Patent Document 1).

### CITATION LIST

### Non-Patent Document

Non-Patent Document 1: “Draft Call for Proposals on 3D Video Coding Technology”, INTERNATIONAL ORGANISATION FOR STANDARDISATION, ORGANISATION INTERNATIONALE DE NORMALISATION, ISO/IEC JTC1/SC29/WG11, CODING OF MOVING PICTURES AND AUDIO, ISO/IEC JTC1/SC29/WG11, MPEG2010/N11679, Guangzhou, China, October 2010

### SUMMARY OF THE INVENTION

### Problems to be Solved by the Invention

When the parallax information image is encoded and decoded in the same manner as the MVC system, there is a case in which the image quality of the decoded image obtained by the decoding is deteriorated.

This technology is achieved in view of such a condition and an object thereof is to improve the image quality of the decoded image.

### Solutions to Problems

An image processing device or a program according to one aspect of this technology is an image processing device or a program, which allows a computer to serve as the image processing device including a correcting unit, which corrects a pixel value of a decoded image obtained by at least quantizing and inversely quantizing an image having a value corresponding to predetermined data as a pixel value being the image in which a possible value as the pixel value is defined to a predetermined defined value according to a maximum value and a minimum value of the predetermined data to the defined value.

An image processing method according to one aspect of this technology is an image processing method including a step of correcting a pixel value of a decoded image obtained by at least quantizing and inversely quantizing an image having a value corresponding to predetermined data as a pixel value being the image in which a possible value as the pixel value is defined to a predetermined defined value according to a maximum value and a minimum value of the predetermined data to the defined value.

In the above-described one aspect, the pixel value of the decoded image obtained by at least quantizing and inversely quantizing the image having the value corresponding to predetermined data as the pixel value being the image in which the possible value as the pixel value is defined to a predetermined defined value according to the maximum value and the minimum value of the predetermined data is corrected to the defined value.

Meanwhile, the image processing device may be an independent device or may be an internal block, which composes one device.

Also, the program may be provided by being transmitted through a transmitting medium or being recorded on a recording medium.

### Effects of the Invention

According to one aspect of this technology, it is possible to improve the image quality of the decoded image.

### BRIEF DESCRIPTION OF DRAWINGS

FIG. 1 is a block diagram illustrating a configuration example of a multi-view image generating device, which generates images of a plurality of viewpoints.

FIG. 2 is a view illustrating handling of a parallax image.

FIG. 3 is a view for illustrating a summary of this technology.

FIG. 4 is a block diagram illustrating a configuration example of one embodiment of a multi-view image encoder to which this technology is applied.

FIG. 5 is a view illustrating a picture, which is referred to when a predicted image is generated, in predictive encoding in an MVC system.

FIG. 6 is a view illustrating order of encoding (and decoding) of the picture in the MVC system.

FIG. 7 is a block diagram illustrating a configuration example of an encoder 11.

FIG. 8 is a view illustrating a macroblock type in the MVC (AVC) system.

FIG. 9 is a view illustrating a predicted motion vector (PMV) in the MVC (AVC) system.

FIG. 10 is a view illustrating the predicted motion vector (PMV) in the MVC (AVC) system.

FIG. 11 is a block diagram illustrating a configuration example of an encoder 22.

FIG. 12 is a block diagram illustrating a configuration example of a correcting unit 232.

FIG. 13 is a view illustrating an example of mapping information.

FIG. 14 is a flowchart illustrating an encoding process to encode a parallax image D#2 of a viewpoint #2.

FIG. 15 is a flowchart illustrating a correcting process.

FIG. 16 is a flowchart illustrating a pixel value changing process.

FIG. 17 is a flowchart illustrating a pixel value correcting process.

FIG. 18 is a block diagram illustrating a configuration example of one embodiment of a multi-view image decoder to which this technology is applied.

FIG. 19 is a block diagram illustrating a configuration example of a decoder 311.

FIG. 20 is a block diagram illustrating a configuration example of a decoder 322.

FIG. 21 is a block diagram illustrating a configuration example of a correcting unit 462.

FIG. 22 is a flowchart illustrating a decoding process to decode encoded data of the parallax image D#2 of the viewpoint #2.

FIG. 23 is a flowchart illustrating the correcting process.

FIG. 24 is a flowchart illustrating the pixel value correcting process.

FIG. 25 is a view illustrating an example of a predictor flag included in header information.

FIG. 26 is a view illustrating an example of the predictor flag included in the header information.

FIG. 27 is a view illustrating an example of the predictor flag included in the header information.

FIG. 28 is a view illustrating a relationship between correction to a defined value and a dynamic range |dmax−dmin| of a shooting parallax vector d.

FIG. 29 is a view illustrating a relationship between the correction to the defined value and a quantization step of a target block.

FIG. 30 is a block diagram illustrating another configuration example of the encoder 22.

FIG. 31 is a block diagram illustrating a configuration example of a correcting unit 532.

FIG. 32 is a flowchart illustrating the encoding process to encode the parallax image D#2 of the viewpoint #2.

FIG. 33 is a flowchart illustrating the correcting process.

FIG. 34 is a flowchart illustrating the pixel value correcting process.

FIG. 35 is a block diagram illustrating a configuration example of the decoder 322.

FIG. 36 is a block diagram illustrating a configuration example of a correcting unit 662.

FIG. 37 is a flowchart illustrating the decoding process to decode the encoded data of the parallax image D#2 of the viewpoint #2.

FIG. 38 is a view illustrating parallax and a depth.

FIG. 39 is a block diagram illustrating a configuration example of one embodiment of a computer to which this technology is applied.

FIG. 40 is a view illustrating a schematic configuration example of a television device to which this technology is applied.

FIG. 41 is a view illustrating a schematic configuration example of a mobile phone to which this technology is applied.

FIG. 42 is a view illustrating a schematic configuration example of a recording/reproducing device to which this technology is applied.

FIG. 43 is a view illustrating a schematic configuration example of an image taking device to which this technology is applied.

### MODE FOR CARRYING OUT THE INVENTION

[Description of Depth Image (Parallax Information Image) in this Specification]

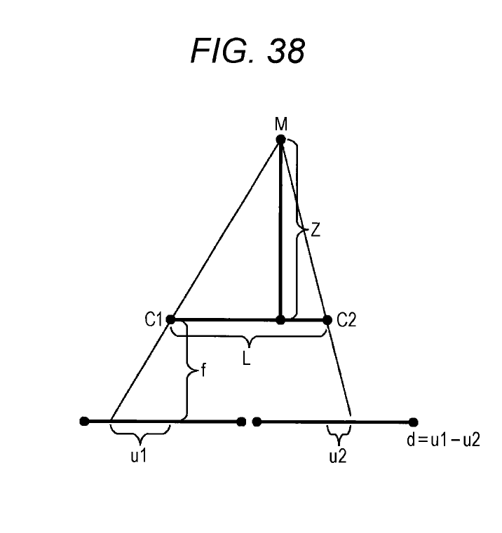

FIG. 38 is a view illustrating parallax and a depth.

As illustrated in FIG. 38, when a color image of a subject M is taken by a camera c1 arranged in a position C1 and a camera c2 arranged in a position C2, a depth Z being a distance between the subject M and the camera c1 (camera c2) in a depth direction is defined by following equation (a).

Z=(L/d)×f (a)

Meanwhile, L represents a distance between the positions C1 and C2 in a horizontal direction (hereinafter, referred to as an inter-camera distance).

Also, d represents a value obtained by subtracting a distance u2 between a position of the subject M on a color image taken by the camera c2 and the center of the color image in the horizontal direction from a distance u1 between the position of the subject M on the color image taken by the camera c1 and the center of the color image in the horizontal direction, that is to say, the parallax. Further, f represents a focal distance of the camera c1 and the focal distance of the camera c1 and that of the camera c2 are the same in equation (a).

As represented by equation (a), the parallax d and the depth Z are uniquely convertible. Therefore, in this specification, an image indicating the parallax d and an image indicating the depth Z of the color images of two viewpoints taken by the cameras c1 and c2 are collectively referred to as depth images (parallax information images).

Meanwhile, the image indicating the parallax d or the depth Z may be used as the depth image (parallax information image), and not the parallax d or the depth Z itself but a value obtained by normalizing the parallax d, a value obtained by normalizing an inverse number 1/Z of the depth Z and the like may be adopted as a pixel value of the depth image (parallax information image).

A value I obtained by normalizing the parallax d to 8 bits (0 to 255) may be obtained by following equation (b). Meanwhile, the parallax d is not necessarily normalized to 8 bits and this may also be normalized to 10 bits, 12 bits, and so on.

$$\begin{matrix}[ Equation 1 ] & \\ I = \frac{255 \times ( d - {D}_{min} )}{{D}_{max} - {D}_{min}} & ( b )\end{matrix}$$

Meanwhile, in equation (b), Dₘₐₓ represents a maximum value of the parallax d and Dₘᵢₙ represents a minimum value of the parallax d. The maximum value Dₘₐₓ and the minimum value Dₘᵢₙ may be set in units of one screen or set in units of a plurality of screens.

A value y obtained by normalizing the inverse number 1/Z of the depth Z to 8 bits (0 to 255) may be obtained by following equation (c). Meanwhile, the inverse number 1/Z of the depth Z is not necessarily normalized to 8 bits, and this may also be normalized to 10 bits, 12 bits, and so on.

$$\begin{matrix}[ Equation 2 ] & \\ y = 255 \times \frac{\frac{1}{Z} - \frac{1}{{Z}_{far}}}{\frac{1}{{Z}_{near}} - \frac{1}{{Z}_{far}}} & ( c )\end{matrix}$$

Meanwhile, in equation (c), Z_{far} represents a maximum value of the depth Z and Zₙₑₐᵣ represents a minimum value of the depth Z. The maximum value Z_{far} and the minimum value Zₙₑₐᵣ may be set in units of one screen or set in units of a plurality of screens.

In this manner, in this specification, the image in which the value I obtained by normalizing the parallax d is the pixel value and the image in which the value y obtained by normalizing the inverse number 1/Z of the depth Z is the pixel value are collectively referred to as the depth images (parallax information images) in consideration of the fact that the parallax d and the depth Z are uniquely convertible. Although a color format of the depth image (parallax information image) is herein YUV420 or YUV400, another color format may also be used.

Meanwhile, when attention is focused not on the value I or the value y as the pixel value of the depth image (parallax information image) but on information itself of the value, the value I or the value y is made depth information (parallax information). Further, a map on which the value I to the value y is mapped is made a depth map (parallax map).

### [Images of Plurality of Viewpoints]

Hereinafter, one embodiment of this technology is described with reference to the drawings; images of a plurality of viewpoints are described as a preliminary step thereof.

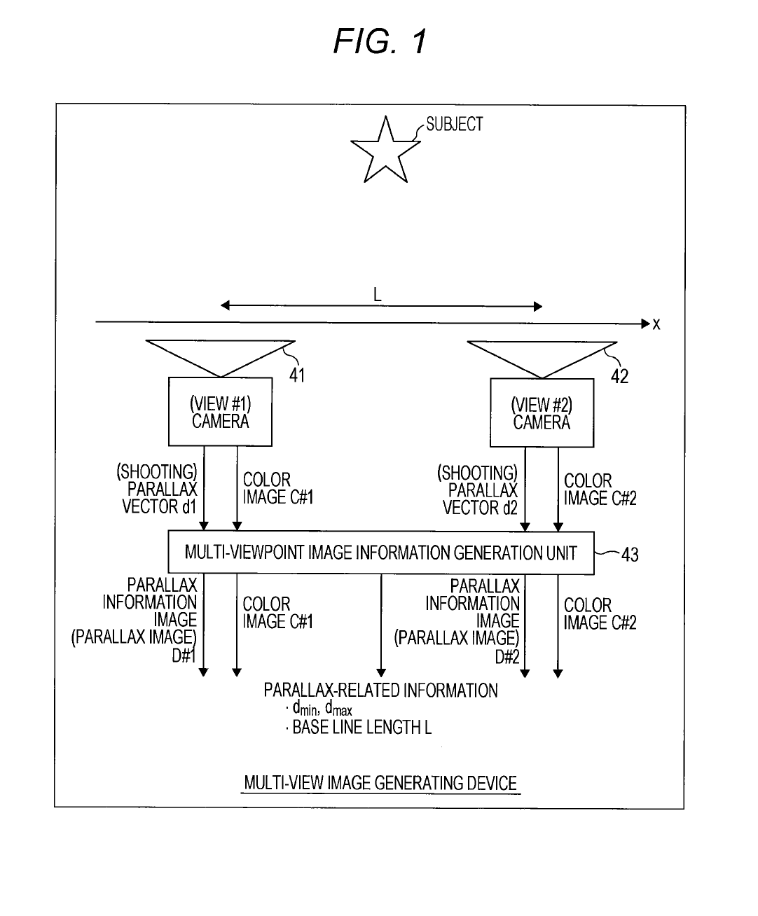

FIG. 1 is a block diagram illustrating a configuration example of a multi-view image generating device, which generates the images of a plurality of viewpoints.

In the multi-view image generating device, in order to take images of a plurality of viewpoints, for example, two viewpoints, two cameras 41 and 42 are installed in positions in which color images of different viewpoints may be taken.

Herein, in this embodiment, in order to simplify the description, the cameras 41 and 42 are arranged in different positions on the same straight line on a certain horizontal plane such that an optical axis of each of them is in a direction perpendicular to the straight line.

The camera 41 takes an image of the subject in the position in which the camera 41 is arranged to output a color image C#1 being a moving image.

Further, the camera 41 makes the position of another optional camera, for example, the camera 42, a reference viewpoint and outputs a parallax vector d1 representing the parallax with respect to the reference viewpoint for each pixel of the color image C#1.

The camera 42 takes an image of the subject in the position in which the camera 42 is arranged to output a color image C#2 being a moving image.

Further, the camera 42 makes the position of another optional camera, for example, the camera 41, the reference viewpoint and outputs a parallax vector d2 representing the parallax with respect to the reference viewpoint for each pixel of the color image C#2.

Herein, when a two-dimensional plane in which a transverse (horizontal) direction and a longitudinal (vertical) direction of the color image are along an x-axis and an y-axis thereof, respectively, is referred to as a color image plane, the cameras 41 and 42 are arranged on the same straight line on a plane (horizontal plane) orthogonal to the color image plane and parallel to the x-axis. Therefore, the parallax vectors d1 and d2 are vectors whose y component is 0 and x component is a value corresponding to a positional relationship between the cameras 41 and 42 in the horizontal direction and the like.

Meanwhile, the parallax vectors d1 and d2 output from the cameras 41 and 42 are hereinafter also referred to as shooting parallax vectors d1 and d2 so as to be distinguished from the parallax vector representing the parallax obtained by ME to be described later.

The color image C#1 and the shooting parallax vector d1 output from the camera 41 and the color image C#2 and the shooting parallax vector d2 output from the camera 42 are supplied to a multi-view image information generating unit 43.

The multi-view image information generating unit 43 directly outputs the color image C#1 from the cameras 41 and 42.

The multi-view image information generating unit 43 also obtains the parallax information (depth information) regarding the parallax of each pixel of the color image #1 from the shooting parallax vector d1 from the camera 41 and generates a parallax information image (depth image) D#1 having the parallax information as the pixel value to output.

Further, the multi-view image information generating unit 43 obtains the parallax information regarding the parallax of each pixel of the color image #2 from the shooting parallax vector d2 from the camera 42 and generates a parallax information image D#2 having the parallax information as the pixel value to output.

Herein, as described above, there are a parallax value (value I), which is a value corresponding to the shooting parallax vector (parallax), and a depth value (value y), which is a value corresponding to the distance to the subject (depth Z), for example, as the parallax information (depth information).

Herein, the pixel value of the parallax information image takes an integral value from 0 to 255 represented by 8 bits, for example. Further, (the x component of) the shooting parallax vector is represented by d and a maximum value and a minimum value of (the x component of) the shooting parallax vector are represented by dmax (Dmax) and dmin (Dmin), respectively, (in a picture, a moving image as one content and the like, for example).

In this case, a parallax value ν (value I) is obtained according to equation (1) using (the x component of) the shooting parallax vector d and the maximum value dmax and the minimum value dmin thereof, for example.

ν=255×(d−dmin)/(dmax−dmin) (1)

Meanwhile, the parallax value ν in equation (1) may be converted to (the x component of) the shooting parallax vector d according to equation (2).

d=νx(dmax−dmin)/255+dmin (2)

The depth Z represents the distance from the straight line on which the cameras 41 and 42 are arranged to the subject.

The distance Z (depth Z) from the camera 41 (the same applies to the camera 42) to the subject may be obtained according to equation (3) using (the x component of) the shooting parallax vector d (d1) when a base line length, which is a distance between the camera 41 and the camera 42 arranged on the same straight line (distance from the reference viewpoint) is represented by L and the focal distance of the camera 41 is represented by f.

Z=(L/d)×f (3)

The parallax value ν and the distance Z to the subject, which are the parallax information, (and further the shooting parallax vector d) may be converted to one another according to equations (1) to (3), so that they are equivalent information.

Hereinafter, the parallax information image (depth image) having the parallax value ν (value I) as the pixel value is also referred to as a parallax image and the image having the depth value (value y) as the pixel value is also referred to as a depth image.

Meanwhile, although the parallax image, for example, out of the parallax image and the depth image is hereinafter used as the parallax information image, it is also possible to use the depth image as the parallax information image.

The multi-view image information generating unit 43 outputs parallax-related information (depth-related information), which is meta data of the parallax information, in addition to the above-described color images #1 and #2 and the parallax images (parallax information images) D#1 and #2.

That is to say, the base line length L, which is the distance between the cameras 41 and 42 (distance between each of the cameras 41 and 42 and the reference viewpoint), and the focal distance f are externally supplied to the multi-view image information generating unit 43.

The multi-view image information generating unit 43 detects the maximum value dmax and the minimum value dmin of (the x component of) the shooting parallax vector d for each of the shooting parallax vector d1 from the camera 41 and the shooting parallax vector d2 from the camera 41.

Then, the multi-view image information generating unit 43 outputs the maximum value dmax and the minimum value dmin of the shooting parallax vector d, the base line length L, and the focal distance f as the parallax-related information.

Meanwhile, although the cameras 41 and 42 are herein arranged on the same straight line on the same plane orthogonal to the color image plane and the shooting parallax vectors d (d1 and d2) are the vectors whose y component is 0 in order to simplify the description, the cameras 41 and 42 may be arranged on different planes orthogonal to the color image plane. In this case, the shooting parallax vector d is the vector whose x component and y component may take values other than 0.

Hereinafter, a method of encoding the color images C#1 and C#2 and the parallax images D#1 and D#2 output from the multi-view image information generating unit 43, which are the images of a plurality of viewpoints, using the parallax-related information also output from the multi-view image information generating unit 43 as needed and decoding them is described.

### [Handling of Parallax Image]

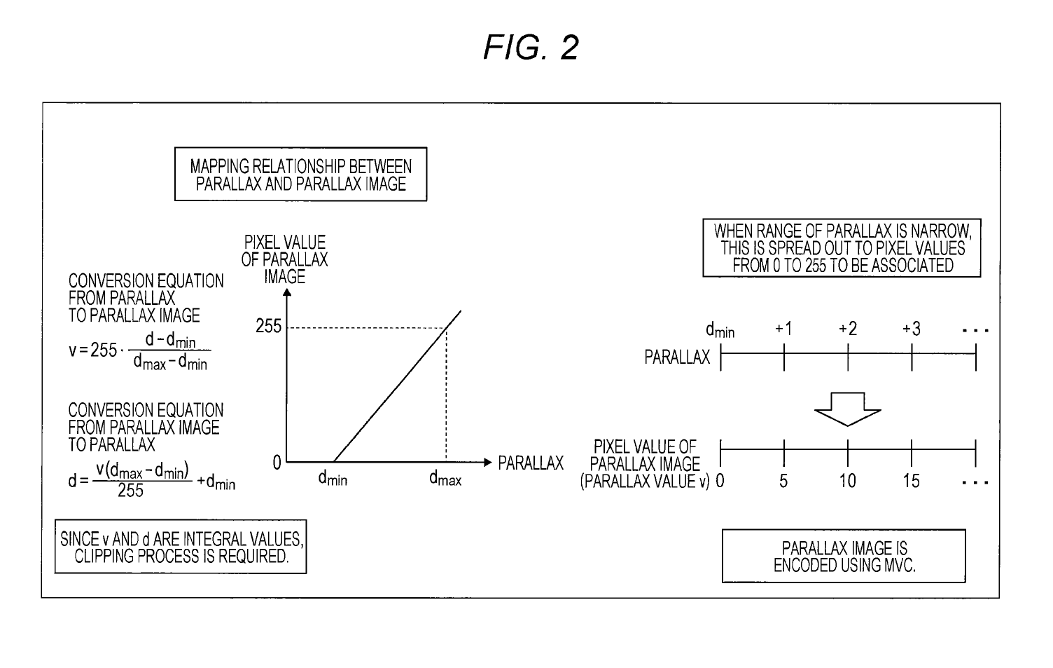

FIG. 2 is a view illustrating handling of the parallax image suggested in Non-Patent Document 1.

Non-Patent Document 1 suggests to allow the parallax value ν and (the x component of) the shooting parallax vector d to have a relationship represented by equations (1) and (2) supposing that the parallax value ν, which is the pixel value of the parallax image, takes the integral value from 0 to 255 represented by 8 bits as illustrated in FIG. 1.

According to equations (1) and (2), the shooting parallax vector d is mapped to the parallax value ν such that the minimum value dmin of the shooting parallax vector d is 0, which is the minimum value of the parallax value ν being the pixel value, and the maximum value dmax of the shooting parallax vector d is 255, which is the maximum value of the parallax value ν being the pixel value.

Therefore, a possible value of the parallax value ν, which is the pixel value of the parallax image, is defined to a predetermined value (hereinafter, also referred to as a defined value) according to the minimum value dmin and the maximum value dmax of the shooting parallax vector d.

That is to say, when a dynamic range of the shooting parallax vector d, that is to say, a difference dmax−dmin between the maximum value dmax and the minimum value dmin is 51, for example, the possible values of the parallax value ν are defined (set) to defined values 0, 5, 10, and so on being integral values at intervals of 5 (=255/(dmax−dmin)=255/51) as illustrated in FIG. 2.

Therefore, it may be said that the parallax image is the image having the value (parallax value ν) corresponding to the shooting parallax vector d as predetermined data as the pixel value, the image in which the possible value as the pixel value is defined to a predetermined defined value according to the maximum value dmax and the minimum value dmin of the shooting parallax vector d.

Meanwhile, the depth image may also be handled in the same manner as the parallax image.

In a case of encoding the parallax image by at least quantizing and decoding the same by at least inversely quantizing as in an MVC system and the like, for example, an image quality of a decoded image (parallax image) obtained as a result of decoding might be deteriorated (the pixel value is different from that of an original image) due to quantization noise (quantization distortion) (quantization error) generated by quantization and inverse quantization.

Therefore, this technology improves the image quality of the decoded image of the parallax image using a characteristic that the possible value of the parallax value ν, which is the pixel value of the parallax image, becomes the defined value defined according to the maximum value dmax and the minimum value dmin of the shooting parallax vector d.

### [Summary of This Technology]

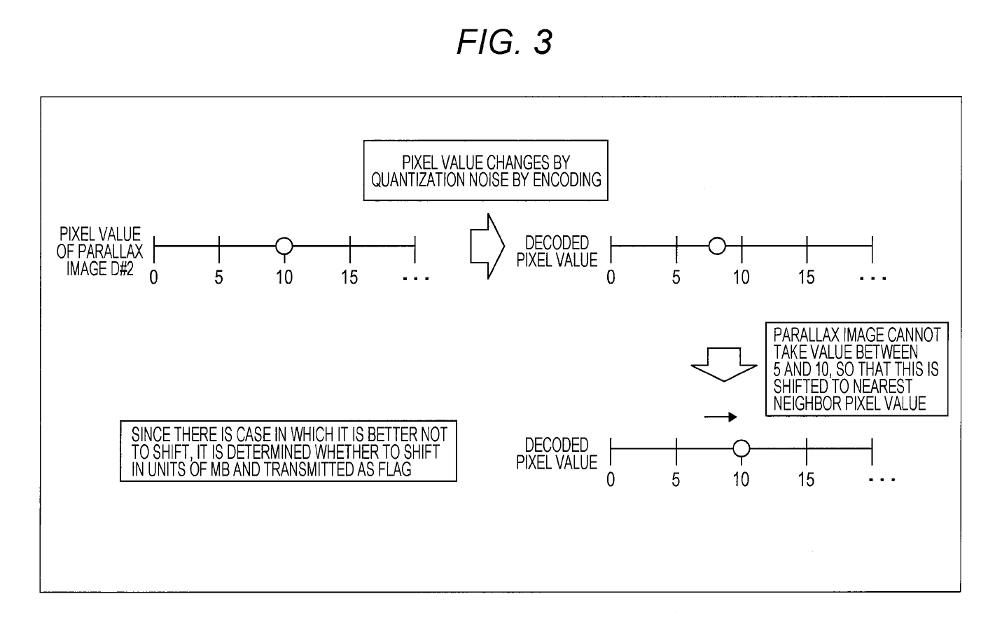

FIG. 3 is a view illustrating a summary of this technology.

As described above, when the parallax image is encoded and decoded using the MVC system, for example, the image quality of the decoded image obtained as a result of the decoding is deteriorated due to the quantization distortion generated by the quantization and the inverse quantization.

That is to say, for example, as illustrated in FIG. 3, when the parallax value ν as a certain pixel value of the parallax image is 10, the pixel value of the decoded image (hereinafter, also referred to as a decoded pixel value) obtained by encoding and decoding the parallax image using the MVC system is different from the pixel value of the original image (the parallax image before the encoding) due to the quantization distortion; for example, this is set to 8 and the like.

Herein, when the defined values, which are the possible values of the parallax value ν of the parallax image, are 0, 5, 10, and so on, the parallax value ν cannot be 8, which is not the defined value.

Therefore, this technology corrects (shifts) the decoded pixel value from a current value of 8 to a value the closest to the current value (nearest neighbor value) of 10 out of the defined values 0, 5, 10, and so on.

As a result, according to this technology, the pixel value of the decoded image (decoded pixel value) conforms to the pixel value of the original image (parallax value ν of the parallax image before the encoding), so that the image quality of the decoded image may be improved.

Meanwhile, this technology may correct every decoded pixel value of the decoded image from the current value to the value the closest to the current value out of the defined values.

However, depending on the decoded pixel value, there is a case in which the current value without correction is closer to the pixel value of the original image than the corrected value is.

Therefore, an encoder, which encodes the parallax image, may determine (decide) whether to correct the decoded pixel value in a predetermined unit such as a macroblock, for example, and output a 1-bit correction flag, for example, indicating whether to correct the decoded pixel value to the defined value or leave the value unchanged (without correcting the same).

A decoder, which decodes the parallax image, may correct the decoded pixel value to the defined value or leave the value unchanged based on the correction flag.

[One Embodiment of Multi-View Image Encoder to which this Technology is Applied]

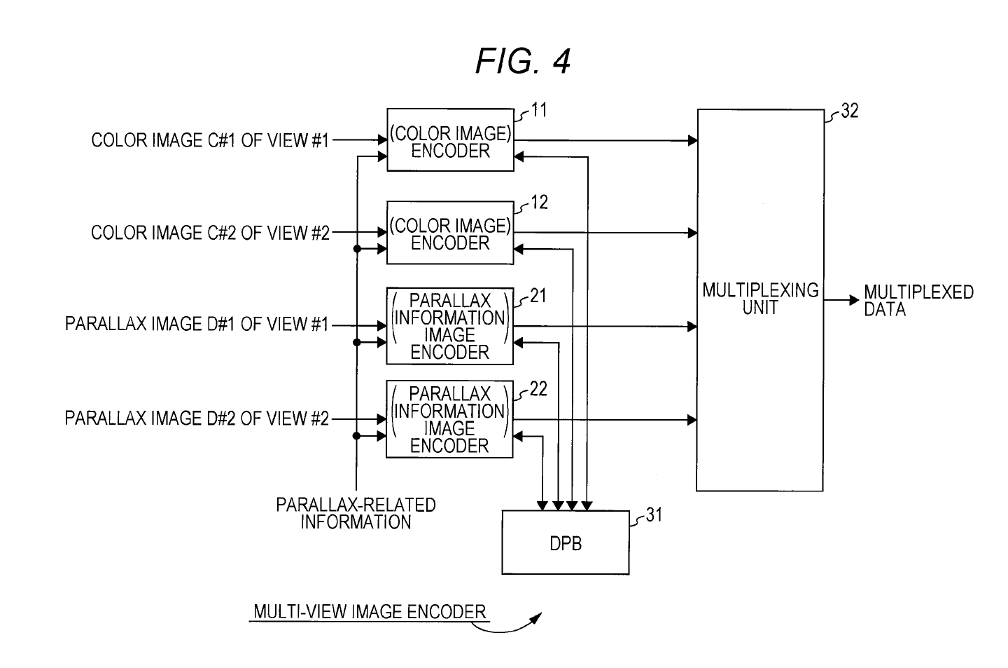

FIG. 4 is a block diagram illustrating a configuration example of one embodiment of a multi-view image encoder to which this technology is applied.

The multi-view image encoder in FIG. 4 is an encoder, which encodes the images of a plurality of viewpoints using the MVC system, for example, and description of the same process as in the MVC system is hereinafter appropriately omitted.

Meanwhile, the multi-view image encoder is not limited to the encoder, which uses the MVC system.

Hereinafter, the color image C#1 of a viewpoint #1 and the color image C#2 of a viewpoint #2, which are the color images of the two viewpoints #1 and #2, and the parallax image D#1 of the viewpoint #1 and the parallax image D#2 of the viewpoint #2, which are the parallax information images of the two viewpoints #1 and #2, are adopted as the images of a plurality of viewpoints.

Further, the color image C#1 and the parallax image D#1 of the viewpoint #1 are handled as images of a base view and the color image C#2 and the parallax image D#2 of the other viewpoint #2 are handled as images of a dependent view, for example.

Meanwhile, the color images and the parallax information images of three or more viewpoints may be adopted as the images of a plurality of viewpoints, and the color image and the parallax information image of an optional viewpoint out of the color images and the parallax information images of the three or more viewpoints may be handled as the images of the base view and the color images and the parallax information images of the other viewpoints may be handled as the images of the dependent views.

In FIG. 4, the multi-view image encoder includes encoders 11, 12, 21, and 22, a DPB 31, and a multiplexing unit 32, and the color image C#1 and the parallax image D#1 of the viewpoint #1, the color image C#2 and the parallax image D#2 of the viewpoint #2, and the parallax-related information output from the multi-view image generating device in FIG. 1 are supplied to the multi-view image encoder.

The color image C#1 of the viewpoint #1 and the parallax-related information are supplied to the encoder 11.

The encoder 11 encodes the color image C#1 of the viewpoint #1 using the parallax-related information as needed and supplies encoded data of the color image C#1 of the viewpoint #1 obtained as a result to the multiplexing unit 32.

The color image C#2 of the viewpoint #2 and the parallax-related information are supplied to the encoder 12.

The encoder 12 encodes the color image C#2 of the viewpoint #2 using the parallax-related information as needed and supplies encoded data of the color image C#2 of the viewpoint #2 obtained as a result to the multiplexing unit 32.

The parallax image D#1 of the viewpoint #1 and the parallax-related information are supplied to the encoder 21.

The encoder 21 encodes the parallax image D#1 of the viewpoint #1 using the parallax-related information as needed and supplies encoded data of the parallax image D#1 of the viewpoint #1 obtained as a result to the multiplexing unit 32.

The parallax image D#2 of the viewpoint #2 and the parallax-related information are supplied to the encoder 22.

The encoder 22 encodes the parallax image D#2 of the viewpoint #2 using the parallax-related information as needed and supplies encoded data of the parallax image D#2 of the viewpoint #2 obtained as a result to the multiplexing unit 32.

The DPB 31 temporarily stores an image after local decoding (decoded image) obtained by encoding an image to be encoded and locally decoding the same by each of the encoders 11, 12, 21, and 22 as (a candidate of) a reference picture, which is referred to when a predicted image is generated.

That is to say, each of the encoders 11, 12, 21 and 22 predictively encodes the image to be encoded. Therefore, each of the encoders 11, 12, 21, and 22 encodes the image to be encoded and locally decodes the same to obtain the decoded image in order to generate the predicted image used in predictive encoding.

The DPB 31 is a so-called shared buffer, which temporarily stores the decoded images obtained by the encoders 11, 12, 21, and 22, and each of the encoders 11, 12, 21, and 22 selects the reference picture, which is referred to when the image to be encoded is encoded from the decoded images stored in the DPB 31. Each of the encoders 11, 12, 21, and 22 generates the predicted image using the reference picture and encodes (predictively encodes) the image using the predicted image.

The DPB 31 is shared by the encoders 11, 12, 21, and 22, so that each of the encoders 11, 12, 21, and 22 may refer also to the decoded image obtained by another encoder in addition to the decoded image obtained by itself.

The multiplexing unit 32 multiplexes the encoded data from the encoders 11, 12, 21, and 22 and outputs multiplexed data obtained as a result.

The multiplexed data output from the multiplexing unit 32 is recorded on a recording medium not illustrated or transmitted through a transmitting medium not illustrated.

Meanwhile, the parallax-related information may be multiplexed with the encoded data by the multiplexing unit 32.

### [Summary of MVC System]

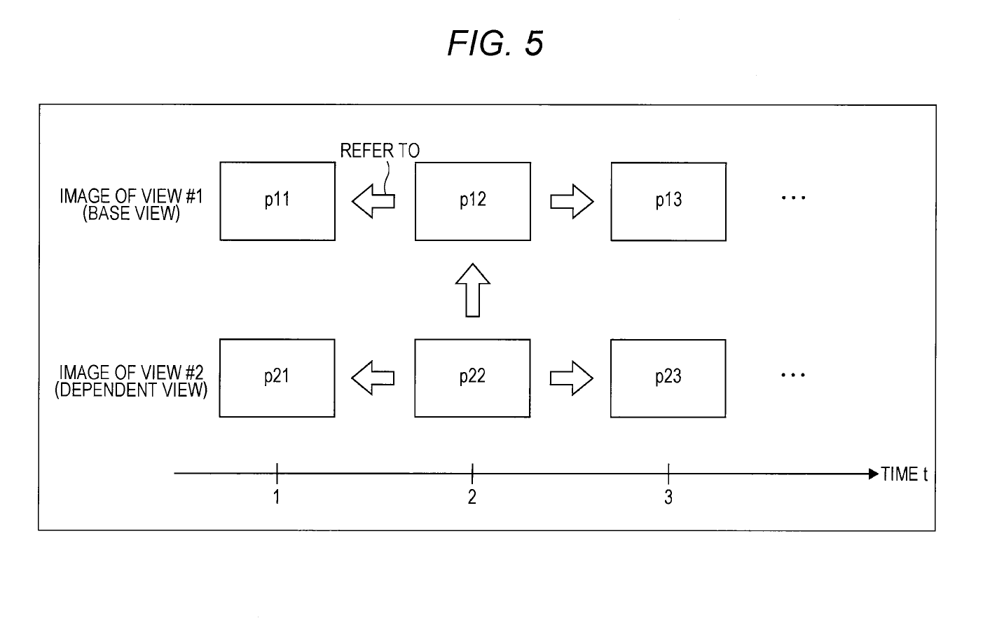

FIG. 5 is a view illustrating the picture, which is referred to when the predicted image is generated, in the predictive encoding using the MVC system.

The pictures of the image of the viewpoint #1, which is the image of the base view, are represented as p11, p12, p13, and so on in order of (display) time and the pictures of the image of the viewpoint #2, which is the image of the dependent view, are represented as p21, p22, p23, and so on in the order of time.

The picture p12, for example, which is the picture of the base view, is predictively encoded with reference to the picture of the base view such as the pictures p11 and p13 as needed.

That is to say, it is possible to predict (generate the predicted image of) the picture p12 of the base view with reference only to the pictures p11 and p13, which are the pictures at other times of the base view.

Also, the picture of the dependent view, for example, the picture p22 is predictively encoded with reference to the picture of the dependent view such as the pictures p21 and p23, and further, the picture p12 of the base view, which is the other view, as needed.

That is to say, the picture p22 of the dependent view may be predicted with reference to the picture p12, which is the picture at the same time as the picture p22, of the base view being the other view, in addition to the pictures p21 and p23, which are the pictures at other times of the dependent view.

Herein, the prediction performed with reference to the picture of the same view as the picture to be encoded is also referred to as time prediction and the prediction performed with reference to the picture of the view different from that of the picture to be encoded is also referred to as parallax prediction.

As described above, in the MVC system, only the time prediction may be performed for the picture of the base view and the time prediction and the parallax prediction may be performed for the picture of the dependent view.

Meanwhile, in the MVC system, the picture of the view different from that of the picture to be encoded, which is referred to in the parallax prediction, should be the picture at the same time as the picture to be encoded.

The encoders 11, 12, 21, and 22 composing the multi-view image encoder in FIG. 4 predict (generate the predicted images) according to the MVC system in principle.

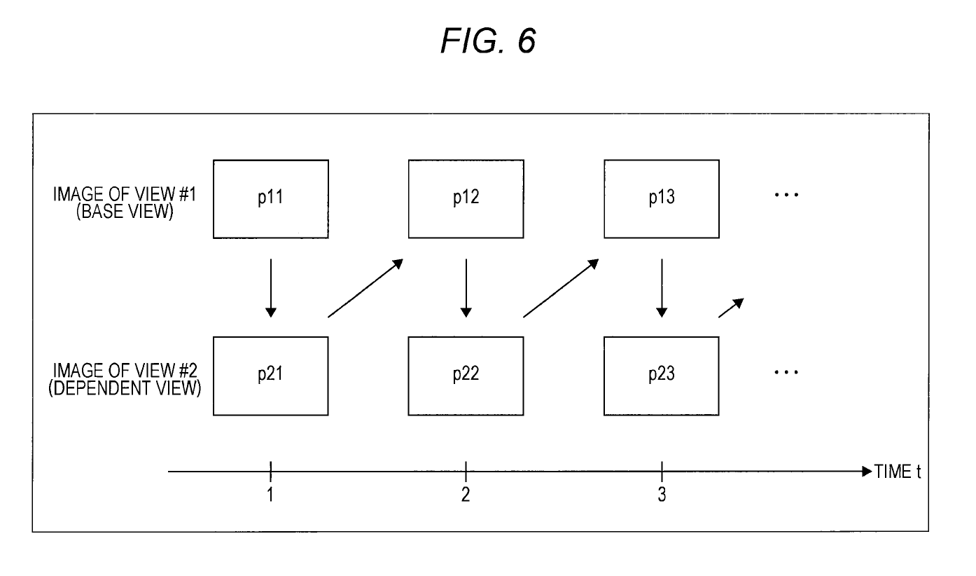

FIG. 6 is a view illustrating order of coding (and decoding) of the pictures in the MVC system.

The pictures of the image of the viewpoint #1, which is the image of the base view, are represented as p11, p12, p13, and so on in the order of (display) time and the pictures of the image of the viewpoint #2, which is the image of the dependent view, are represented as p21, p22, p23, and so on in the order of time as in FIG. 5.

In order to simplify the description, supposing that the pictures of each view are encoded in the order of time, the picture p11 at an initial time t=1 of the base view is first encoded, and then, the picture p21 at the same time t=1 of the dependent view is encoded.

When the encoding of (all) the pictures at the same time t=1 of the dependent view is finished, the picture p12 at a next time t=2 of the base view is encoded, and then, the picture p22 at the same time t=2 of the dependent view is encoded.

Hereinafter, the pictures of the base view and the pictures of the dependent view are encoded in the same order.

The encoders 11, 12, 21, and 22 composing the multi-view image encoder in FIG. 4 encode the pictures in order according to the MVC system.

### [Configuration Example of Encoder 11]

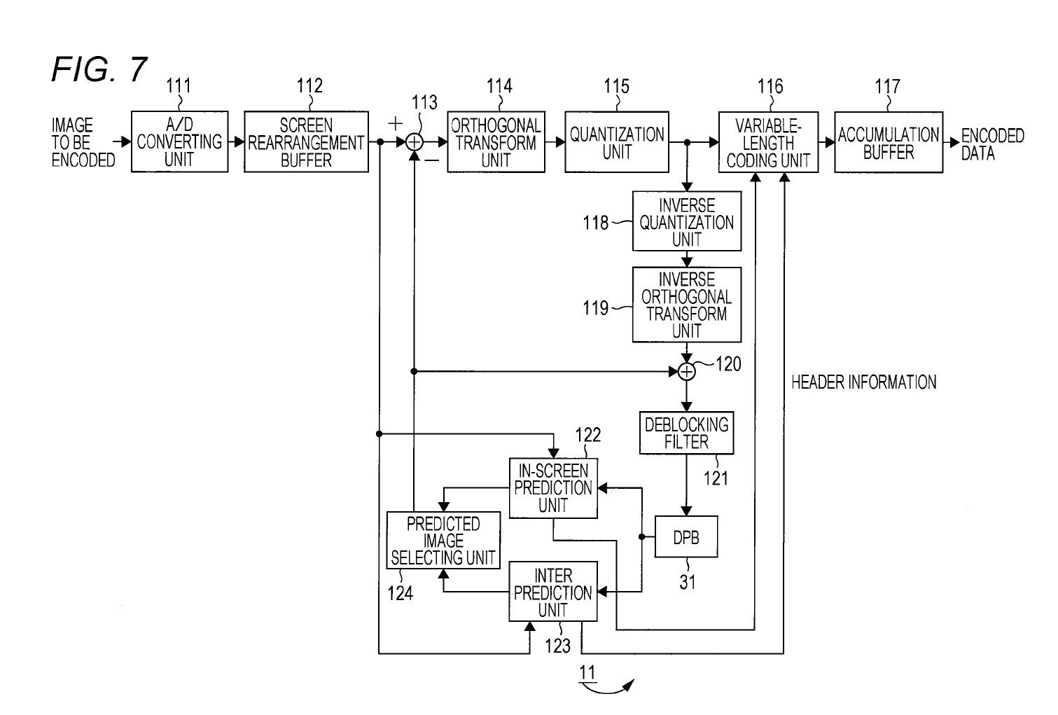

FIG. 7 is a block diagram illustrating a configuration example of the encoder 11 in FIG. 4.

Meanwhile, the encoder 12 in FIG. 4 also is composed in the same manner as the encoder 11 and encodes the image according to the MVC system, for example.

In FIG. 7, the encoder 11 includes an A/D (Analog/Digital) converting unit 111, a screen rearrangement buffer 112, a calculation unit 113, an orthogonal transform unit 114, a quantization unit 115, a variable-length coding unit 116, an accumulation buffer 117, an inverse quantization unit 118, an inverse orthogonal transform unit 119, a calculation unit 120, a deblocking filter 121, an in-screen prediction unit 122, an inter prediction unit 123, and a predicted image selecting unit 124.

The pictures of the color image C#1 of the viewpoint #1, which is the image (moving image) to be encoded, are sequentially supplied to the A/D converting unit 111 in the order of display.

When the picture supplied to the A/D converting unit 111 is an analog signal, this A/D converts the analog signal to supply to the screen rearrangement buffer 112.

The screen rearrangement buffer 112 temporarily stores the pictures from the A/D converting unit 111 and reads the pictures according to a structure of a GOP (Group of Pictures) determined in advance, thereby performing rearrangement to rearrange order of the pictures from the order of display to the order of encoding (order of decoding).

The picture read from the screen rearrangement buffer 112 is supplied to the calculation unit 113, the in-screen prediction unit 122, and the inter prediction unit 123.

In addition to the picture supplied from the screen rearrangement buffer 112, the predicted image generated by the in-screen prediction unit 122 or the inter prediction unit 123 is supplied from the predicted image selecting unit 124 to the calculation unit 113.

The calculation unit 113 makes the picture read from the screen rearrangement buffer 112 a target picture to be encoded, and further, sequentially makes the macroblock composing the target picture a target block to be encoded.

Then, the calculation unit 113 calculates a subtracted value obtained by subtracting the pixel value of the predicted image supplied from the predicted image selecting unit 124 from the pixel value of the target block as needed and supplies the same to the orthogonal transform unit 114.

The orthogonal transform unit 114 applies orthogonal transform such as discrete cosine transform and Karhunen-Loeve transform to (the pixel value of) the target block (or a residual obtained by subtracting the predicted image therefrom) from the calculation unit 113 and supplies a transform coefficient obtained as a result to the quantization unit 115.

The quantization unit 115 quantizes the transform coefficient supplied from the orthogonal transform unit 114 and supplies a quantization value obtained as a result to the variable-length coding unit 116.

The variable-length coding unit 116 applies lossless coding such as variable-length coding (for example, CAVLC (Context-Adaptive Variable-Length Coding) and the like) and arithmetic coding (for example, CABAC (Context-Adaptive Binary Arithmetic Coding) and the like) to the quantization value from the quantization unit 115 and supplies the encoded data obtained as a result to the accumulation buffer 117.

Meanwhile, in addition to the quantization value supplied from the quantization unit 115, header information to be included in a header of the encoded data is supplied from the in-screen prediction unit 122 and the inter prediction unit 123 to the variable-length coding unit 116.

The variable-length coding unit 116 encodes the header information from the in-screen prediction unit 122 and the inter prediction unit 123 and includes the same in the header of the coded data.

The accumulation buffer 117 temporarily stores the encoded data from the variable-length coding unit 116 and outputs the same at a predetermined data rate.

The encoded data output from the accumulation buffer 117 is supplied to the multiplexing unit 32 (FIG. 4).

The quantization value obtained by the quantization unit 115 is supplied to the variable-length coding unit 116 and is also supplied to the inverse quantization unit 118 to be locally decoded by the inverse quantization unit 118, the inverse orthogonal transform unit 119, and the calculation unit 120.

That is to say, the inverse quantization unit 118 inversely quantizes the quantization value from the quantization unit 115 to obtain the transform coefficient and supplies the same to the inverse orthogonal transform unit 119.

The inverse orthogonal transform unit 119 performs inverse orthogonal transform of the transform coefficient from the inverse quantization unit 118 to supply to the calculation unit 120.

The calculation unit 120 adds the pixel value of the predicted image supplied from the predicted image selecting unit 124 to the data supplied from the inverse orthogonal transform unit 119 as needed, thereby obtaining the decoded image obtained by decoding (locally decoding) the target block and supplies the same to the deblocking filter 121.

The deblocking filter 121 supplies the decoded image from the calculation unit 120 to the DPB 31 (FIG. 4) after filtering the same to remove (decrease) block distortion generated in the decoded image.

Herein, the DPB 31 stores the picture of the decoded image from the deblocking filter 121, that is to say, the color image C#1 encoded and locally decoded by the encoder 11 as (the candidate of) the reference picture, which is referred to when the predicted image used in the predictive encoding (encoding in which the predicted image is subtracted by the calculation unit 113) to be performed later is generated.

As illustrated in FIG. 4, since the DPB 31 is shared by the encoders 11, 12, 21, and 22, this also stores the picture of the color image C#2 encoded and locally decoded by the encoder 12, the picture of the parallax image D#1 encoded and locally decoded by the encoder 21, and the picture of the parallax image D#2 encoded and locally decoded by the encoder 22 in addition to the picture of the color image C#1 encoded and locally decoded by the encoder 11.

Meanwhile, targets of the local decoding by the inverse quantization unit 118, the inverse orthogonal transform unit 119, and the calculation unit 120 are an I picture, a P picture, and a Bs picture being referable pictures, which may become the reference pictures, for example, and the DPB 31 stores the decoded images of the I picture, the P picture, and the Bs picture.

When the target picture is the I picture, the P picture, or a B picture (including the Bs picture), which might be intra predicted (in-screen predicted), the in-screen prediction unit 122 reads an already locally decoded part (decoded image) of the target picture from the DPB 31. Then, the in-screen prediction unit 122 makes a part of the decoded image of the target picture read from the DPB 31 the predicted image of the target block of the target picture supplied from the screen rearrangement buffer 112.

Further, the in-screen prediction unit 122 obtains an encoding cost required for encoding the target block using the predicted image, that is to say, the encoding cost required for encoding the residual and the like between the target block and the predicted image, and supplies the same to the predicted image selecting unit 124 together with the predicted image.

When the target picture is the P picture or the B picture (including the Bs picture), which might be inter predicted, the inter prediction unit 123 reads one or more pictures encoded and locally decoded before the target picture and from the DPB 31 as (the candidates of) the reference picture.

Also, the inter prediction unit 123 detects a displacement vector representing displacement (parallax and motion) between the target block and a corresponding block (block (area), which minimizes the encoding cost such as SAD (Sum of Absolute Differences) between the same and the target block) corresponding to the target block of the reference picture by ME (Motion Estimation) using the target block of the target picture supplied from the screen rearrangement buffer 112 and the reference picture.

Herein, when the reference picture is the picture of the same view as the target picture, that is to say, the picture at a time different from that of the target picture of the parallax image D#2 of the viewpoint #2, the displacement vector detected by the ME using the target block and the reference picture is a motion vector representing motion between the target block and the reference picture (temporal displacement).

When the reference picture is the picture of the view different from that of the target picture, that is to say, herein, the picture at the same time as the target picture of the parallax image D#1 of the viewpoint #1, the displacement vector detected by the ME using the target block and the reference picture is the parallax vector representing the parallax (spatial displacement) between the target block and the reference picture.

The parallax vector obtained by the ME in the above-described manner is also referred to as a calculated parallax vector so as to be distinguished from the shooting parallax vector illustrated in FIG. 1.

In this embodiment, although the shooting parallax vector is the vector whose y component is 0 in order to simplify the description, the calculated parallax vector detected by the ME represents the displacement (positional relationship) between the target block and the block (corresponding block), which minimizes the SAD and the like between the same and the target block of the reference picture, so that the y component is not necessarily 0.

The inter prediction unit 123 performs displacement compensation (motion compensation to compensate the displacement in motion or parallax compensation to compensate the displacement in parallax) being MC (Motion Compensation) of the reference picture from the DPB 31 according to the displacement vector of the target block, thereby generating the predicted image.

That is to say, the inter prediction unit 123 obtains the corresponding block, which is the block (area) in a position moved (displaced) according to the displacement vector of the target block from the position of the target block, of the reference picture as the predicted image.

Further, the inter prediction unit 123 obtains the encoding cost required for encoding the target block using the predicted image for each inter prediction mode in which the reference picture used for generating the predicted image, a macroblock type to be described later and the like are different according to a predetermined cost function.

The inter prediction unit 123 makes the inter prediction mode with a minimum encoding cost an optimal inter prediction mode, which is the inter prediction mode the best, and supplies the predicted image obtained in the optimal inter prediction mode and the encoding cost to the predicted image selecting unit 124.

Herein, generation of the predicted image based on the displacement vector (parallax vector and motion vector) is also referred to as displacement prediction (parallax prediction and motion prediction) or the displacement compensation (parallax compensation and motion compensation). Meanwhile, the displacement prediction includes detection of the displacement vector as needed.

The predicted image selecting unit 124 selects the predicted image with a smaller encoding cost out of the predicted images from the in-screen prediction unit 122 and the inter prediction unit 123 and supplies the same to the calculation units 113 and 120.

Herein, the in-screen prediction unit 122 supplies information regarding the intra prediction to the variable-length coding unit 116 as the header information and the inter prediction unit 123 supplies information regarding the inter prediction (information of the displacement vector, a reference index for specifying the reference picture used for generating the predicted image assigned to the reference picture and the like) to the variable-length coding unit 116 as the header information.

The variable-length coding unit 116 selects the header information from the in-screen prediction unit 122 and that from the inter prediction unit 123 by which the predicted image is generated with the smaller encoding cost and includes the same in the header of the encoded data.

### [Macroblock Type]

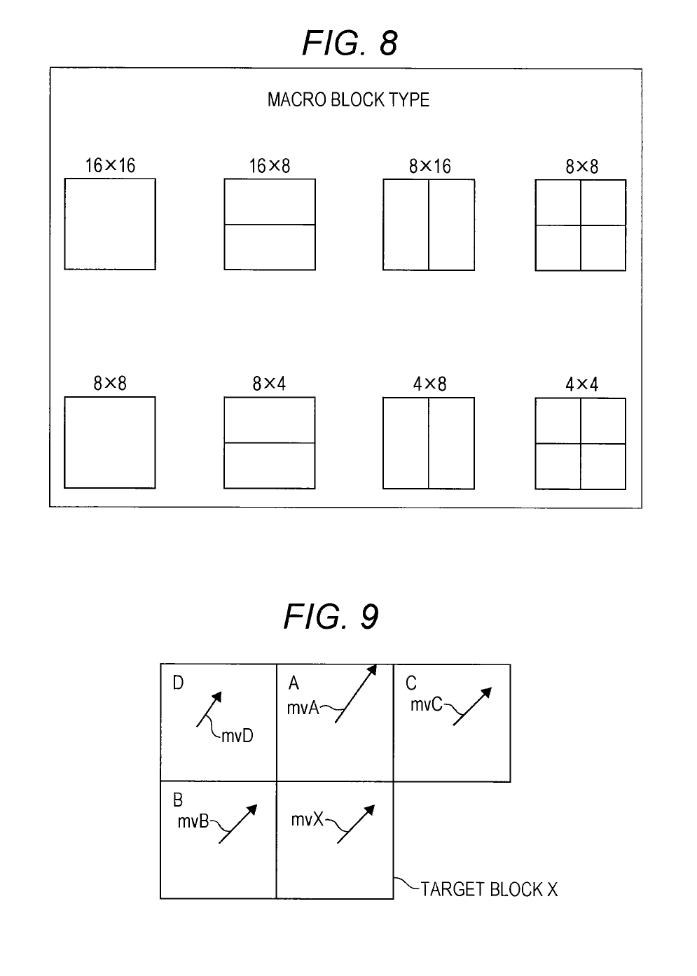

FIG. 8 is a view illustrating a macroblock type in the MVC (AVC) system.

Although the macroblock, which becomes the target block, is a 16×16-pixel block (in transverse and longitudinal directions) in the MVC system, the ME (and the generation of the predicted image) may be performed for each partition obtained by dividing the macroblock.

That is to say, in the MVC system, it is possible to divide the macroblock into any of 16×16-pixel partitions, 16×8-pixel partitions, 8×16-pixel partitions, and 8×8-pixel partitions and perform the ME for each partition to detect the displacement vector (motion vector and calculated parallax vector).

Also, in the MVC system, it is possible to further divide the 8×8-pixel partition into any of 8×8-pixel sub-partitions, 8×4-pixel sub-partitions, 4×8-pixel sub-partitions, and 4×4-pixel sub-partitions and perform the ME for each sub-partition to detect the displacement vector (motion vector and calculated parallax vector).

The macroblock type indicates a type of the partitions (further, the sub-partitions) into which the macroblock is divided.

In the inter prediction by the inter prediction unit 123 (FIG. 7), the encoding cost of each macroblock type is calculated as the encoding cost in each inter prediction mode and the inter prediction mode (macroblock type) with the minimum encoding cost is selected as the optimal inter prediction mode.

### [Predicted Motion Vector (PMV)]

FIG. 9 is a view illustrating a predicted motion vector (PMV) in the MVC (AVC) system.

In the inter prediction by the inter prediction unit 123 (FIG. 7), the displacement vector (motion vector and calculated parallax vector) of the target block is detected by the ME and the predicted image is generated using the displacement vector.

The displacement vector is required for decoding the image on a decoding side, so that it is required to encode the information of the displacement vector and include the same in the encoded data; however, when the displacement vector is directly encoded, a code amount of the displacement vector increases and coding efficiency might be deteriorated.

That is to say, in the MVC system, there is a case in which the macroblock is divided into the 8×8-pixel partitions and each of the 8×8-pixel partitions is further divided into 4×4-pixel sub-partitions as illustrated in FIG. 7. In this case, since one macroblock is finally divided into 4×4 sub-partitions, so that 16 (=4×4) displacement vectors might be generated for one macroblock, so that, when the displacement vector is directly encoded, the code amount of the displacement vector increases and the coding efficiency is deteriorated.

Therefore, in the MVC (AVC) system, vector prediction to predict the displacement vector is performed and a residual between the displacement vector and the predicted vector obtained by the vector prediction is encoded as the information of the displacement vector (displacement vector information (parallax vector information and motion vector information)).

That is to say, it is supposed that a certain macroblock X is the target block to be encoded. Also, in order to simplify the description, it is supposed that the target block X is divided into the 16×16-pixel partition (the target block X is directly made the partition).

A predicted vector PMVX of a displacement vector mvX of the target block X is calculated according to equation (4) using a displacement vector mvA of a macroblock A located above the target block X so as to be adjacent thereto, a displacement vector mvB of a macroblock B located on the left of the target block X so as to be adjacent thereto, and a displacement vector mvC of a macroblock C located on the upper right of the target block X so as to be adjacent thereto out of the macroblocks already encoded (in raster scan order) when the target block X is encoded, as illustrated in FIG. 9.

PMVX=med(mvA,mvB,mvC) (4)

Herein, in equation (4), med( ) represents a median (central value) of a value in parentheses.

Meanwhile, when the displacement vector mvC of the macroblock C is unavailable such as when the target block X is a rightmost macroblock of the picture, the predicted vector PMVX is calculated using a displacement vector mvD of a macroblock D located on the upper left of the target block X so as to be adjacent thereto in place of the displacement vector mvC.

Also, the predicted vector PMVX is separately calculated according to equation (4) for each of the x component and the y component.

In the inter prediction unit 123 (FIG. 7), a difference mvX−PMV between the displacement vector mvX of the target block X and the predicted vector PMVX thereof is included in the header information as the displacement vector information of the target block X.

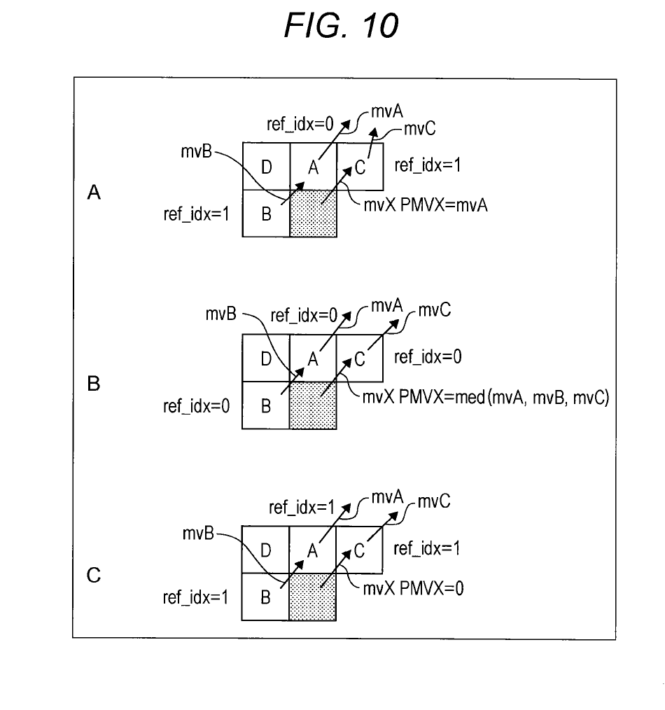

FIG. 10 is a view further illustrating the predicted vector in the MVC (AVC) system.

A method of generating the predicted vector of the displacement vector of the target block is different according to the reference index (hereinafter, also referred to as the reference index for prediction) assigned to the reference picture used for generating the predicted image of the macroblock around the target block.

Herein, (the reference picture, which might become) the reference picture in the MVC (AVC) system and the reference index are described.

In the AVC system, a plurality of pictures may be made the reference pictures when the predicted image is generated.

In a codec in the AVC-system, the reference picture is stored in a buffer referred to as a DPB after the decoding (local decoding).

In the DPB, the picture referred to in a short term, the picture referred to in a long term, and the picture, which is not referred to, are marked as a picture used for short-term reference, a picture used for long-term reference, and a picture unused for reference, respectively.

There are two types of control methods of controlling the DPB, which are a sliding window process and an adaptive memory control process.

In the sliding window process, the DPB is managed by a FIFO (First-In-First-Out) method and the pictures stored in the DPB are sequentially released from the picture with a smaller frame_num (to be the picture unused for reference).

That is to say, in the sliding window process, the I (Intra) picture, the P (Predictive) picture, and the Bs picture being the referable B (Bi-directional Predictive) picture are stored in the DPB as the picture used for short-term reference.

When the DPB stores as many (pictures, which might become) the reference pictures as this may store, the earliest (oldest) picture used for short-term reference out of the pictures used for short-term reference stored in the DPB is released.

Meanwhile, when the picture used for long-term reference is stored in the DPB, the sliding window process does not affect the picture used for long-term reference stored in the DPB. That is to say, in the sliding window process, only the picture used for short-term reference in the reference pictures is managed by the FIFO method.

In the adaptive memory control process, the picture stored in the DPB is managed using a command referred to as MMCO (Memory management control operation).

According to the MMCO command, for the reference picture stored in the DPB, it is possible to set the picture used for short-term reference as the picture unused for reference, to set the picture used for short-term reference as the picture used for long-term reference by assigning a long-term frame index, which is the reference index for managing the picture for long-term reference, to the picture used for short-term reference, to set a maximum value of the long-term frame index, and to set all the reference pictures as the pictures unused for reference.

In the AVC system, the inter prediction to generate the predicted image is performed by the motion compensation of the reference picture stored in the DPB; it is possible to use up to two reference pictures for the inter prediction of the B picture (including the Bs picture). The inter prediction to use the two reference pictures is referred to as L0 (List 0) prediction and L1 (List 1) prediction.

As for the B picture (including the Bs picture), the L0 prediction or the L1 prediction or both of the L0 prediction and the L1 prediction are used as the inter prediction. As for the P picture, only the L0 prediction is used as the inter prediction.

In the inter prediction, the reference picture, which is referred to when the predicted image is generated, is managed by a reference picture list.

In the reference picture list, the reference index, which is the index for specifying the reference picture referred when the predicted image is generated, is assigned to the reference picture stored in the DPB.

When the target picture is the P picture, since only the L0 prediction is used as the inter prediction for the P picture as described above, the reference index is assigned only for the L0 prediction.

When the target picture is the B picture (including the Bs picture), there is a case in which both of the L0 prediction and the L1 prediction are used as the inter prediction for the B picture as described above, so that the reference index is assigned for both of the L0 prediction and the L1 prediction.

Herein, the reference index for the L0 prediction is also referred to as an L0 index and the reference index for the L1 prediction is also referred to as an L1 index.

When the target picture is the P picture, the reference index (L0 index) whose value is smaller is assigned to the reference picture stored in the DPB whose order of decoding is later by default (defined value) in the AVC system.

The reference index is an integral value not smaller than 0 whose minimum value is 0. Therefore, when the target picture is the P picture, 0 is assigned to the reference picture decoded just before the target picture as the L0 index.

When the target picture is the B picture (including the Bs picture), the reference indices (L0 index and L1 index) are assigned to the reference picture stored in the DPB in order of POC (Picture Order Count), that is to say, in the order of display by default in the AVC.

That is to say, regarding the L0 prediction, the L0 index whose value is smaller is assigned to the reference picture closer to the target picture for the reference pictures before the target picture in terms of time in the order of display, and thereafter, the L0 index whose value is smaller is assigned to the reference picture closer to the target picture for the reference pictures after the target picture in terms of time in the order of display.

Also, regarding the L1 prediction, the L1 index whose value is smaller is assigned to the reference picture closer to the target picture for the reference pictures after the target picture in terms of time in the order of display, and thereafter, the L1 index whose value is smaller is assigned to the reference picture closer to the target picture for the reference pictures before the target picture in terms of time in the order of display.

Meanwhile, the above-described assignment of the reference indices (L0 index and L1 index) by default in the AVC system is performed for the picture for short-term reference. The reference index is assigned to the picture for long-term reference after the reference index is assigned to the picture for short-term reference.

Therefore, the reference index whose value is larger than that of the picture for short-term reference is assigned to the picture for long-term reference by default in the AVC.

In the AVC system, the reference index is assigned by the above-described default method or this may be optionally assigned using a command referred to as Reference Picture List Reordering (hereinafter, also referred to as an RPLR command).

Meanwhile, when there is the reference picture to which the reference index is not assigned after the assignment of the reference index using the RPLR command, the reference index is assigned to the reference picture by the default method.

As illustrated in FIG. 10, when the macroblock X (shaded block in FIG. 10) is the target block, the predicted vector PMVX of the displacement vector mvX of the target block X is obtained by the different methods according to the reference index for prediction of each of the macroblock A located above the target block X so as to be adjacent thereto, the macroblock B located on the left of the target block X so as to be adjacent thereto, and the macroblock C located on the upper right of the target block X so as to be adjacent thereto (reference index assigned to the reference picture used for generating the predicted image of each of the macroblocks A, B, and C).

For example, it is supposed that a reference index for prediction ref_idx of the target block X is 0.

As illustrated in FIG. 10A, when there is only one macroblock whose reference for prediction ref_idx is 0, the same as that of the target block X in the three macroblocks A to C adjacent to the target block X, the displacement vector of the one macroblock (macroblock whose reference index for prediction ref_idx is 0) is made the predicted vector PMVX of the displacement vector mvX of the target block X.

Herein, in FIG. 10A, only the macroblock A in the three macroblocks A to C adjacent to the target block X is the macroblock whose reference index for prediction ref_idx is 0, therefore, the displacement vector mvA of the macroblock A is made the predicted vector PMVX of (the displacement vector mvX of) the target block X.

Also, as illustrated in FIG. 10B, when there are two or more macroblocks whose reference index for prediction ref_idx is 0, the same as that of the target block X in the three macroblocks A to C adjacent to the target block X, the median of the displacement vectors of the two or more macroblocks whose reference index for prediction ref_idx is 0 is made the predicted vector PMVX of the target block X.

Herein, in FIG. 10B, all the three macroblocks A to C adjacent to the target block X are the macroblocks whose reference index for prediction ref_idx is 0, therefore, a median med (mvA, mvB, mvC) of the displacement vector mvA of the macroblock A, the displacement vector mvB of the macroblock B, and the displacement vector mvC of the macroblock C is made the predicted vector PMVX of the target block X.

Also, as illustrated in FIG. 10C, when there is no macroblock whose reference for prediction ref_idx is 0, the same as that of the target block X in the three macroblocks A to C adjacent to the target block X, 0 vector is made the predicted vector PMVX of the target block X.

Herein, in FIG. 100, there is no macroblock whose reference index for prediction ref_idx is 0 in the three macroblocks A to C adjacent to the target block X, so that the 0 vector is made the predicted vector PMVX of the target block X.

Meanwhile, in the MVC (AVC) system, when encoding the target block using the reference picture to which the reference index rev idx whose value is 0 is assigned, the target block may be made a skipped macroblock.

As for the skipped macroblock, neither the residual between the same and the predicted image nor the information of the displacement vector is encoded. At the time of the decoding, the predicted vector is directly adopted as the displacement vector of the skipped macroblock and a copy of the block (corresponding block) of the reference picture in a position displaced from the position of the skipped macroblock by an amount of the displacement vector is made a decoded result of the skipped macroblock.

Although it depends on specifications of the encoder whether to make the target block the skipped macroblock, this is decided (determined) based on the code amount of the encoded data, the encoding cost of the target block and the like, for example.

### [Configuration Example of Encoder 22]

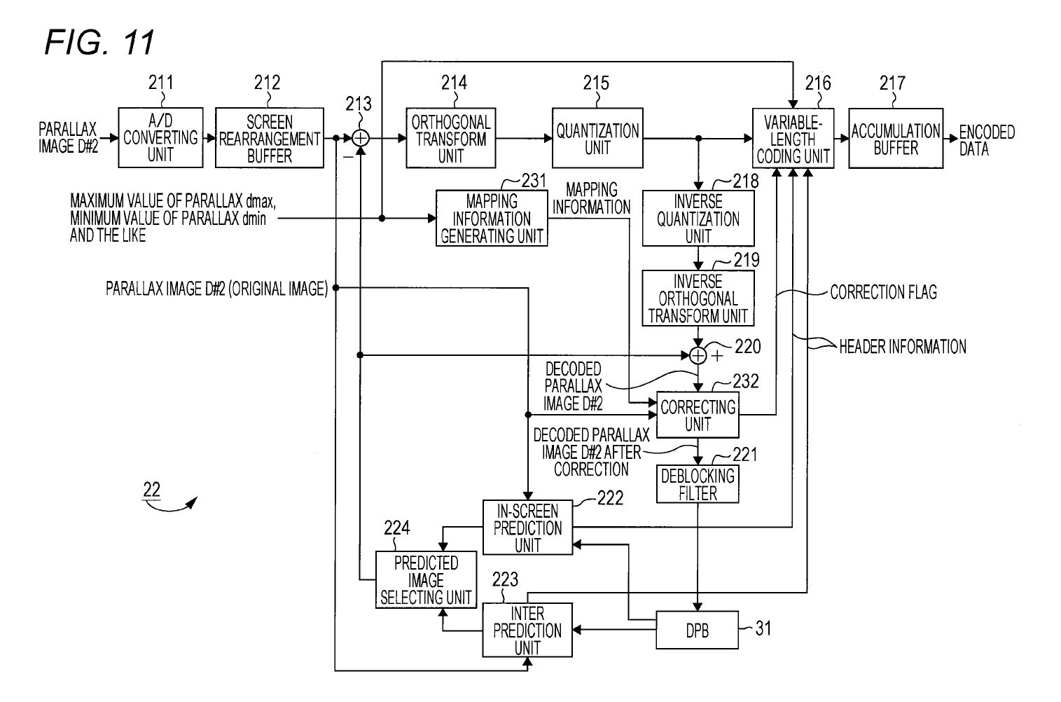

FIG. 11 is a block diagram illustrating a configuration example of the encoder 22 in FIG. 4.

The encoder 22 encodes the parallax image D#2 of the viewpoint #2, which is the image to be encoded, using the MVC system.

In FIG. 11, the encoder 22 includes an A/D converting unit 211, a screen rearrangement buffer 212, a calculation unit 213, an orthogonal transform unit 214, a quantization unit 215, a variable-length coding unit 216, an accumulation buffer 217, an inverse quantization unit 218, an inverse orthogonal transform unit 219, a calculation unit 220, a deblocking filter 221, an in-screen prediction unit 222, an inter prediction unit 223, a predicted image selecting unit 224, a mapping information generating unit 231, and a correcting unit 232.

The A/D converting unit 211 to the predicted image selecting unit 224 are composed in the same manner as the A/D converting unit 111 to the predicted image selecting unit 124 of the encoder 11 in FIG. 7, so that the description thereof is appropriately omitted.

In FIG. 11, the picture of the decoded image, that is to say, the parallax image (hereinafter, also referred to as a decoded parallax image) D#2 encoded and locally decoded by the encoder 22 is supplied from the deblocking filter 221 to the DPB 31 and is stored as (the picture, which might be) the reference picture.

Also, the picture of the color image C#1 encoded and locally decoded by the encoder 11, the picture of the color image C#2 encoded and locally decoded by the encoder 12, and the picture of the parallax image (decoded parallax image) D#1 encoded and locally decoded by the encoder 21 are also supplied to the DPB 31 to be stored as illustrated in FIGS. 4 and 7.

The maximum value dmax and the minimum value dmin of the shooting parallax vector d (shooting parallax vector d2 of the viewpoint #2) of the parallax image D#2, which is the encoding target of the encoder 22, and the like as the parallax-related information (FIG. 4) are supplied to the mapping information generating unit 231.

The mapping information generating unit 231 obtains information of the defined value, which the parallax value ν being the pixel value of the parallax image D#2 may take, based on the parallax-related information and supplies the same to the correcting unit 232 as the mapping information.

That is to say, the mapping information generating unit 231 obtains the defined value, which the parallax value ν in equation (1) may take, according to the maximum value dmax and the minimum value dmin of the shooting parallax vector d of the parallax image D#2, generates a list indicating correspondence between each defined value and the shooting parallax vector d converted (mapped) to the defined value and the like as the mapping information, and supplies the same to the correcting unit 232.

Meanwhile, (at least the maximum value dmax and the minimum value dmin of the shooting parallax vector d being information necessary for generating the mapping information, out of) the parallax-related information is supplied to the mapping information generating unit 231 and also to the variable-length coding unit 216. In the variable-length coding unit 216, the parallax-related information is included in the header of the encoded data as the header information.

In addition to the mapping information supplied from the mapping information generating unit 231, the decoded image (decoded parallax image D#2) obtained by decoding (locally decoding) the target block is supplied from the calculation unit 220 to the correcting unit 232.

Further, the target picture of the parallax image D#2 as the original image is supplied from the screen rearrangement buffer 212 to the correcting unit 232.

The correcting unit 232 corrects the decoded pixel value, which is the pixel value of the decoded image of the target block (hereinafter, also referred to as a decoded target block) from the calculation unit 220 using the mapping information from the mapping information generating unit 231 and the target block (hereinafter, also referred to as an original target block) in the target picture from the screen rearrangement buffer 212 and supplies the target block after the correction (hereinafter, also referred to as a corrected target block) to the deblocking filter 221.

The correcting unit 232 also generates the correction flag regarding the correction of the decoded pixel value and supplies the same to the variable-length coding unit 216 as the header information.

Herein, the variable-length coding unit 216 includes the correction flag as the header information in the header of the encoded data.

Meanwhile, the encoder 21 in FIG. 4 also is composed in the same manner as the encoder 22 in FIG. 11. However, in the encoder 21, which encodes the parallax image D#1, which is the image of the base view, the parallax prediction is not performed in the inter prediction.

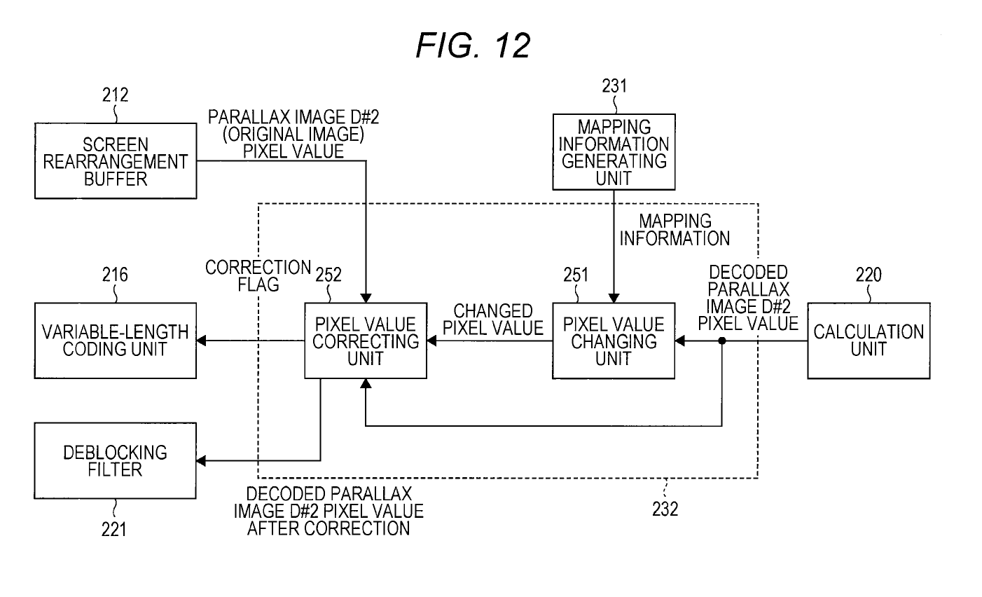

FIG. 12 is a block diagram illustrating a configuration example of the correcting unit 232 in FIG. 11.

In FIG. 12, the correcting unit 232 includes a pixel value changing unit 251 and a pixel value correcting unit 252.

In addition to the decoded target block, which is the decoded parallax image D#2 of the target block, supplied from the calculation unit 220, the mapping information is supplied from the mapping information generating unit 231 to the pixel value changing unit 251.

The pixel value changing unit 251 changes the decoded pixel value, which is the pixel value of the decoded target block from the calculation unit 220, to the defined value based on the mapping information from the mapping information generating unit 231 and supplies a target block composed of a changed pixel value, which is the pixel value after the change, (hereinafter, also referred to as a changed target block) to the pixel value correcting unit 252.

Herein, all the pixel values of the changed target block (changed pixel values) are the defined values.

The target picture is supplied from the screen rearrangement buffer 212 and the decoded target block is supplied from the calculation unit 220 to the pixel value correcting unit 252.

The pixel value correcting unit 252 corrects the pixel value of the decoded target block (decoded pixel value) based on the target block in the target picture from the screen rearrangement buffer 212, that is to say, the original target block, which is the target block before the encoding (target block of the parallax image D#2, which is the original image), the changed target block whose pixel value is changed to the defined value from the pixel value changing unit 251, and the decoded target block from the calculation unit 220, and supplies the corrected target block, which is the target block after the correction, to the deblocking filter 221.

That is to say, based on the SAD corresponding to a difference between each pixel value of the changed target block and each pixel value of the original target block (hereinafter, also referred to as the SAD for the changed target block) and the SAD corresponding to a difference between each pixel value of the decoded target block and each pixel value of the original target block (hereinafter, also referred to as the SAD for the decoded target block), the pixel value correcting unit 252 makes the decoded target block the corrected target block (leaves the pixel value of the decoded target block unchanged) when the SAD for the decoded target block is not larger than the SAD for the changed target block.

On the other hand, when the SAD for the decoded target block is larger than the SAD for the changed target block, the pixel value correcting unit 252 makes the changed target block the corrected target block (corrects the pixel value of the decoded target block to the defined value, which is the pixel value of the changed target block).

As described above, when the SAD as an error of (the pixel value of) the decoded target block with respect to (the pixel value of) the original target block is not larger than the SAD as the error of (the pixel value of) the changed target block with respect to (the pixel value of) the original target block, the pixel value correcting unit 252 does not correct the decoded target block and directly makes the same the corrected target block.

Also, when the error of (the pixel value of) the decoded target block with respect to the original target block is larger than the error of the changed target block with respect to the original target block, the pixel value correcting unit 252 corrects the decoded target block and makes the same the changed target block, all the pixel values of which are made the defined values.

In addition, the pixel value correcting unit 252 generates the correction flag indicating whether (the pixel value of) the corrected target block is corrected to (the defined value being the pixel value of) the changed target block or this remains (the pixel value of) the decoded target block and supplies the same to the variable-length coding unit 216.

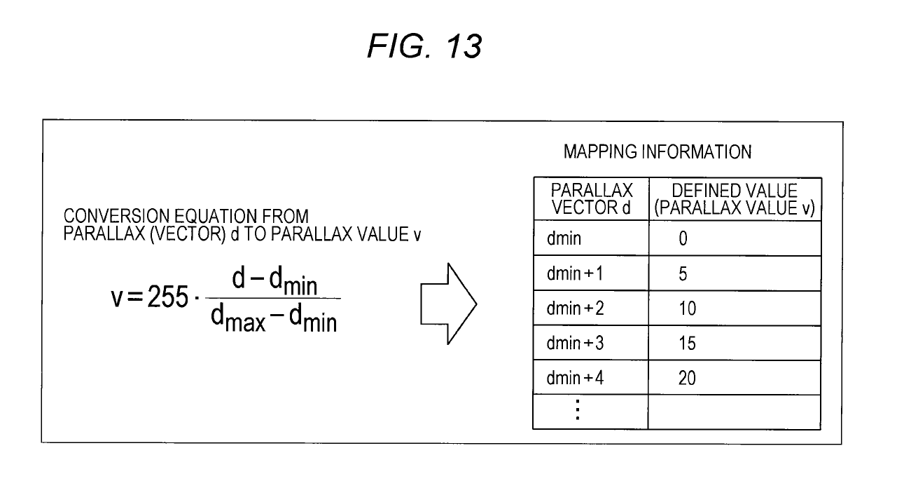

FIG. 13 is a view illustrating an example of the mapping information generated by the mapping information generating unit 231 in FIG. 11.

The mapping information generating unit 231 obtains the defined value, which the parallax value ν in equation (1) may take, according to the maximum value dmax and the minimum value dmin of the shooting parallax vector d of the parallax image D#2 and generates the list indicating the correspondence between each defined value and the shooting parallax vector d, which is made the defined value as the mapping information.

According to the mapping information in FIG. 13, it may be recognized that the shooting parallax vectors d=dmin, dmin+1, dmin+2, and so on are converted (mapped) to the parallax values ν=0, 5, 10, and so on, which are the defined values, in the parallax image D#2.

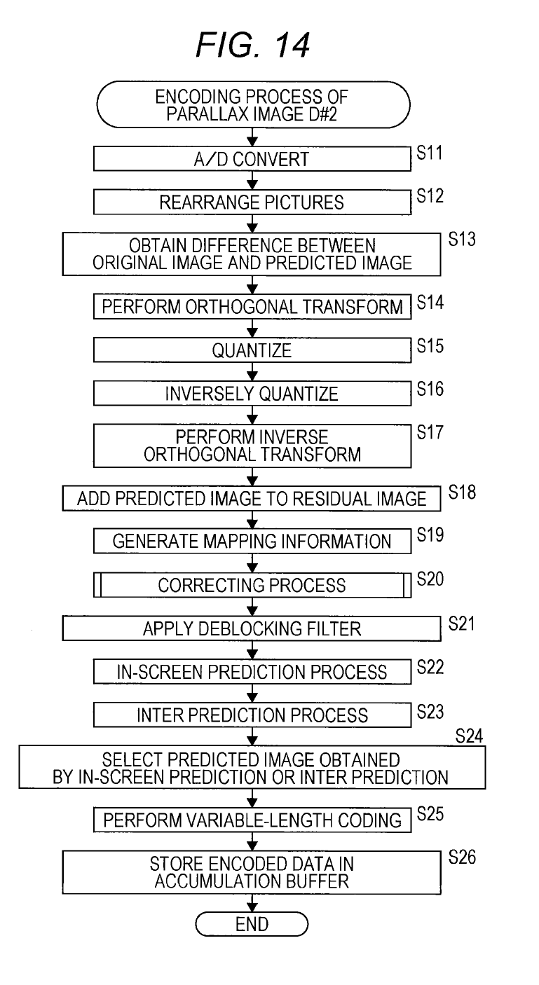

FIG. 14 is a flowchart illustrating an encoding process performed by the encoder 22 in FIG. 11 to encode the parallax image D#2 of the viewpoint #2.

At step S11, the A/D converting unit 211 A/D converts the analog signal of the picture of the parallax image D#2 of the viewpoint #2 supplied thereto and supplies the same to the screen rearrangement buffer 212, then the process shifts to step S12.

At step S12, the screen rearrangement buffer 212 temporarily stores the pictures of the parallax image D#2 from the A/D converting unit 211 and reads the pictures according to the structure of the GOP determined in advance, thereby performing the rearrangement to rearrange the order of the pictures from the order of display to the order of encoding (order of decoding).

The picture read from the screen rearrangement buffer 212 is supplied to the calculation unit 213, the in-screen prediction unit 222, the inter prediction unit 223, and the correcting unit 232, and the process shifts from step S12 to step S13.

At step S13, the calculation unit 213 makes the picture of the parallax image D#2 from the screen rearrangement buffer 212 the target picture to be encoded, and further sequentially makes the macroblock composing the target picture the target block to be encoded.

Then, the calculation unit 213 calculates the difference (residual) between the pixel value of the target block and the pixel value of the predicted image supplied from the predicted image selecting unit 224 as needed and supplies the same to the orthogonal transform unit 214, then the process shifts from step S13 to step S14.

At step S14, the orthogonal transform unit 214 applies the orthogonal transform to the target block from the calculation unit 213 and supplies the transform coefficient obtained as a result to the quantization unit 215, then the process shifts to step S15.

At step S15, the quantization unit 215 quantizes the transform coefficient supplied from the orthogonal transform unit 214 and supplies the quantization value obtained as a result to the inverse quantization unit 218 and the variable-length coding unit 216, then the process shifts to step S16.

At step S16, the inverse quantization unit 218 inversely quantizes the quantization value from the quantization unit 215 to obtain the transform coefficient and supplies the same to the inverse orthogonal transform unit 219, then the process shifts to step S17.

At step S17, the inverse orthogonal transform unit 219 performs the inverse orthogonal transform of the transform coefficient from the inverse quantization unit 218 and supplies the same to the calculation unit 220, then the process shifts to step S18.

At step S18, the calculation unit 220 adds the pixel value of the predicted image supplied from the predicted image selecting unit 224 to the data supplied from the inverse orthogonal transform unit 219 as needed, thereby obtaining the decoded target block, which is the decoded parallax image D#2 obtained by decoding (locally decoding) the target block. Then, the calculation unit 220 supplies the decoded target block to the correcting unit 232 and the process shifts from step S18 to step S19.

At step S19, the mapping information generating unit 231 obtains the information of the defined value, which the parallax value ν being the pixel value of the target picture of the parallax image D#2 may take, based on the parallax-related information and supplies the same to the correcting unit 232 as the mapping information, then the process shifts to step S20.

At step S20, the correcting unit 232 performs a correcting process to correct (the decoded pixel value being the pixel value of) the decoded target block from the calculation unit 220 using the mapping information from the mapping information generating unit 231 and the original target block, which is the target block in the target picture from the screen rearrangement buffer 212. Then, the correcting unit 232 supplies the corrected target block, which is the target block after the correcting process, to the deblocking filter 221 and the process shifts from step S20 to step S21.

At step S21, the deblocking filter 221 filters the decoded parallax image D#2 as the corrected target block from the correcting unit 232 and supplies the same to the DPB 31 (FIG. 4) to store, then the process shifts to step S22.

At step S22, the in-screen prediction unit 222 performs an intra prediction process (in-screen prediction process) of a next target block, which is the macroblock to be encoded next.

That is to say, the in-screen prediction unit 222 performs the intra prediction (in-screen prediction) to generate the predicted image (predicted image of the intra prediction) from the picture of the decoded parallax image D#2 stored in the DPB 31 for the next target block.

Then, the in-screen prediction unit 222 obtains the encoding cost required for encoding the target block using the predicted image of the intra prediction and supplies the same to the predicted image selecting unit 224 together with the predicted image of the intra prediction, then the process shifts from step S22 to step S23.

At step S23, the inter prediction unit 223 performs an inter prediction process of the next target block using the pictures of the decoded parallax images D#1 and D#2 stored in the DPB 31 as the reference pictures.

That is to say, the inter prediction unit 223 performs the inter prediction (parallax prediction and time prediction) of the next target block using the pictures of the decoded parallax images D#1 and D#2 stored in the DPB 31 as the reference pictures, thereby obtaining the predicted image, the encoding cost and the like for each inter prediction mode with different macroblock types and the like.

Further, the inter prediction unit 223 makes the inter prediction mode with the minimum encoding cost the optimal inter prediction mode and supplies the predicted image of the optimal inter prediction mode to the predicted image selecting unit 224 together with the encoding cost, then the process shifts from step S23 to step S24.

At step S24, the predicted image selecting unit 224 selects the predicted image with a smaller encoding cost, for example, out of the predicted image from the in-screen prediction unit 222 (predicted image of the intra prediction) and the predicted image from the inter prediction unit 223 (predicted images of the inter prediction) and supplies the same to the calculation units 213 and 220, then the process shifts to step S25.

Herein, the predicted image selected by the predicted image selecting unit 224 at step S27 is used in the processes at steps S13 and S18 performed in the encoding of the next target block.

Also, the in-screen prediction unit 222 supplies the information regarding the intra prediction obtained in the intra prediction process at step S22 to the variable-length coding unit 216 as the header information and the inter prediction unit 223 supplies the information regarding the inter prediction obtained in the inter prediction process at step S23 (mode-related information indicating the optimal inter prediction mode, the displacement vector information, the reference index for prediction and the like) to the variable-length coding unit 216 as the header information.

At step S25, the variable-length coding unit 216 applies variable-length coding to the quantization value from the quantization unit 215 to obtain the encoded data.

Further, the variable-length coding unit 216 selects the header information from the unit, which generates the predicted image with a smaller coding cost, from the header information from the in-screen prediction unit 222 and that from the inter prediction unit 223 and includes the same in the header of the encoded data.

Also, the variable-length coding unit 216 includes the parallax-related information and the correction flag output from the correcting unit 232 by the correcting process performed at step S20 in the header of the encoded data.

Then, the variable-length coding unit 216 supplies the encoded data to the accumulation buffer 217 and the process shifts from step S25 to step S26.

At step S26, the accumulation buffer 217 temporarily stores the encoded data from the variable-length coding unit 216 and outputs the same at a predetermined data rate.

The encoded data output from the accumulation buffer 217 is supplied to the multiplexing unit 32 (FIG. 4).

The encoder 22 appropriately repeatedly performs the above-described processes at steps S11 to S26.

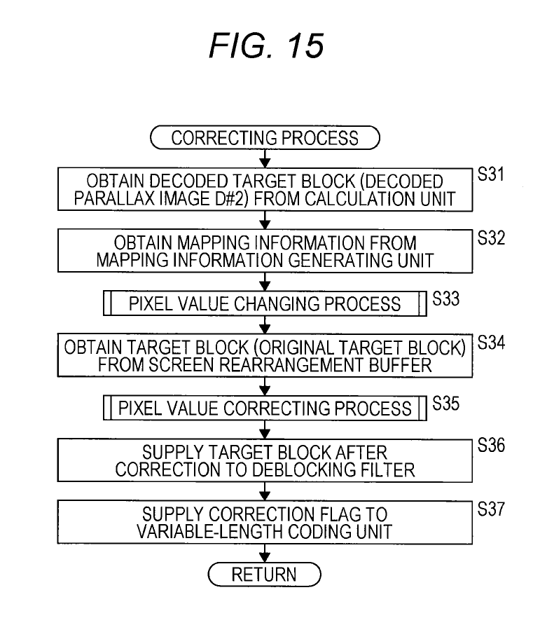

FIG. 15 is a flowchart illustrating the correcting process performed by the correcting unit 232 in FIG. 12 at step S20 in FIG. 14.

At step S31, the correcting unit 232 (FIG. 12) obtains the decoded target block, which is the decoded parallax image D#2 of the target block, from the calculation unit 220 and supplies the same to the pixel value changing unit 251 and the pixel value correcting unit 252, then the process shifts to step S32.

At step S32, the correcting unit 232 obtains the mapping information from the mapping information generating unit 231 and supplies the same to the pixel value changing unit 251, then the process shifts to step S33.

At step S33, the pixel value changing unit 251 performs a pixel value changing process to change the decoded pixel value, which is the pixel value of the decoded target block from the calculation unit 220, to the defined value based on the mapping information from the mapping information generating unit 231.

Then, the pixel value changing unit 251 supplies the changed target block, which is the target block composed of the changed pixel value being the pixel value changed to the defined value obtained by the pixel value changing process, to the pixel value correcting unit 252, and the process shifts to step S34.

At step S34, the correcting unit 232 obtains the original target block, which is the target block in the target picture from the screen rearrangement buffer 212, and supplies the same to the pixel value correcting unit 252, then the process shifts to step S35.

At step S35, the pixel value correcting unit 252 performs a pixel value correcting process to correct the pixel value of the decoded target block (decoded pixel value) based on the original target block from the screen rearrangement buffer 212, the changed target block from the pixel value changing unit 251, and the decoded target block from the calculation unit 220, and the process shifts to step S36.

At step S36, the pixel value correcting unit 252 supplies the corrected target block, which is the target block obtained by the pixel value correcting process at step S35, to the deblocking filter 221 and the process shifts to step S37.

At step S37, the pixel value correcting unit 252 supplies (outputs) the correction flag regarding the target block obtained by the pixel value correcting process at step S35 to the variable-length coding unit 216, and the process returns.

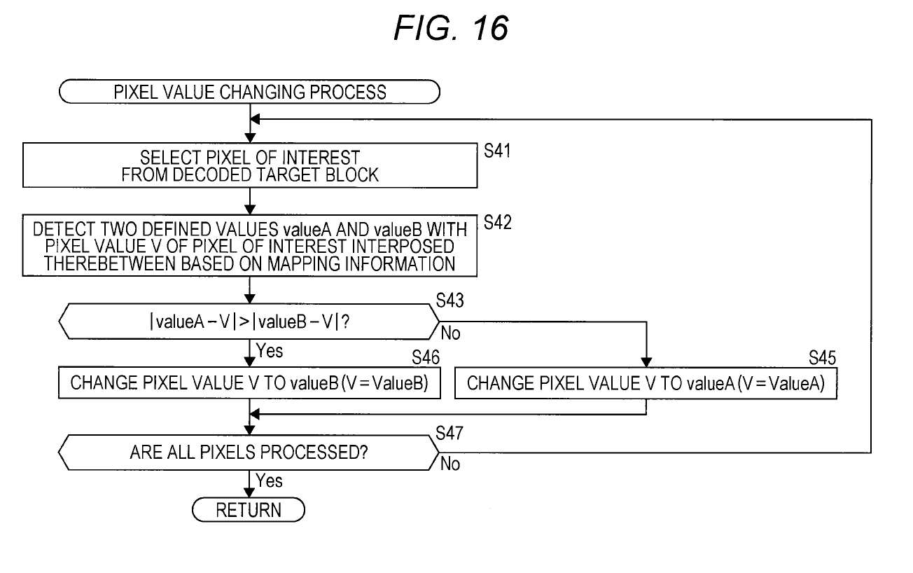

FIG. 16 is a flowchart illustrating the pixel value changing process performed by the pixel value changing unit 251 in FIG. 12 at step S33 in FIG. 15.

At step S41, the pixel value changing unit 251 selects one of the pixels not yet selected as a pixel of interest from the decoded target block as the pixel of interest and the process shifts to step S42.

At step S42, the pixel value changing unit 251 detects two defined values valueA and valueB with the pixel value (decoded pixel value) of the pixel of interest interposed therebetween based on the mapping information from the mapping information generating unit 231 and the process shifts to step S43.

Herein, the defined value valueA is a maximum defined value not larger than (or smaller than) the pixel value of the pixel of interest in the defined values obtained from the mapping information and the defined value valueB is a minimum defined value larger than (or not smaller than) the pixel value of the pixel of interest in the defined values obtained from the mapping information.

At step S43, the pixel value changing unit 251 determines whether a difference absolute value |valueA−V| between the defined value valueA and a pixel value V of the pixel of interest is larger than a difference absolute value |valueB−V| between the defined value valueB and the pixel value V of the pixel of interest.

At step S43, when it is determined that the difference absolute value |valueA−V| is not larger than the difference absolute value |valueB−V|, that is to say, when a nearest neighbor of the pixel value V of the pixel of interest is the defined value valueA in the defined values obtained from the mapping information, the process shifts to step S45 and the pixel value changing unit 251 changes the pixel value (decoded pixel value) of the pixel of interest to the defined value valueA, which is the nearest neighbor of the pixel value V of the pixel of interest, then the process shifts to step S47.

Therefore, in this case, the changed pixel value after the change of the pixel value V of the pixel of interest is the defined value valueA.

On the other hand, at step S43, when it is determined that the difference absolute value |valueA−V| is larger than the difference absolute value |valueB−V|, that is to say, when the nearest neighbor of the pixel value V of the pixel of interest is the defined value valueB in the defined values obtained from the mapping information, the process shifts to step S46 and the pixel value changing unit 251 changes the pixel value (decoded pixel value) of the pixel of interest to the defined value valueB, which is the nearest neighbor of the pixel value V of the pixel of interest, then the process shifts to step S47.

Therefore, in this case, the changed pixel value after the change of the pixel value V of the pixel of interest is the defined value valueB.

At step S47, the pixel value changing unit 251 determines whether all the pixel values (decoded pixel values) of the decoded target block are changed to the changed pixel values.

When it is determined that not all the pixel values of the decoded target block are changed to the changed pixel values at step S47, the process returns to step S41 and the similar process is hereinafter repeated.

At step S47, when it is determined that all the pixel values of the decoded target block are changed to the changed pixel values, that is to say, when the changed target block in which all the pixel values of the decoded target block are changed to the changed pixel values being the nearest neighbor defined values is obtained, the pixel value changing unit 251 supplies the changed target block to the pixel value correcting unit 252 and the process returns.

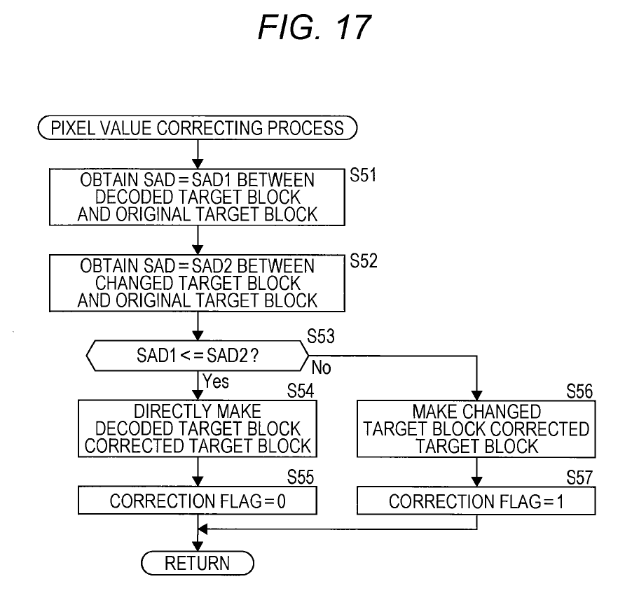

FIG. 17 is a flowchart illustrating the pixel value correcting process performed by the pixel value correcting unit 252 in FIG. 12 at step S35 in FIG. 15.

At step S51, the pixel value correcting unit 252 obtains SAD1, which is the SAD (SAD for the decoded target block) between the decoded target block from the calculation unit 220 and the original target block from the screen rearrangement buffer 212 and the process shifts to step S52.

At step S52, the pixel value correcting unit 252 obtains SAD2, which is the SAD (SAD for the changed target block) between the changed target block from the pixel value changing unit 251 and the original target block from the screen rearrangement buffer 212 and the process shifts to step S53.

At step S53, the pixel value correcting unit 252 determines whether the SAD1 for the decoded target block is not larger than the SAD2 for the changed target block.

At step S53, when it is determined that the SAD1 for the decoded target block is not larger than the SAD2 for the changed target block, that is to say, when the error of the decoded target block (with respect to the original target block) is not larger than the error of the changed target block (with respect to the original target block), so that the image quality of the decoded target block is better than that of the changed target block (the decoded target block more resembles the original target block than the changed target block does), the process shifts to step S54 and the pixel value correcting unit 252 makes the decoded target block the corrected target block (without correcting the pixel value of the decoded target block) and the process shifts to step S55.

A step S55, the pixel value correcting unit 252 sets a value indicating that the corrected target block is the decoded target block and is not corrected, for example, 0 as the correction flag and the process returns.

Also, at step S53, when it is determined that the SAD1 for the decoded target block is larger than the SAD2 for the changed target block, that is to say, when the error of the decoded target block (with respect to the original target block) is larger than the error of the changed target block (with respect to the original target block), so that the image quality of the changed target block is better than that of the decoded target block (the changed target block more resembles the original target block than the decoded target block does), the process shifts to step S56 and the pixel value correcting unit 252 makes the changed target block the corrected target block (by correcting the pixel value of the decoded target block to the defined value being the changed pixel value of the changed target block) and the process shifts to step S57.

At step S57, the pixel value correcting unit 252 sets a value indicating that the corrected target block is the changed target block and is corrected to the defined value, for example, 1 as the correction flag and the process returns.

[One Embodiment of Multi-View Image Decoder to which this Technology is Applied]

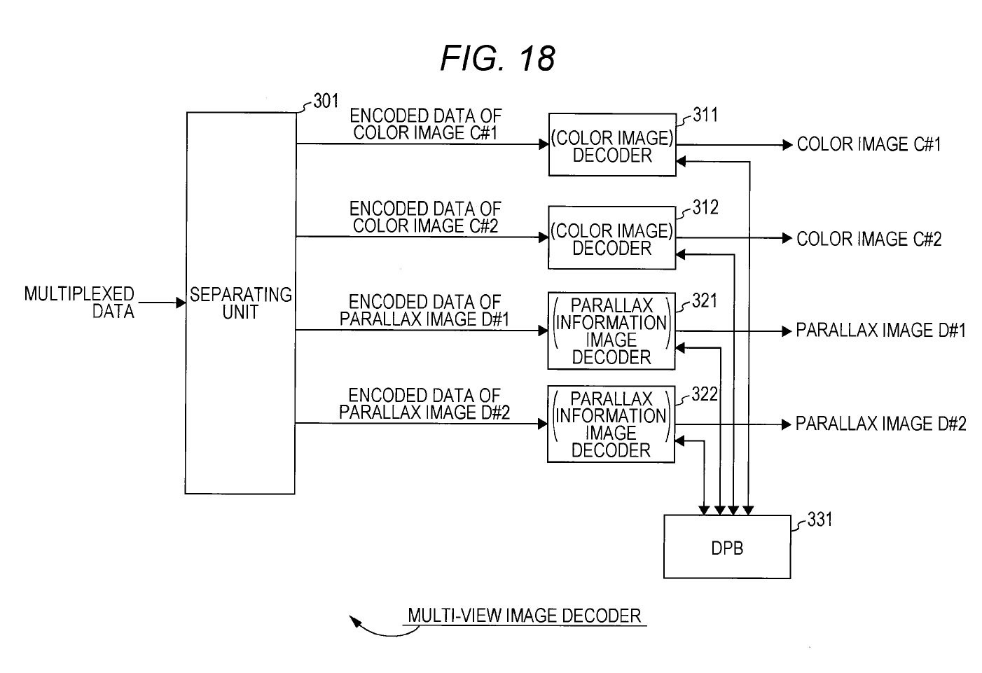

FIG. 18 is a block diagram illustrating a configuration example of one embodiment of a multi-view image decoder to which this technology is applied.

The multi-view image decoder in FIG. 18 is a decoder, which decodes the data obtained by encoding the images of a plurality of viewpoints using the MVC system, for example, and description of the same process as the MVC system is hereinafter appropriately omitted.

Meanwhile, the multi-view image decoder is not limited to the decoder, which uses the MVC system.

In the multi-view image decoder in FIG. 18, the multiplexed data output from the multi-view image encoder in FIG. 4 is decoded to the color image C#1 of the viewpoint #1 and the color image C#2 of the viewpoint #2, which are the color images of the two viewpoints #1 and #2, and the parallax image D#1 of the viewpoint #1 and the parallax image D#2 of the viewpoint #2, which are the parallax information images of the two viewpoints #1 and #2.

In FIG. 18, the multi-view image decoder includes a separating unit 301, decoders 311, 312, 321, and 322, and a DPB 331.

The multiplexed data output from the multi-view image encoder in FIG. 4 is supplied to the separating unit 301 through the recording medium and the transmitting medium not illustrated.

The separating unit 301 separates the encoded data of the color image C#1, the encoded data of the color image C#2, the encoded data of the parallax image D#1, and the encoded data of the parallax image D#2 from the multiplexed data supplied thereto.

Then, the separating unit 301 supplies the encoded data of the color image C#1 to the decoder 311, the encoded data of the color image C#2 to the decoder 312, the encoded data of the parallax image D#1 to the decoder 321, and the encoded data of the parallax image D#2 to the decoder 322.

The decoder 311 decodes the encoded data of the color image C#1 from the separating unit 301 and outputs the color image C#1 obtained as a result.

The decoder 312 decodes the encoded data of the color image C#2 from the separating unit 301 and outputs the color image C#2 obtained as a result.

The decoder 321 decodes the encoded data of the parallax image D#1 from the separating unit 301 and outputs the parallax image D#1 obtained as a result.

The decoder 322 decodes the encoded data of the parallax image D#2 from the separating unit 301 and outputs the parallax image D#2 obtained as a result.

The DPB 331 temporarily stores the image after the decoding (decoded images) obtained by decoding the image to be decoded by each of the decoders 311, 312, 321, and 322 as the candidate of the reference picture, which is referred when the predicted image is generated.

That is to say, the decoders 311, 312, 321, and 322 decode the images predictively encoded by the encoders 11, 12, 21, and 22 in FIG. 4, respectively.

The predicted image used in the predictive encoding is required for decoding the predictively encoded image, so that each of the decoders 311, 312, 321, and 322 temporarily stores the image after the decoding (decoded image) used for generating the predicted image in the DPB 331 after decoding the image to be decoded in order to generate the predicted image used in the predictive encoding.

The DPB 331 is the shared buffer, which temporarily stores the image after the decoding (decoded image) obtained by each of the decoders 311, 312, 321, and 322 and each of the decoders 311, 312, 321, and 322 selects the reference picture, which is referred to when the image to be decoded is decoded, from the decoded images stored in the DPB 331 and generates the predicted image using the reference picture.

Since the DPB 331 is shared by the decoders 311, 312, 321, and 322, each of the decoders 311, 312, 321, and 322 may also refer to the decoded image obtained by another decoder in addition to the decoded image obtained by itself.

### [Configuration Example of Decoder 311]

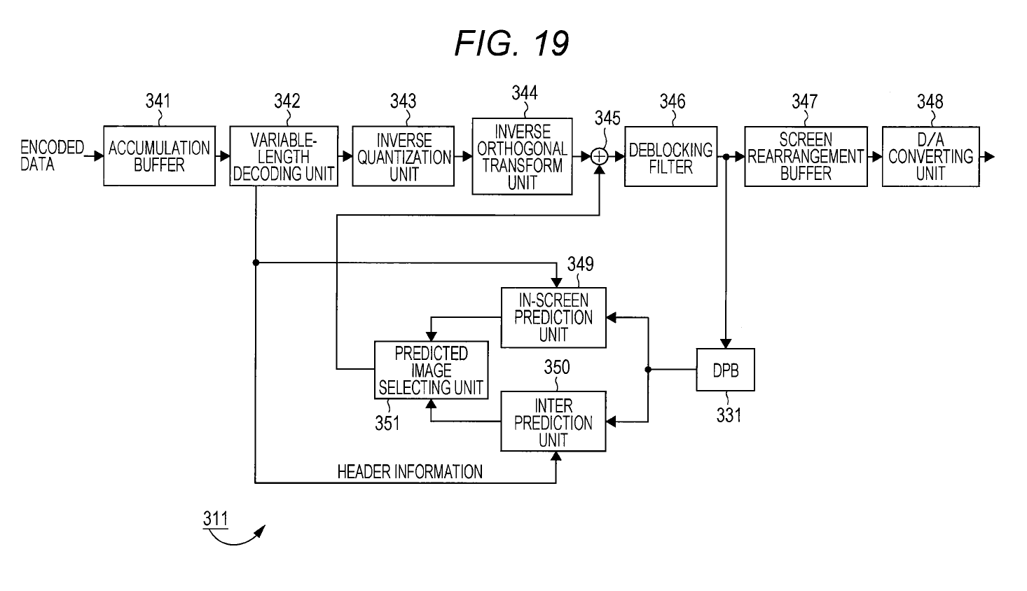

FIG. 19 is a block diagram illustrating a configuration example of the decoder 311 in FIG. 18.

Meanwhile, the decoder 312 in FIG. 18 is composed in the same manner as the decoder 311 and encodes the image according to the MVC system, for example.

In FIG. 19, the decoder 311 includes an accumulation buffer 341, a variable-length decoding unit 342, an inverse quantization unit 343, an inverse orthogonal transform unit 344, a calculation unit 345, a deblocking filter 346, a screen rearrangement buffer 347, a D/A converting unit 348, an in-screen prediction unit 349, an inter prediction unit 350, and a predicted image selecting unit 351.

The encoded data of the color image C#1 is supplied from the separating unit 301 (FIG. 18) to the accumulation buffer 341.

The accumulation buffer 341 temporarily stores the encoded data supplied thereto and supplies the same to the variable-length decoding unit 342.

The variable-length decoding unit 342 performs variable-length decoding of the encoded data from the accumulation buffer 341, thereby restoring the quantization value and the header information. Then, the variable-length decoding unit 342 supplies the quantization value to the inverse quantization unit 343 and supplies the header information to the in-screen prediction unit 349 and the inter prediction unit 350.

The inverse quantization unit 343 inversely quantizes the quantization value from the variable-length decoding unit 342 to obtain the transform coefficient and supplies the same to the inverse orthogonal transform unit 344.

The inverse orthogonal transform unit 344 performs the inverse orthogonal transform of the transform coefficient from the inverse quantization unit 343 and supplies the same to the calculation unit 345 in units of macroblocks.

The calculation unit 345 makes the macroblock supplied from the inverse orthogonal transform unit 344 the target block to be decoded and adds the predicted image supplied from the predicted image selecting unit 351 to the target block as needed, thereby obtaining the decoded image and supplies the same to the deblocking filter 346.

The deblocking filter 346 filters the decoded image from the calculation unit 345 in the same manner as the deblocking filter 121 in FIG. 7, for example, and supplies the decoded image after the filtering to the screen rearrangement buffer 347.

The screen rearrangement buffer 347 temporarily stores the pictures of the decoded image from the deblocking filter 346 to read, thereby rearranging the order of the pictures to its original order (order of display) and supplies the same to the D/A (Digital/Analog) converting unit 348.

The D/A converting unit 348 D/A converts the picture to output when it is required to output the picture from the screen rearrangement buffer 347 as the analog signal.

Also, the deblocking filter 346 supplies the decoded images of the I picture, the P picture, and the Bs picture, which are the referable pictures, out of the decoded images after the filtering to the DPB 331.

Herein, the DPB 331 stores the picture of the decoded image from the deblocking filter 346, that is to say, the picture of the color image C#1 as the candidate of the reference picture, which is referred to when the predicted image used in the decoding performed later is generated.

As illustrated in FIG. 18, the DPB 331 is shared by the decoders 311, 312, 321, and 322, so that this stores not only the picture of the color image C#1 decoded by the decoder 311 but also the picture of the color image C#2 decoded by the decoder 312, the picture of the parallax image D#1 decoded by the decoder 321, and the picture of the parallax image D#2 decoded by the decoder 322.

The in-screen prediction unit 349 recognizes whether the target block is encoded using the predicted image generated by the intra prediction (in-screen prediction) based on the header information from the variable-length decoding unit 342.

When the target block is encoded using the predicted image generated by the intra prediction, the in-screen prediction unit 349 reads an already decoded part (decoded image) of the picture (target picture) including the target block from the DPB 331 in the same manner as the in-screen prediction unit 122 in FIG. 7. Then, the in-screen prediction unit 349 supplies a part of the decoded image of the target picture read from the DPB 331 to the predicted image selecting unit 351 as the predicted image of the target block.

The inter prediction unit 350 recognizes whether the target block is encoded using the predicted image generated by the inter prediction based on the header information from the variable-length decoding unit 342.

When the target block is encoded using the predicted image generated by the inter prediction, the inter prediction unit 350 recognizes the reference index for prediction, that is to say, the reference index assigned to the reference picture used when the predicted image of the target block is generated, based on the header information from the variable-length decoding unit 342.

Then, the inter prediction unit 350 reads the reference picture to which the reference index for prediction is assigned from the reference pictures stored in the DPB 331.

Further, the inter prediction unit 350 recognizes the displacement vector (parallax vector and motion vector) used for generating the predicted image of the target block based on the header information from the variable-length decoding unit 342 and generates the predicted image by performing the displacement compensation of the reference picture (motion compensation to compensate the displacement in motion or the parallax compensation to compensate the displacement in parallax) according to the displacement vector in the same manner as the inter prediction unit 123 in FIG. 7.

That is to say, the inter prediction unit 350 obtains the block (corresponding block) in the position moved (displaced) according to the displacement vector of the target block from the position of the target block of the reference picture as the predicted image.

Then, the inter prediction unit 350 supplies the predicted image to the predicted image selecting unit 351.

When the predicted image is supplied from the in-screen prediction unit 349, the predicted image selecting unit 351 selects the predicted image and when the predicted image is supplied from the inter prediction unit 350, this selects the predicted image to supply to the calculation unit 345.

### [Configuration Example of Decoder 322]

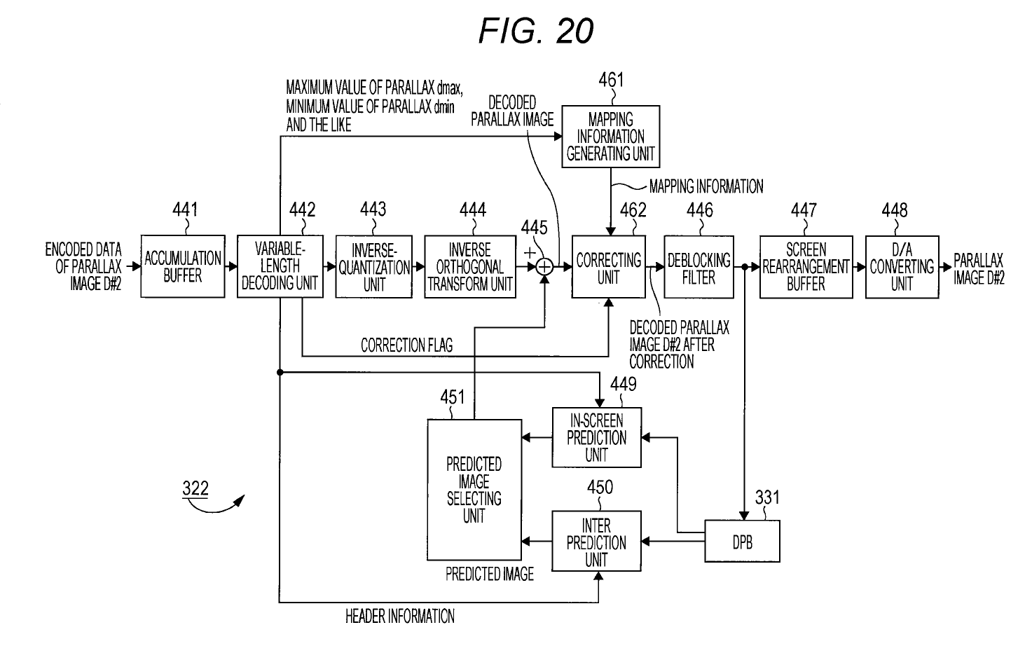

FIG. 20 is a block diagram illustrating a configuration example of the decoder 322 in FIG. 18.

The decoder 322 decodes the encoded data of the parallax image D#2 of the viewpoint #2 to be decoded using the MVC system, that is to say, in the same manner as the local decoding performed by the encoder 22 in FIG. 11.

In FIG. 20, the decoder 322 includes an accumulation buffer 441, a variable-length decoding unit 442, an inverse quantization unit 443, an inverse orthogonal transform unit 444, a calculation unit 445, a deblocking filter 446, a screen rearrangement buffer 447, a D/A converting unit 448, an in-screen prediction unit 449, an inter prediction unit 450, a predicted image selecting unit 451, a mapping information generating unit 461, and a correcting unit 462.

The accumulation buffer 441 to the predicted image selecting unit 451 are composed in the same manner as the accumulation buffer 341 to the predicted image selecting unit 351 in FIG. 19, so that the description thereof is appropriately omitted.

In FIG. 20, the picture of the decoded image, that is to say, the decoded parallax image D#2, which is the parallax image decoded by the decoder 322, is supplied from the deblocking filter 446 to the DPB 331 to be stored as the reference picture.

Also, the picture of the color image C#1 decoded by the decoder 311, the picture of the color image C#2 decoded by the decoder 312, and the picture of the parallax image (decoded parallax image) D#1 decoded by the decoder 321 are also supplied to the DPB 331 to be stored as illustrated in FIGS. 18 and 19.

The maximum value dmax and the minimum value dmin and the like of the shooting parallax vector d (shooting parallax vector d2 of the viewpoint #2) of the parallax image D#2, which is the decoding target of the encoder 322, as the parallax-related information included in the header information (FIG. 4) are supplied from the variable-length decoding unit 442 to the mapping information generating unit 461.

The mapping information generating unit 461 obtains the mapping information being the information of the defined value, which the parallax value ν being the pixel value of the parallax image D#2 may take, based on the parallax-related information and supplies the same to the correcting unit 462 in the same manner as the mapping information generating unit 231 in FIG. 11.

In addition to the mapping information supplied from the mapping information generating unit 461, the decoded image (decoded parallax image D#2) obtained by decoding the target block is supplied from the calculation unit 445 to the correcting unit 462.

Further, the correction flag included in the header information is supplied from the variable-length decoding unit 442 to the correcting unit 462.

The correcting unit 462 corrects (the decoded pixel value being the pixel value of) the decoded target block, which is the decoded image of the target block, from the calculation unit 445 using the mapping information from the mapping information generating unit 461 according to the correction flag from the variable-length decoding unit 442 in the same manner as the correcting unit 232 in FIG. 11 and supplies the corrected target block being the target block after the correction to the deblocking filter 446.

Meanwhile, the decoder 321 in FIG. 18 also is composed in the same manner as the decoder 322 in FIG. 20.

However, in the decoder 321, which decodes the parallax image D#1 being the image of the base view, the parallax prediction is not performed in the inter prediction as in the encoder 21.

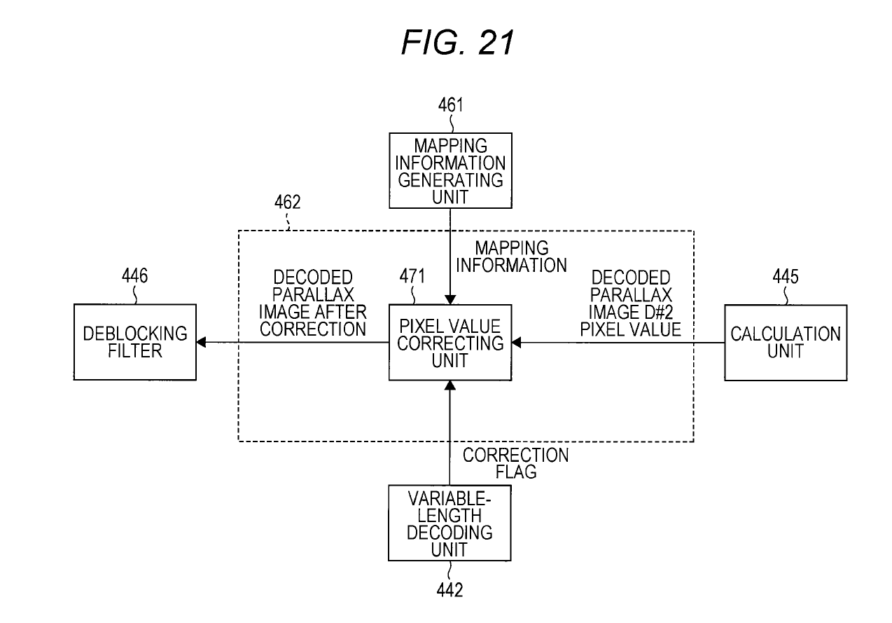

FIG. 21 is a block diagram illustrating a configuration example of the correcting unit 462 in FIG. 20.

In FIG. 21, the correcting unit 462 includes a pixel value correcting unit 471.

In addition to the decoded target block being the decoded parallax image D#2 of the target block supplied from the calculation unit 445, the mapping information is supplied from the mapping information generating unit 461 to the pixel value correcting unit 471.

Further, the correction flag is supplied from the variable-length decoding unit 442 to the pixel value correcting unit 471.

The pixel value correcting unit 471 obtains the correction flag of the target block (decoded target block) from the correction flag from the variable-length decoding unit 422, corrects the decoded target block from the calculation unit 445 according to the correction flag, and supplies the corrected target block, which is the target block after the correction, to the deblocking filter 446.

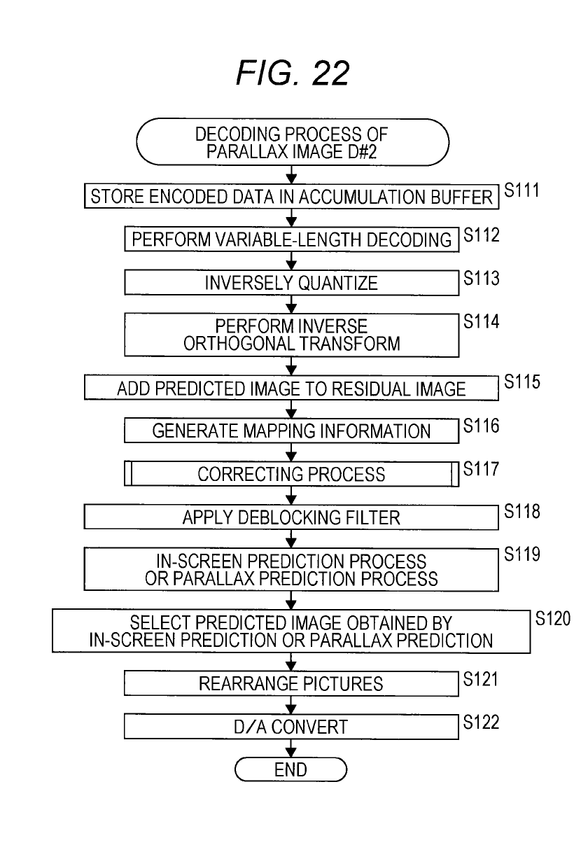

FIG. 22 is a flowchart illustrating a decoding process to decode the encoded data of the parallax image D#2 of the viewpoint #2 performed by the decoder 322 in FIG. 20.

At step S111, the accumulation buffer 441 stores the encoded data of the parallax image D#2 of the viewpoint #2 supplied thereto and the process shifts to step S112.

At step S112, the variable-length decoding unit 442 reads the encoded data stored in the accumulation buffer 441 and performs the variable-length decoding of the same, thereby restoring the quantization value and the header information. Then, the variable-length decoding unit 442 supplies the quantization value to the inverse quantization unit 443 and supplies the header information to the in-screen prediction unit 449, the inter prediction unit 450, the mapping information generating unit 461, and the correcting unit 462, then the process shifts to step S113.

At step S113, the inverse quantization unit 443 inversely quantizes the quantization value from the variable-length decoding unit 442 to obtain the transform coefficient and supplies the same to the inverse orthogonal transform unit 444, then the process shifts to step S114.

At step S114, the inverse orthogonal transform unit 444 performs the inverse orthogonal transform of the transform coefficient from the inverse quantization unit 443 and supplies the same to the calculation unit 445 in units of macroblocks, then the process shifts to step S115.

At step S115, the calculation unit 445 makes the macroblock from the inverse orthogonal transform unit 444 the target block (residual image) to be decoded and adds the predicted image supplied from the predicted image selecting unit 451 to the target block as needed, thereby obtaining the decoded target block, which is the decoded parallax image D#2 of the target block. Then, the calculation unit 445 supplies the decoded target block to the correcting unit 462 and the process shifts from step S115 to step S116.

At step S116, the mapping information generating unit 461 obtains the mapping information being the information of the defined value, which the parallax value ν being the pixel value of the parallax image D#2 may take, in the same manner as the mapping information generating unit 231 in FIG. 11 based on the maximum value dmax and the minimum value dmin of the shooting parallax vector d (shooting parallax vector d2 of the viewpoint #2) of the parallax image D#2, which is the decoding target of the encoder 322, as the parallax-related information included in the header information from the variable-length decoding unit 442. Then, the mapping information generating unit 461 supplies the mapping information to the correcting unit 462 and the process shifts to step S117.

At step S117, the correcting unit 462 performs the correcting process to correct the decoded target block from the calculation unit 445 in the same manner as the correcting unit 232 in FIG. 11 using the mapping information from the mapping information generating unit 461 according to the correction flag included in the header information from the variable-length decoding unit 442. Then, the correcting unit 462 supplies the corrected target block, which is the decoded target block after the correction, to the deblocking filter 446 and the process shifts from step S117 to step S118.

At step S118, the deblocking filter 446 filters the decoded parallax image D#2 of the corrected target block from the correcting unit 462 and supplies the decoded parallax image D#2 after the filtering to the DPB 331 and the screen rearrangement buffer 447, then the process shifts to step S119.

At step S119, the in-screen prediction unit 449 and the inter prediction unit 450 recognize the prediction system out of the intra prediction (in-screen prediction) and the inter prediction by which the predicted image used when the next target block (the macroblock to be decoded next) is encoded is generated based on the header information supplied from the variable-length decoding unit 442.

When the next target block is encoded using the predicted image generated by the in-screen prediction, the in-screen prediction unit 449 performs the intra prediction process (in-screen prediction process).

That is to say, the in-screen prediction unit 449 performs the intra prediction (in-screen prediction) to generate the predicted image (predicted image of the intra prediction) from the picture of the decoded parallax image D#2 stored in the DPB 331 for the next target block and supplies the predicted image to the predicted image selecting unit 451, then the process shifts from step S119 to step S120.

When the next target block is encoded using the predicted image generated by the inter prediction, the inter prediction unit 450 performs the inter prediction process.

That is to say, the inter prediction unit 450 selects the picture to which the reference index for prediction of the next target block included in the header information from the variable-length decoding unit 442 is assigned out of the pictures of the decoded parallax images D#1 and D#2 stored in the DPB 331 as the reference picture for the next target block.

Further, the inter prediction unit 450 performs the inter prediction (parallax compensation and motion compensation) using the mode-related information and the displacement vector information included in the header information from the variable-length decoding unit 442, thereby generating the predicted image and supplies the predicted image to the predicted image selecting unit 451, then the process shifts from step S119 to step S120.

At step S120, the predicted image selecting unit 451 selects the predicted image from the unit from which the predicted image is supplied out of the in-screen prediction unit 449 and the inter prediction unit 450 and supplies the same to the calculation unit 445, then the process shifts to step S121.

Herein, the predicted image selected by the predicted image selecting unit 451 at step S120 is used in the process at step S115 performed in the decoding of the next target block.

At step S121, the screen rearrangement buffer 447 temporarily stores the pictures of the decoded parallax image D#2 from the deblocking filter 446 to read, thereby rearranging the order of the pictures to its original order and supplies the same to the D/A converting unit 448, then the process shifts to step S122.

At step S122, the D/A converting unit 348 D/A converts the picture to output when it is required to output the picture from the screen rearrangement buffer 447 as the analog signal.

The decoder 322 appropriately repeatedly performs the above-described processes at steps S111 to S122.

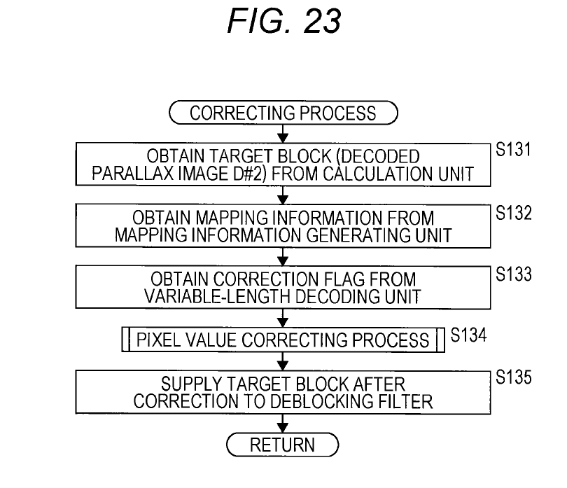

FIG. 23 is a flowchart illustrating the correcting process performed by the correcting unit 462 in FIG. 21 at step S117 in FIG. 22.

At step S131, the correcting unit 462 (FIG. 21) obtains the decoded target block, which is the decoded parallax image D#2 of the target block, from the calculation unit 445 and supplies the same to the pixel value correcting unit 471, then the process shifts to step S132.

At step S132, the correcting unit 462 obtains the mapping information from the mapping information generating unit 461 and supplies the same to the pixel value correcting unit 471, then the process shifts to step S133.

At step S133, the correcting unit 462 obtains the correction flag (of the decoded target block) included in the header information from the variable-length decoding unit 442 and supplies the same to the pixel value correcting unit 471, then the process shifts to step S134.

At step S134, the pixel value correcting unit 471 performs the pixel value correcting process to correct the decoded target block from the calculation unit 445 using the mapping information from the mapping information generating unit 461 as needed according to the correction flag from the variable-length decoding unit 442, and the process shifts to step S135.

At step S135, the pixel value correcting unit 471 supplies the corrected target block, which is the target block obtained by the pixel value correcting process at step S134, to the deblocking filter 446 and the process returns.

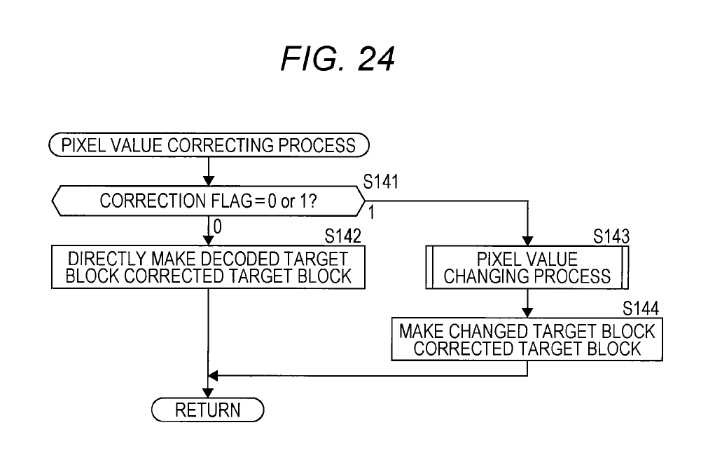

FIG. 24 is a flowchart illustrating the pixel value correcting process performed by the pixel value correcting unit 471 in FIG. 21 at step S134 in FIG. 23.

At step S141, the pixel value correcting unit 471 determines whether the correction flag from the variable-length decoding unit 442 is 0 or 1.

At step S141, when it is determined that the correction flag is 0, that is to say, when the decoded target block is not corrected by the encoder 22, which encodes the parallax image D#2, the process shifts to step S142, and the pixel value correcting unit 471 directly adopts the decoded target block from the calculation unit 445 as the corrected target block obtained by correcting the decoded target block, and the process returns.

When it is determined that the correction flag is 1 at step S141, that is to say, when the decoded target block is corrected to the defined value by the encoder 22, which encodes the parallax image D#2, the process shifts to step S143 and the pixel value correcting unit 471 performs the pixel value changing process similar to that in FIG. 16 using the decoded target block from the calculation unit 445 and the mapping information from the mapping information generating unit 461.

When the pixel value correcting unit 471 obtains the changed target block in which all the pixel values of the decoded target block from the calculation unit 445 are changed to the changed pixel values, which are the nearest neighbor defined values, similar to that illustrated in FIG. 16 by the pixel value changing process, the process shifts from step S143 to step S144.

At step S144, the pixel value correcting unit 471 adopts the changed target block obtained by the changed target block at step S143 as the corrected target block obtained by correcting the decoded target block and the process returns.

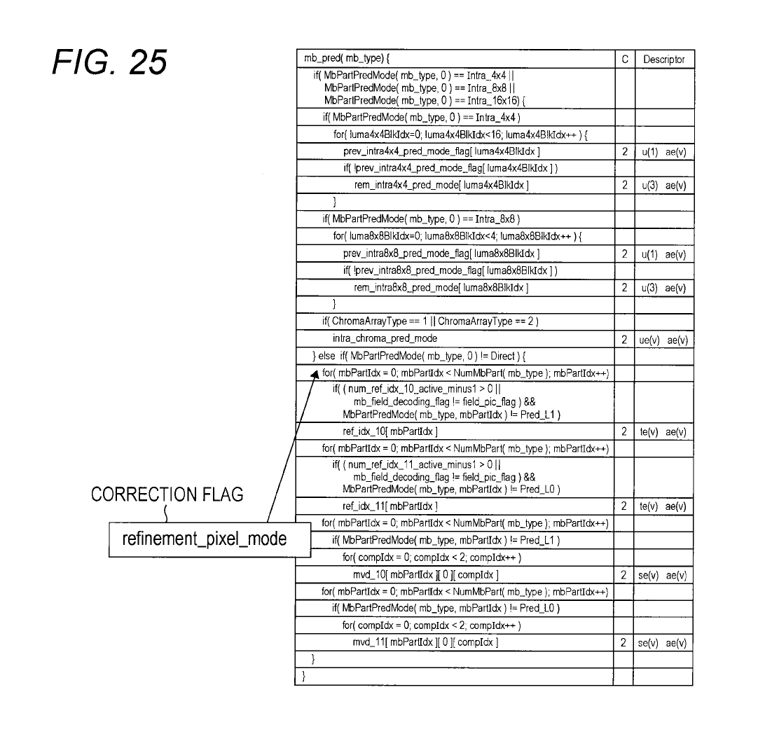

FIGS. 25 to 27 illustrate the correction flag included in the header when the encoded data is the encoded data in the MVC (AVC) system.

Herein, the correction to the defined value may be performed using the macroblock as the minimum unit.

The correction to the defined value may be performed using the partition of the macroblock type to divide the target block into the partitions not smaller than the 8×8-pixel partition (type not smaller than 8×8), that is to say, the macroblock type to divide the target block into the 8×8-pixel partitions (8×8 type), the macroblock type to divide the target block into the 16×8-pixel partitions (16×8 type), and the macroblock type to divide the target block into the 8×16-pixel partitions (8×16 type), as the minimum unit.

Further, the correction to the defined value may be performed using the partition (sub-partition) of the macroblock type (type smaller than 8×8) to divide the target block into the partitions smaller than the 8×8-pixel partition, that is to say, the 8×4-pixel, 4×8-pixel, or 4×4-pixel sub-partitions, as the minimum unit.

When the correction to the defined value is performed using the macroblock as the minimum unit, the correction flag is set using the macroblock as the minimum unit.

When the correction to the defined value is performed using the partition of the type not smaller than 8×8 as the minimum unit, the correction flag is set using the partition of the type not smaller than 8×8 as the minimum unit.

Further, when the correction to the defined value is performed using the partition (sub-partition) of the type smaller than 8×8 as the minimum unit, the correction flag is set using the partition (sub-partition) of the type smaller than 8×8 as the minimum unit.

FIG. 25 is a view illustrating the correction flag set using the macroblock as the minimum unit.

That is to say, FIG. 25 illustrates syntax of mb_pred (mb_type) in the MVC system.

When the correction flag is set using the macroblock as the minimum unit, the correction flag is included in mb_pred (mb_type).

In FIG. 25, refinement_pixel_mode indicates the correction flag.

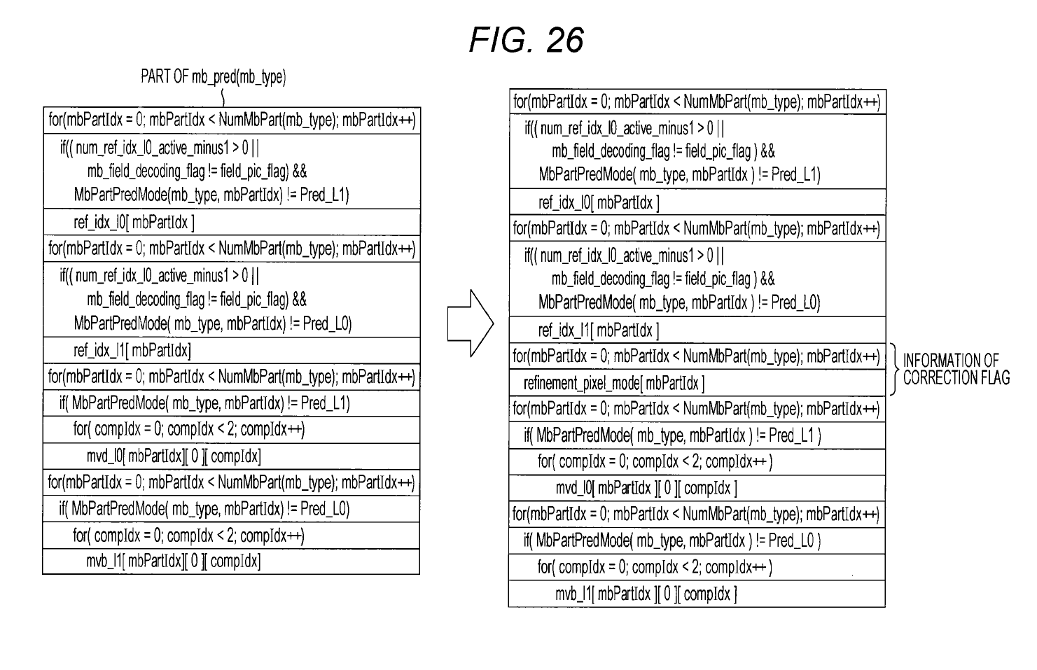

FIG. 26 is a view illustrating the correction flag set using the partition of the type not smaller than 8×8 as the minimum unit.

That is to say, FIG. 26 illustrates syntax of a part of mb_pred (mb_type) in the MVC system.

When the correction flag is set using the partition of the type not smaller than 8×8 as the minimum unit, the correction flag is included in mb_pred (mb_type).

In FIG. 26, refinement_pixel_mode[mbPartIdx] indicates the correction flag.

Meanwhile, an argument mbPartIdx of the correction flag refinement_pixel_mode[mbPartIdx] is an index for distinguishing each partition of the type not smaller than 8×8.

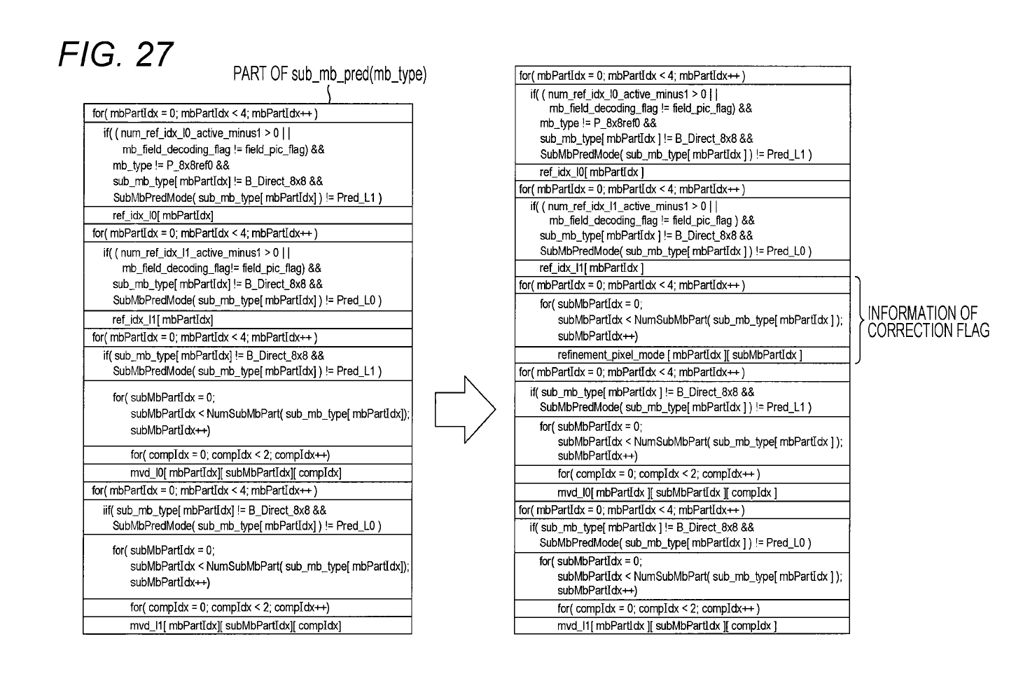

FIG. 27 is a view illustrating the correction flag set using the partition of the type smaller than 8×8 as the minimum unit.

That is to say, FIG. 27 illustrates syntax of a part of sub_mb_pred(mb_type) in the MVC system.

When the correction flag is set using the partition of the type smaller than 8×8 as the minimum unit, the correction flag is included in mb_pred(mb_type) and sub_mb_pred(mb_type).

Meanwhile, when the correction flag is set using the partition of the type smaller than 8×8 as the minimum unit, the correction flag included in mb_pred(mb_type) is as illustrated in FIG. 26 and FIG. 27 illustrates the correction flag included in sub_mb_pred(mb_type).

In FIG. 27, refinement_pixel_mode[mbPartIdx][subMbPartIdx] indicates the correction flag.

Meanwhile, an argument subMbPartIdx of the correction flag refinement_pixel_mode[mbPartIdx][subMbPartIdx] is an index for distinguishing each partition of the type smaller than 8×8.

Herein, when the correction flag is set using the macroblock as the minimum unit, increase in data amount of the header of the encoded data (overhead data amount) may be minimized.

On the other hand, when the correction flag is set using the partition (sub-partition) of the type smaller than 8×8 as the minimum unit, it is possible to control the correction of the pixel value (decoded pixel value) for each small-sized partition, thereby further improving the image quality of the decoded image (decoded parallax image D#2).

Also, when the correction flag is set using the partition of the type not smaller than 8×8 as the minimum unit, it is possible to realize an intermediate image quality between a case in which the macroblock is the minimum unit and a case in which the partition of the type smaller than 8×8 is the minimum unit while inhibiting the increase in data amount of the header of the encoded data.

[Relation Between Correction to Defined Value and Dynamic Range |dmax-dmin| of Shooting Parallax Vector d or Quantization Step]

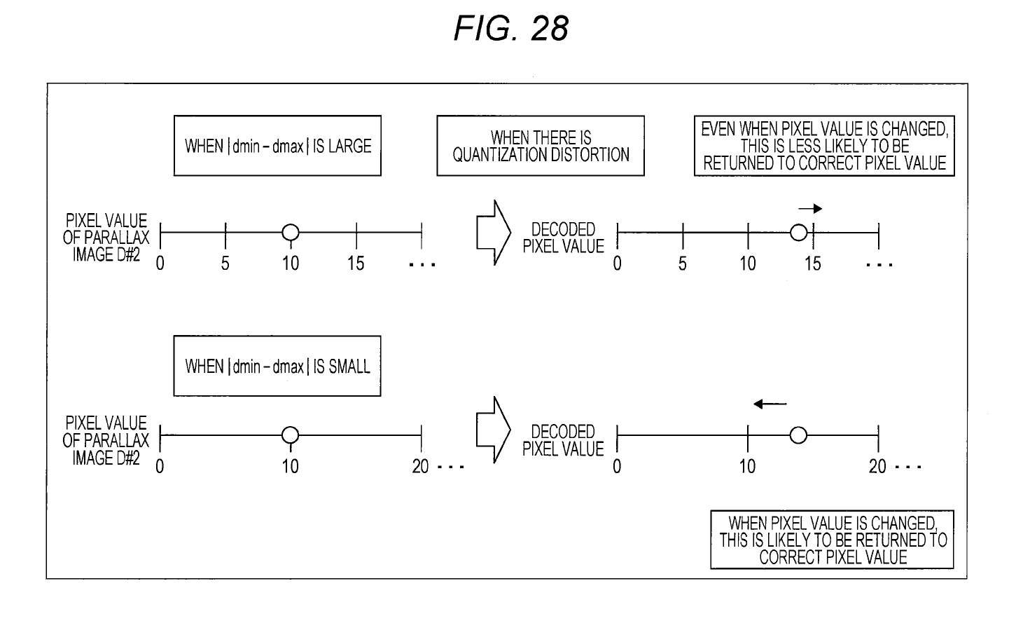

FIG. 28 is a view illustrating a relationship between the correction to the defined value and the dynamic range |dmax-dmin| of the shooting parallax vector d.

The defined value, which is the parallax value ν being the pixel value of the parallax image D#2 (the same applies to the parallax image D#1), is obtained according to equation (1), so that a gap between the defined values becomes narrow when the dynamic range |dmax-dmin| of the shooting parallax vector d2 is large and becomes wide when the dynamic range |dmax-dmin| is small.

When the gap between the defined values is narrow, an effect of the quantization distortion to the narrow gap between the defined values is large, so that, even when the pixel value of the decoded target block (decoded pixel value) is corrected (changed) to the nearest neighbor defined value, it is highly possible that this is corrected to the defined value different from the defined value, which is the parallax value ν of the original image.

That is to say, as illustrated in FIG. 28, when the parallax value ν as a certain pixel value of the parallax image D#2 (original image) is 10, if the gap between the defined value is narrow, it is highly possible that the decoded pixel value of the target block of the decoded parallax image D#2 (decoded target block) is closer to 15, which is the defined value different from the parallax value ν, than 10, which is the original parallax value ν, due to the quantization distortion.

In this case, when the decoded pixel value of the decoded target block is corrected to the nearest neighbor defined value, it is corrected to 15, which is the defined value different from the original parallax value ν=10.

On the other hand, when the gap between the defined values is wide, the effect of the quantization distortion to the wide gap between the defined values is small, so that when the decoded pixel value of the decoded target block is corrected to the nearest neighbor defined value, it is highly possible that this is corrected to the defined value, which is the parallax value ν of the original image.

That is to say, as illustrated in FIG. 28, when the parallax value ν as a certain pixel value of the parallax image D#2 (original image) is 10, if the gap between the defined values is wide, it is highly possible that the decoded pixel value of the target block of the decoded parallax image D#2 (decoded target block) is closer to the defined value, which is the original parallax value ν=10, even when this is affected by the quantization distortion.

In this case, when the decoded pixel value of the decoded target block is corrected to the nearest neighbor defined value, this is corrected to the defined value the same as the original parallax value ν=10.

Therefore, in this technology, it is possible to determine whether to perform the correction to the defined value based on the dynamic range |dmax-dmin| of the shooting parallax vector d.

That is to say, in this technology, it is possible (to increase the possibility) to perform the correction to the defined value is not performed when the dynamic range |dmax-dmin| is small and the gap between the defined values is small.

Also, in this technology, it is possible to correct (increase the possibility to correct) to the defined value when the dynamic range |dmax-dmin| is large and the gap between the defined values is wide.

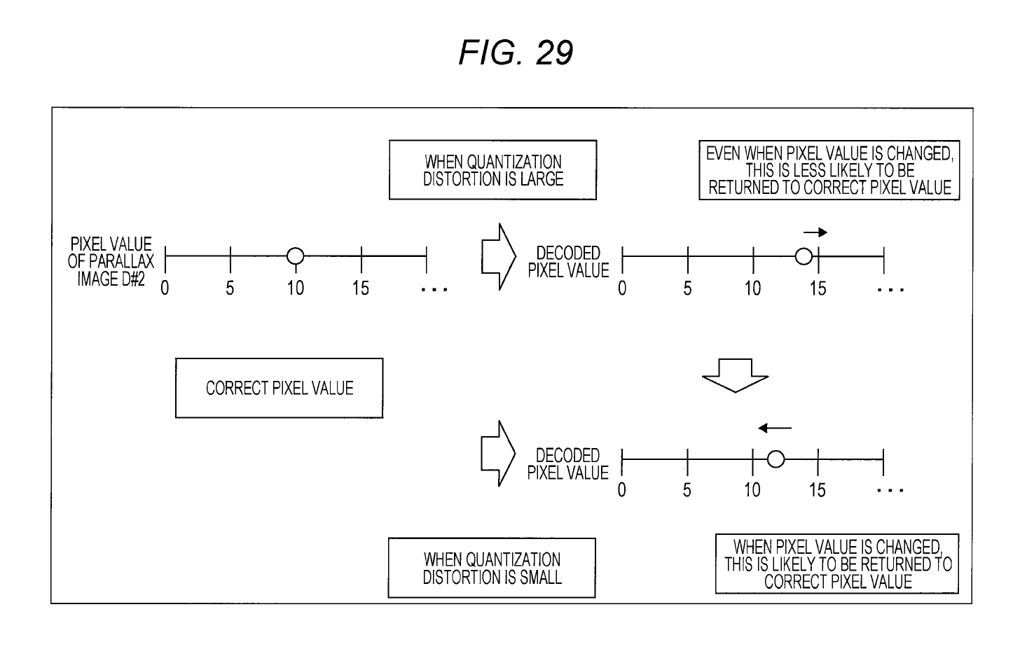

FIG. 29 is a view illustrating a relationship between the correction to the defined value and the quantization step of the target block.

When the quantization step is large, the quantization distortion is large (tends to be large), and as a result, the effect of the quantization distortion to the gap between the defined values is large, so that, even when the pixel value of the decoded target block (decoded pixel value) is corrected (changed) to the nearest neighbor defined value, it is highly possible that this is corrected to the defined value different from the defined value, which is the parallax value ν of the original image.

That is to say, as illustrated in FIG. 29, in a case in which the parallax value ν as a certain pixel value of the parallax image D#2 (original image) is 10, when the quantization step is large and the quantization distortion is also large as a result, it is highly possible that the decoded pixel value of the target block of the decoded parallax image D#2 (decoded target block) is closer to 15, which is the defined value different from the parallax value ν, than 10, which is the original parallax value ν, due to the quantization distortion.

In this case, when the decoded pixel value of the decoded target block is corrected to the nearest neighbor defined value, this is corrected to 15, which is the defined value different from the original parallax value ν=10.

On the other hand, when the quantization step is small, the quantization distortion is small (tends to be small), and the effect of the quantization distortion to the gap between the defined values is small as a result, so that, when the decoded pixel value of the decoded target block is corrected to the nearest neighbor defined value, it is highly possible that this is corrected to the defined value, which is the parallax value ν of the original image.

That is to say, as illustrated in FIG. 29, in a case in which the parallax value ν as a certain pixel value of the parallax image D#2 (original image) is 10, when the quantization step is small and the quantization distortion is also small as a result, it is highly possible that the decoded pixel value of the target block of the decoded parallax image D#2 (decoded target block) is closer the defined value, which is the original parallax value ν=10, even when this is affected by the quantization distortion.

In this case, when the decoded pixel value of the decoded target block is corrected to the nearest neighbor defined value, this is corrected to the defined value the same as the original parallax value ν=10.

Therefore, this technology may determine whether to perform the correction to the defined value based on the quantization step of the target block.

That is to say, in this technology, it is possible (to increase the possibility) that the correction to the defined value is not performed in a case in which the quantization step is large and the quantization distortion is large.

Also, in this technology, it is possible (to increase the possibility) to perform the correction to the defined value in a case in which the quantization step is small and the quantization distortion is small.

### [Another Configuration Example of Encoder 22]

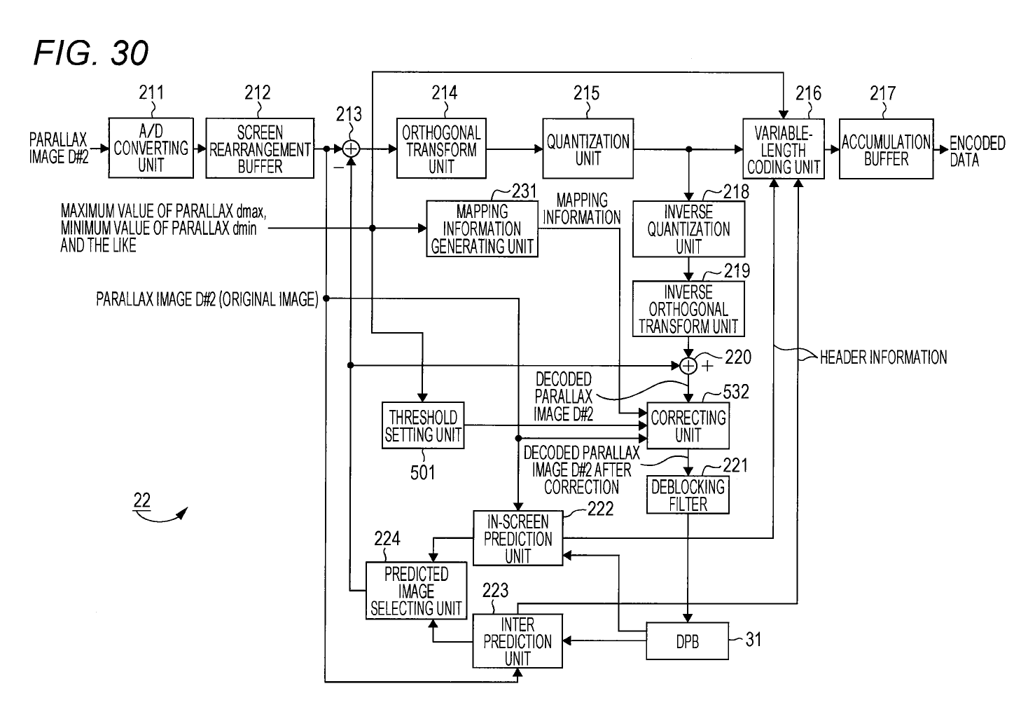

FIG. 30 is a block diagram illustrating another configuration example of the encoder 22 in FIG. 4.

Meanwhile, in the drawing, the same reference sign is assigned to a part corresponding to that in FIG. 11 and the description thereof is hereinafter appropriately omitted.

That is to say, the encoder 22 in FIG. 30 is the same as that in FIG. 11 in that this includes the A/D converting unit 211 to the predicted image selecting unit 224 and the mapping information generating unit 231.

However, the encoder 22 in FIG. 30 is different from that in FIG. 11 in that this is provided with a correcting unit 532 in place of the correcting unit 232 and is newly provided with a threshold setting unit 501.

The maximum value dmax and the minimum value dmin of the shooting parallax vector d (shooting parallax vector d2 of the viewpoint #2) of the parallax image D#2, which is the encoding target of the encoder 22 included in the parallax-related information (FIG. 4), are supplied to the threshold setting unit 501.

The threshold setting unit 501 obtains the difference absolute value |dmax-dmin| between the maximum value dmax and the minimum value dmin, which is the dynamic range of the shooting parallax vector d2, from the maximum value dmax and the minimum value dmin of the shooting parallax vector d2 of the parallax image D#2 supplied thereto.

Then, the threshold setting unit 501 sets a correction threshold Th, which is a threshold used to determine whether to perform the correction to the defined value, based on the dynamic range |dmax-dmin| and supplies the same to the correcting unit 532.

That is to say, the threshold setting unit 501 uses a function whose function value becomes smaller as an argument value becomes larger as a function for threshold to calculate the correction threshold Th, for example, calculates the function for threshold using the dynamic range |dmax-dmin| as the argument, and obtains the function value of the function for threshold as the correction threshold Th.

Therefore, in this embodiment, the correction threshold Th whose value is smaller may be obtained as the dynamic range |dmax-dmin| is larger.

In this embodiment, as described later, as the correction threshold Th is smaller, the correction to the defined value is less likely to be performed (as the correction threshold Th is larger, the correction to the defined value is likely to be performed).

Meanwhile, the function whose function value is a continuous value and the function whose function value is discrete values not smaller than a 2-level value may be adopted as the function for threshold.

In addition to the correction threshold Th supplied from the threshold setting unit 501, the mapping information is supplied from the mapping information generating unit 231 and the decoded target block (decoded parallax image D#2) is supplied from the calculation unit 220 to the correcting unit 532.

The correcting unit 532 corrects (the decoded pixel value being the pixel value of) the decoded target block from the calculation unit 220 to the defined value using the mapping information from the mapping information generating unit 231 and supplies the corrected target block, which is the target block after the correction, to the deblocking filter 221 in the same manner as the correcting unit 232 in FIG. 11.

However, the correcting unit 532 determines whether to correct (the decoded pixel value of) the decoded target block to the defined value based on the correction threshold Th from the threshold setting unit 501 and the quantization step (Qp of the macroblock) used in the quantization of the target block in the quantization unit 215 (and the inverse quantization unit 218).

That is to say, when the quantization step of the target block is larger than the correction threshold Th, the effect of the quantization distortion is large and it is highly possible that the decoded pixel is corrected to the defined value different from a correct defined value (pixel value of the original target block) even when this is corrected to the nearest neighbor defined value, so that the correcting unit 532 does not perform the correction to the defined value and directly supplies the decoded target block to the deblocking filter 221 as the corrected target block.

On the other hand, when the quantization step of the target block is not larger than the correction threshold Th, the effect of the quantization distortion is small and it is highly possible that the decoded pixel value is corrected to the correct defined value (pixel value of the original target block) when this is corrected to the nearest neighbor defined value, so that the correcting unit 532 performs the correction to the defined value.

That is to say, the correcting unit 532 obtains the changed target block composed of the changed pixel value obtained by changing the decoded pixel value to the nearest neighbor defined value and supplies the changed target block to the deblocking filter 221 as the corrected target block in the same manner as the correcting unit 232 in FIG. 11.

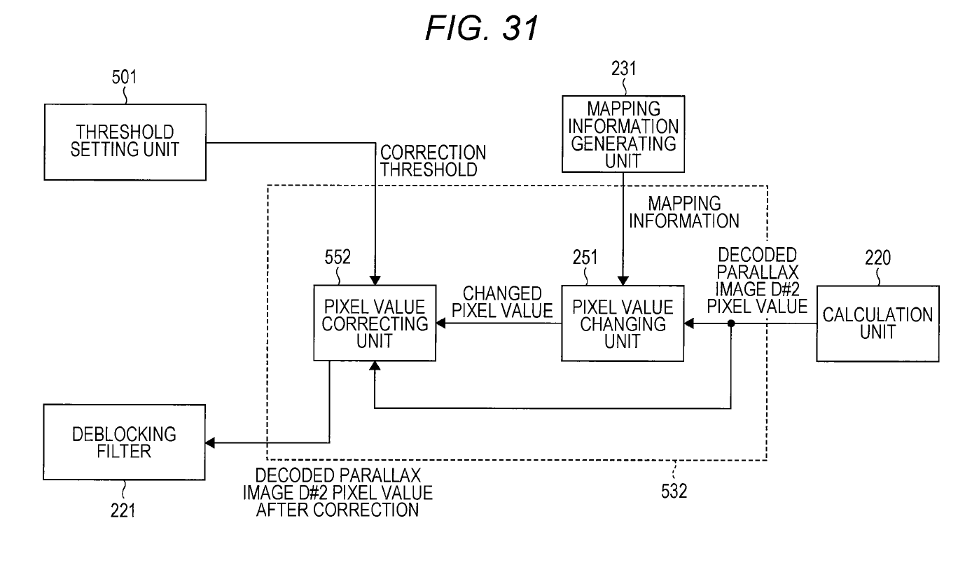

FIG. 31 is a block diagram illustrating a configuration example of the correcting unit 532 in FIG. 30.

Meanwhile, in the drawing, the same reference sign is assigned to a part corresponding to the correcting unit 232 in FIG. 12 and the description thereof is hereinafter appropriately omitted.

In FIG. 31, the correcting unit 532 includes a pixel value changing unit 251 and a pixel value correcting unit 552.

Therefore, the correcting unit 532 is the same as the correcting unit 232 in FIG. 12 in that this includes the pixel value changing unit 251 and different from the correcting unit 232 in FIG. 12 in that this includes the pixel value correcting unit 552 in place of the pixel value correcting unit 252.

The changed target block, which is the target block composed of the changed pixel value being the pixel value after the change obtained by changing the decoded pixel value being the pixel value of the decoded target block from the calculation unit 220 to the defined value based on the mapping information from the mapping information generating unit 231, is supplied from the pixel value changing unit 251 to the pixel value correcting unit 552.

The decoded target block is supplied from the calculation unit 220 and the correction threshold Th is supplied from the threshold setting unit 501 to the pixel value correcting unit 552.

The pixel value correcting unit 552 determines whether to correct (the decoded pixel value of) the decoded target block to the defined value based on a magnitude relationship between the correction threshold Th from the threshold setting unit 501 and the quantization step of the target block (Qp of the macroblock).

That is to say, when the quantization step of the target block is larger than the correction threshold Th, the effect of the quantization distortion is large and it is highly possible that the decoded pixel is corrected to the defined value different from the correct defined value (pixel value of the original target block) even when this is corrected to the nearest neighbor defined value, so that the pixel value correcting unit 552 determines not perform the correction to the defined value.

Then, the pixel value correcting unit 552 directly supplies the decoded target block from the calculation unit 220 to the deblocking filter 221 as the corrected target block.

On the other hand, when the quantization step of the target block is not larger than the corrected threshold Th, the effect of the quantization distortion is small and it is highly possible that the decoded pixel value is corrected to the correct defined value (pixel value of the original target block) when this is corrected to the nearest neighbor defined value, so that the pixel value correcting unit 552 determines to perform the correction to the defined value.

Then, the pixel value correcting unit 552 supplies the changed target block composed of the changed pixel value obtained by changing the decoded pixel value to the nearest neighbor defined value from the pixel value changing unit 251 to the deblocking filter 221 as the corrected target block.

As described above, since the correcting unit 532 performs the correction to the defined value when the quantization step of the target block is not larger than the correction threshold Th, the correction to the defined value is less likely to be performed as the correction threshold Th is smaller and the correction to the defined value is likely to be performed as the correction threshold Th is larger.

Herein, as illustrated in FIG. 28, when the dynamic range |dmax-dmin| is large, the gap between the defined values becomes narrow and the effect of the quantization distortion is large, so that it is highly possible that the pixel value of the decoded target block (the decoded pixel value) is corrected to the defined value different from the defined value, which is the parallax value ν of the original image, even when this is corrected to the nearest neighbor defined value.

Therefore, when the dynamic range |dmax-dmin| is large, the threshold setting unit 501 (FIG. 30) sets a small value as the correction threshold Th such that the correction to the defined value is less likely to be performed.

On the other hand, as illustrated in FIG. 28, when the dynamic range |dmax-dmin| is small, the gap between the defined values is wide and the effect of the quantization distortion is small, so that when the decoded pixel value of the decoded target block is corrected to the nearest neighbor defined value, it is highly possible that this is corrected to the defined value, which is the parallax value ν of the original image.

Therefore, when the dynamic range |dmax-dmin| is small, the threshold setting unit 501 (FIG. 30) sets a large value as the correction threshold Th such that the correction to the defined value is likely to be performed.

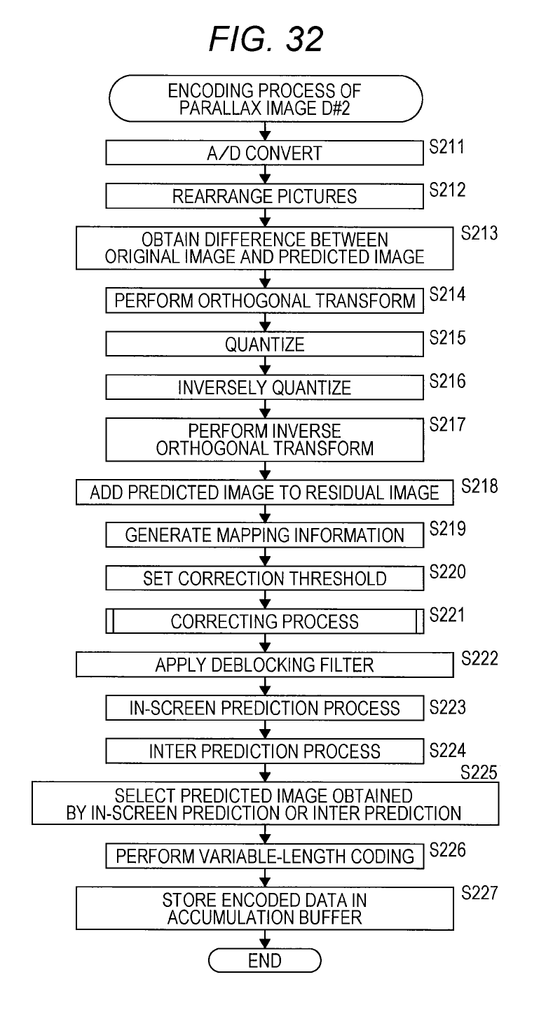

FIG. 32 is a flowchart illustrating the encoding process to encode the parallax image D#2 of the viewpoint #2 performed by the encoder 22 in FIG. 30.

At steps S211 to S218, the processes similar to those at steps S11 to S18 in FIG. 14 are performed.

Then, the calculation unit 220 supplies the decoded target block obtained at step S218 to the correcting unit 532 and the process shifts from step S218 to step S219.

At step S219, the mapping information generating unit 231 obtains (generates) the mapping information based on the parallax-related information as at step S19 in FIG. 14 and supplies the same to the correcting unit 532, then the process shifts to step S220.

At step S220, the threshold setting unit 501 obtains the dynamic range |dmax-dmin| of the shooting parallax vector d2 from the maximum value dmax and the minimum value dmin of the shooting parallax vector d2 included in the parallax-related information.

Then, the threshold setting unit 501 sets the correction threshold Th whose value is smaller as the dynamic range |dmax-dmin| is larger (the correction threshold Th whose value is larger as the dynamic range |dmax−dmin| is smaller) as described above based on the dynamic range |dmax-dmin| and supplies the same to the correcting unit 532, then the process shifts from step S220 to step S221.

At step S221, the correcting unit 532 performs the correcting process to correct (the decoded pixel value being the pixel value of) the decoded target block from the calculation unit 220 using the mapping information from the mapping information generating unit 231 and the correction threshold Th from the threshold setting unit 501. Then, the correcting unit 532 supplies the corrected target block, which is the target block after the correcting process, to the deblocking filter 221 and the process shifts from step S221 to step S222.

Hereinafter, the processes similar to those at steps S21 to 26 in FIG. 14 are performed at steps S222 to S227.

Meanwhile, although the variable-length coding unit 216 includes the correction flag output by the correcting unit 232 in FIG. 11 in the header of the encoded data at step S25 in FIG. 14, the correcting unit 532 in FIG. 30 does not output the correction flag, so that the correction flag is not included in the header of the encoded data by the variable-length coding unit 216 at step S226 in FIG. 32 corresponding to step S25 in FIG. 14.

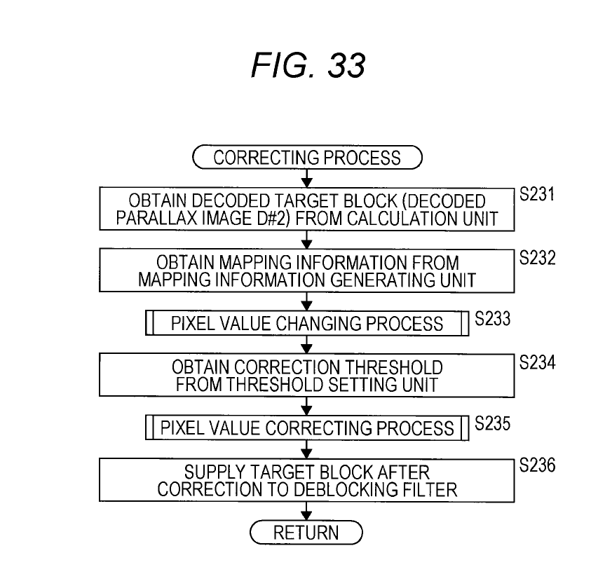

FIG. 33 is a flowchart illustrating the correcting process performed by the correcting unit 532 in FIG. 31 at step S221 in FIG. 32.

The processes similar to those at steps S31 to S33 in FIG. 15 are performed at steps S231 to S233.

That is to say, at step S231 the correcting unit 532 (FIG. 31) obtains the decoded target block from the calculation unit 220 and supplies the same to the pixel value changing unit 251 and the pixel value correcting unit 552, then the process shifts to step S232.

At step S232, the correcting unit 532 obtains the mapping information from the mapping information generating unit 231 and supplies the same to the pixel value changing unit 251, then the process shifts to step S233.

At step S233, the pixel value changing unit 251 performs the pixel value changing process similar to that in FIG. 16 to change (the decoded pixel value of) the decoded target block from the calculation unit 220 to the defined value based on the mapping information from the mapping information generating unit 231.

Then, the pixel value changing unit 251 supplies the changed target block, which is the target block composed of the changed pixel value being the pixel value changed to the defined value obtained by the pixel value change process, to the pixel value correcting unit 552, then the process shifts to step S234.

At step S234, the correcting unit 532 obtains the correction threshold Th from the threshold setting unit 501 and supplies the same to the pixel value correcting unit 552, then the process shifts to step S235.

At step S235, the pixel value correcting unit 552 performs the pixel value correcting process to correct the pixel value of the decoded target block (decoded pixel value) based on the changed target block from the pixel value changing unit 251, the decoded target block from the calculation unit 220, and the correction threshold Th from the threshold setting unit 501, then the process shifts to step S236.

At step S236, the pixel value correcting unit 552 supplies the corrected target block, which is the target block obtained by the pixel value correcting process at step S235, to the deblocking filter 221 and the process returns.

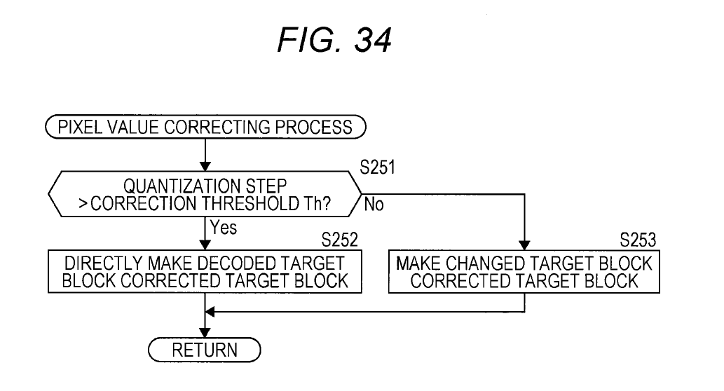

FIG. 34 is a flowchart illustrating the pixel value correcting process performed by the pixel value correcting unit 552 in FIG. 31 at step S235 in FIG. 33.

At step S251, the pixel value correcting unit 552 determines whether the quantization step of the target block (quantization step used in the quantization of the target block by the quantization unit 215 (FIG. 30)) is larger than the correction threshold Th from the threshold setting unit 501.

When it is determined that the quantization step of the target block is larger than the correction threshold Th at step S251, that is to say, when (the effect of) the quantization distortion is large in comparison with the gap between the defined values, the process shifts to step S252 and the pixel value correcting unit 552 makes the decoded target block the corrected target block (leaves the pixel value of the decoded target block unchanged without correcting the same), then the process returns.

When it is determined that the quantization step of the target block is not larger than the correction threshold Th at step S251, that is to say, when the quantization distortion is small in comparison with the gap between the defined values, the process shifts to step S253 and the pixel value correcting unit 552 makes the changed target block from the pixel value changing unit 251 the corrected target block (corrects the pixel value of the decoded target block to the defined value being the changed pixel value of the changed target block) and the process returns.

### [Another Configuration Example of Decoder 322]

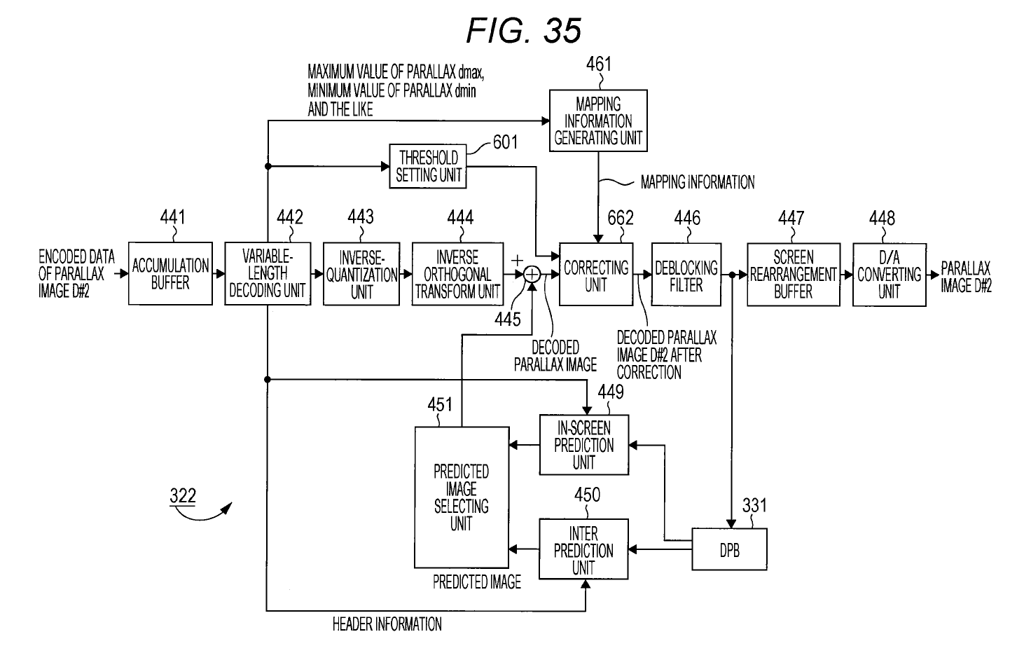

FIG. 35 is a block diagram illustrating another configuration example of the decoder 322 in FIG. 18.

That is to say, FIG. 35 illustrates a configuration example of the decoder 322 in a case in which the encoder 22 is composed as illustrated in FIG. 30.

Meanwhile, in the drawing, the same reference sign is assigned to a part corresponding to that in FIG. 20 and the description thereof is hereinafter appropriately omitted.

In FIG. 35, the decoder 322 is the same as that in FIG. 20 in that this includes the accumulation buffer 441 to the predicted image selecting unit 451 and the mapping information generating unit 461.

However, the decoder 322 in FIG. 35 is different from that in FIG. 20 in that this is provided with a correcting unit 662 in place of the correcting unit 462 and is newly provided with a threshold setting unit 601.

The maximum value dmax and the minimum value dmin of the shooting parallax vector d2 of the parallax image D#2, which is the decoding target of the decoder 322, included in the header information are supplied from the variable-length decoding unit 442 to the threshold setting unit 601.

The threshold setting unit 601 obtains the dynamic range |dmax-dmin| of the shooting parallax vector d2 from the maximum value dmax and the minimum value dmin of the shooting parallax vector d2 from the variable-length decoding unit 442 and sets the correction threshold Th based on the dynamic range |dmax-dmin| in the same manner as the threshold setting unit 501 in FIG. 30. Then, the threshold setting unit 601 supplies the correction threshold Th to the correcting unit 662.

In addition to the correction threshold Th supplied from the threshold setting unit 601, the mapping information is supplied from the mapping information generating unit 461 and the decoded target block (decoded parallax image D#2) is supplied from the calculation unit 445 to the correcting unit 662.

The correcting unit 662 determines whether to correct (the decoded pixel value of) the decoded target block to the defined value based on the correction threshold Th from the threshold setting unit 601 and the quantization step used for the inverse quantization of the target block by the inverse quantization unit 443 (the same as the quantization step used for the quantization of the target block by the quantization unit 215 in FIG. 30) in the same manner as the correcting unit 532 in FIG. 20.

Then, the correcting unit 662 corrects (the decoded pixel value being the pixel value of) the decoded target block from the calculation unit 445 to the defined value using the mapping information from the mapping information generating unit 461 according to a result of the determination and supplies the corrected target block, which is the target block after the correction, to the deblocking filter 446.

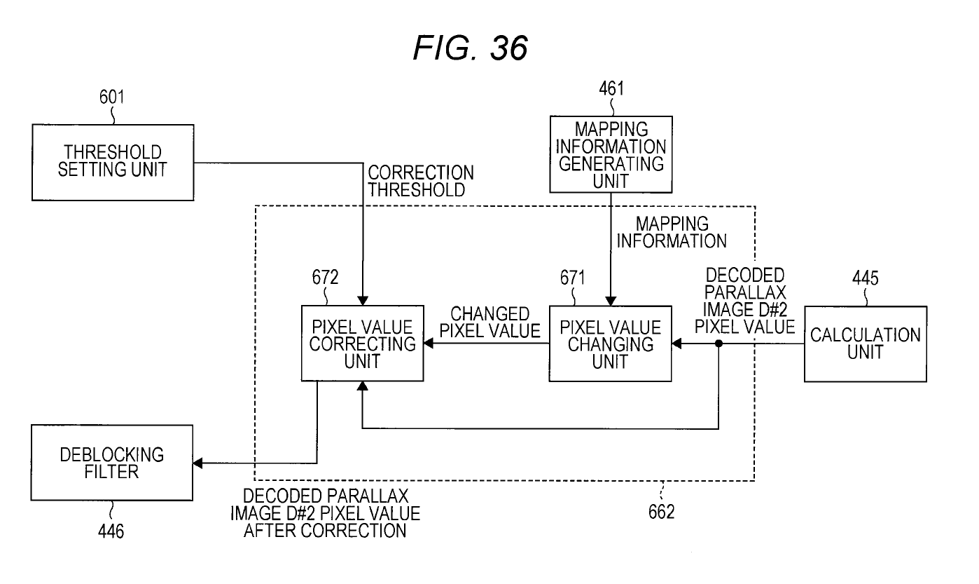

FIG. 36 is a block diagram illustrating a configuration example of the correcting unit 662 in FIG. 35.

In FIG. 36, the correcting unit 662 includes a pixel value changing unit 671 and a pixel value correcting unit 672.

The pixel value changing unit 671 and the pixel value correcting unit 672 perform the same processes as those of the pixel value changing unit 251 and the pixel value correcting unit 552 composing the correcting unit 532 in FIG. 31.

That is to say, the decoded target block, which is the decoded parallax image D#2 of the target block, is supplied from the calculation unit 445 and the mapping information is supplied from the mapping information generating unit 461 to the pixel value changing unit 671.

The pixel value changing unit 671 changes the decoded pixel value, which is the pixel value of the decoded target block from the calculation unit 445, to the defined value based on the mapping information from the mapping information generating unit 461 and supplies the changed target block, which is the target block composed of the changed pixel value being the pixel value after the change, to the pixel value correcting unit 672 in the same manner as the pixel value changing unit 251 in FIG. 31 (and FIG. 12).

In addition to the changed target block supplied from the pixel value changing unit 671, the decoded target block is supplied from the calculation unit 445 and the correction threshold Th is supplied from the threshold setting unit 601 to the pixel value correcting unit 672.

The pixel value correcting unit 672 determines whether to correct (the decoded pixel value of) the decoded target block from the calculation unit 445 to the defined value based on the magnitude relationship between the correction threshold Th from the threshold setting unit 601 and the quantization step of the target block (quantization step used in the inverse quantization of the target block by the inverse quantization unit 443 (FIG. 35)) in the same manner as the pixel value correcting unit 552 in FIG. 31.

That is to say, when the quantization step of the target block is larger than the correction threshold Th, the effect of the quantization distortion is large and it is highly possible that the decoded pixel value is corrected to the defined value different from the correct defined value (pixel value of the original target block) even when this is corrected to the nearest neighbor defined value, so that the pixel value correcting unit 672 determines that the correction to the defined value is not performed.

Then, the pixel value correcting unit 672 directly supplies the decoded target block from the calculation unit 445 to the deblocking filter 446 as the corrected target block.

On the other hand, when the quantization step of the target block is not larger than the corrected threshold Th, the effect of the quantization distortion is small, and it is highly possible that the decoded pixel value is corrected to the correct defined value (pixel value of the original target block) when this is corrected to the nearest neighbor defined value, so that the pixel value correcting unit 672 determines to perform the correction to the defined value.

Then, the pixel value correcting unit 672 supplies the changed target block composed of the changed pixel value obtained by changing the decoded pixel value to the nearest neighbor defined value from the pixel value changing unit 671 to the deblocking filter 446 as the corrected target block.

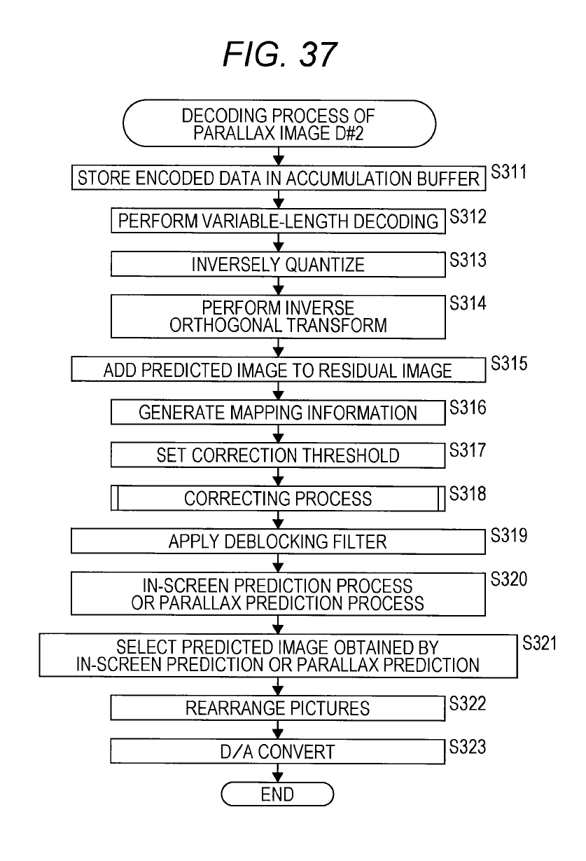

FIG. 37 is a flowchart illustrating the decoding process to decode the encoded data of the parallax image D#2 of the viewpoint #2 performed by the decoder 322 in FIG. 35.

At steps S311 to S315, the processes similar to those at steps S111 to S115 in FIG. 22 are performed.

Then, the calculation unit 445 supplies the decoded target block obtained at step S315 to the correcting unit 662 and the process shifts from step S315 to step S316.

At step S316, the mapping information generating unit 461 obtains the mapping information and supplies the same to the correcting unit 662, then the process shifts from step S316 to step S317.

At step S317, the threshold setting unit 601 sets the correction threshold Th and supplies the same to the correcting unit 662, then the process shifts to step S318.

At step S318, the correcting unit 662 performs the correcting process the same as that in FIG. 33 to correct (the decoded pixel value being the pixel value of) the decoded target block from the calculation unit 445 using the mapping information from the mapping information generating unit 461 and the correction threshold Th from the threshold setting unit 601. Then, the correcting unit 662 supplies the corrected target block, which is the target block after the correcting process, to the deblocking filter 446 and the process shifts from step S318 to step S319.

Hereinafter, the processes similar to those at steps S118 to S122 in FIG. 20 are performed at steps S319 to S323.

Meanwhile, in the description above, although it is determined whether to perform the correction to the defined value based on both of the dynamic range |dmax-dmin| and the quantization step, that is to say, the correction threshold Th is set based on the dynamic range |dmax-dmin| and it is determined whether the correction to the defined value is performed by a threshold process of the quantization step using the correction threshold Th, it is possible to determine whether to perform the correction to the defined value based on one of the dynamic range |dmax-dmin| and the quantization step.

That is to say, it is possible to determine whether to perform the correction to the defined value by setting a fixed threshold and performing the threshold process of the dynamic range |dmax-dmin| or the quantization by using the fixed threshold, for example.

[Description of Computer to which this Technology is Applied]

A series of processes described above may be performed by hardware or by software. When a series of processes are performed by the software, a program, which composes the software, is installed on a multi-purpose computer and the like.

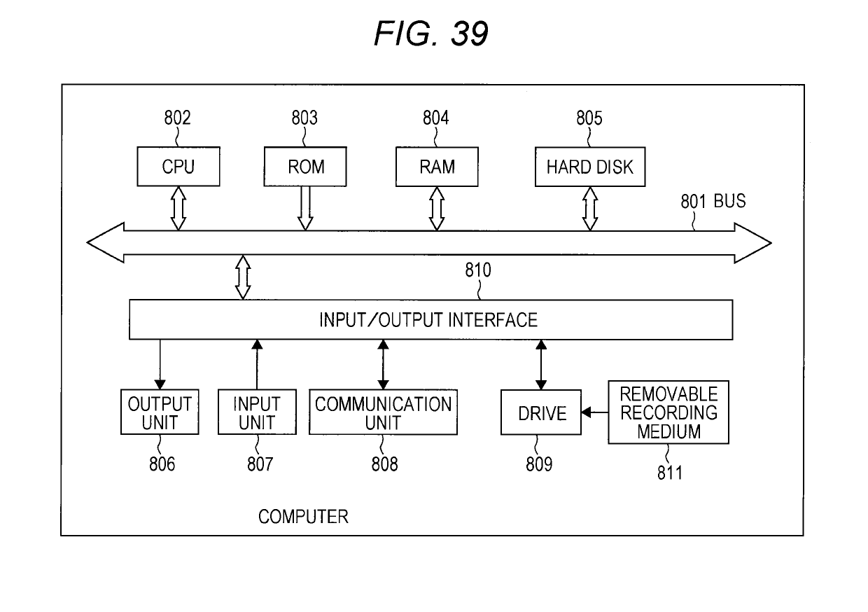

FIG. 39 illustrates a configuration example of one embodiment of the computer on which the program, which executes a series of processes described above, is installed.

The program may be recorded in advance on a hard disk 805 and a ROM 803 as recording media embedded in the computer.

Alternatively, the program may be stored in (recorded on) a removable recording medium 811. Such removable recording medium 811 may be provided as so-called packaged software. Herein, the removable recording medium 811 includes a flexible disk, a CD-ROM (Compact Disc Read Only Memory), an MO (Magneto-Optical) disk, a DVD (Digital Versatile Disc), a magnetic disk, a semiconductor memory and the like, for example.

Meanwhile, the program may be installed on the computer from the above-described removable recording medium 811 or may be downloaded to the computer through a communication network and a broadcast network to be installed on the embedded hard disk 805. That is, the program may be wirelessly transmitted from a downloading site to the computer through a satellite for digital satellite broadcasting or may be transmitted by wire to the computer through the network such as a LAN (Local Area Network) and the Internet, for example.

A CPU (Central Processing Unit) 802 is embedded in the computer and an input/output interface 810 is connected to the CPU 802 through a bus 801.

When an instruction is input by operation and the like of an input unit 807 by a user through the input/output interface 810, the CPU 802 executes the program stored in the ROM (Read Only Memory) 803 according to this. Alternatively, the CPU 802 loads the program stored in the hard disk 805 onto a RAM (Random Access Memory) 804 to execute.

According to this, the CPU 802 performs the process according to the above-described flowchart or the process performed by the configuration of the above-described block diagram. Then, the CPU 802 outputs a processing result from an output unit 806 or transmits the same from a communication unit 808, or records the same on the hard disk 805 through the input/output interface 810, for example, as needed.

Meanwhile, the input unit 807 is composed of a keyboard, a mouse, a microphone and the like. The output unit 806 is composed of a LCD (Liquid Crystal Display), a speaker and the like.

Herein, in this specification, the process performed by the computer according to the program is not necessarily performed in chronological order along the order described as the flowchart. That is to say, the process performed by the computer according to the program also includes the process executed in parallel or independently executed (for example, a parallel process and a process by an object).

Also, the program may be processed by one computer (processor) or processed by a plurality of computers. Further, the program may be transmitted to a remote computer to be executed.

### [Configuration Example of Television Device]

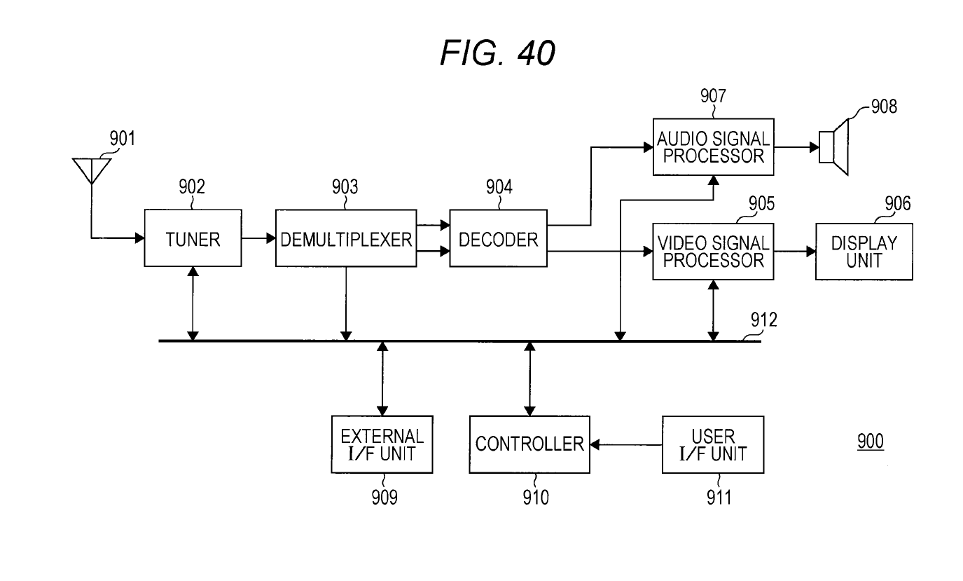

FIG. 40 illustrates a schematic configuration of a television device to which this technology is applied. A television device 900 includes an antenna 901, a tuner 902, a demultiplexer 903, a decoder 904, a video signal processor 905, a display unit 906, an audio signal processor 907, a speaker 908, and an external interface unit 909. Further, the television device 900 includes a controller 910, a user interface unit 911 and the like.

The tuner 902 selects an intended channel from a broadcast wave signal received by the antenna 901 to demodulate and outputs an obtained encoded bit stream to the demultiplexer 903.

The demultiplexer 903 extracts a packet of video and audio of a program to be watched from the encoded bit stream and outputs data of the extracted packet to the decoder 904. The demultiplexer 903 supplies a packet of data such as EPG (Electronic Program Guide) to the controller 910. Meanwhile, when scrambling is applied, the scrambling is cancelled by the demultiplexer and the like.

The decoder 904 performs a decoding process of the packet and outputs video data and audio data generated by the decoding process to the video signal processor 905 and the audio signal processor 907, respectively.

The video signal processor 905 performs noise reduction, video processing according to user setting and the like of the video data. The video signal processor 905 generates the video data of a program to be displayed on the display unit 906 and image data according to a process based on an application supplied through a network. The video signal processor 905 also generates the video data for displaying a menu screen and the like for selecting an item and the like and superimposes the same on the video data of the program. The video signal processor 905 generates a drive signal based on the video data generated in this manner to drive the display unit 906.

The display unit 906 drives a display device (for example, a liquid crystal display device and the like) based on the drive signal from the video signal processor 905 to display video of the program and the like.

The audio signal processor 907 applies a predetermined process such as the noise reduction to the audio data, performs a D/A conversion process and an amplifying process of the audio data after the process and supplies the same to the speaker 908, thereby outputting audio.

The external interface unit 909 is an interface for connecting to an external device and the network and this transmits and receives the data such as the video data and the audio data.

The user interface unit 911 is connected to the controller 910. The user interface unit 911 is composed of an operating switch, a remote control signal receiving unit and the like and supplies an operation signal according to user operation to the controller 910.

The controller 910 is composed of a CPU (Central Processing Unit), a memory and the like. The memory stores a program executed by the CPU, various data necessary for the CPU to perform a process, the EPG data, the data obtained through the network and the like. The program stored in the memory is read by the CPU at predetermined timing such as on start-up of the television device 900 to be executed. The CPU executes the program to control each unit such that the television device 900 operates according to the user operation.

Meanwhile, the television device 900 is provided with a bus 912 for connecting the tuner 902, the demultiplexer 903, the video signal processor 905, the audio signal processor 907, the external interface unit 909 and the like to the controller 910.

In the television device configured in this manner, the decoder 904 is provided with a function of an image processing device (image processing method) of this application. Therefore, it is possible to improve the image quality of the decoded image.

### [Configuration Example of Mobile Phone]

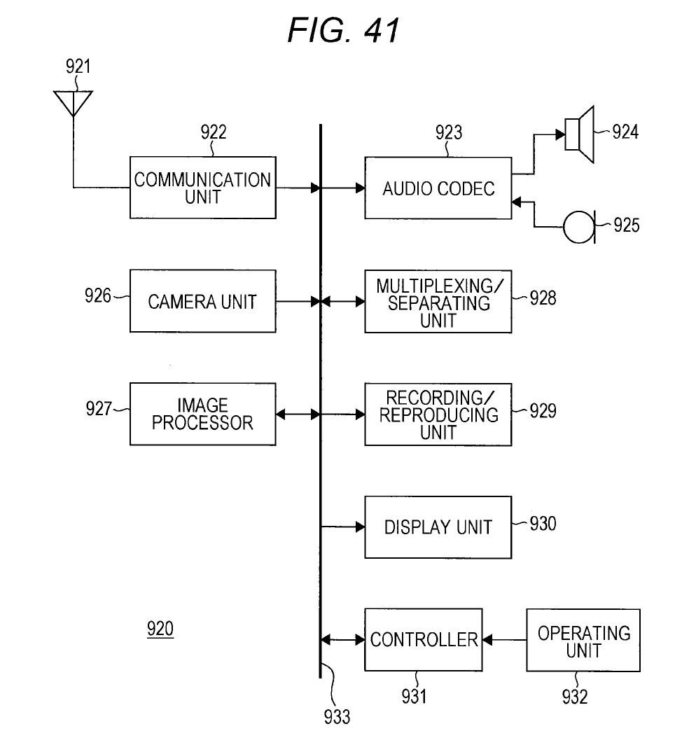

FIG. 41 illustrates a schematic configuration of a mobile phone to which this technology is applied. A mobile phone 920 includes a communication unit 922, an audio codec 923, a camera unit 926, an image processor 927, a multiplexing/separating unit 928, a recording/reproducing unit 929, a display unit 930, and a controller 931. They are connected to each other through a bus 933.

An antenna 921 is connected to the communication unit 922, and a speaker 924 and a microphone 925 are connected to the audio codec 923. Further, an operating unit 932 is connected to the controller 931.

The mobile phone 920 performs various pieces of operation such as transmission and reception of an audio signal, transmission and reception of e-mail and image data, image taking, and data recording in various modes such as an audio call mode and a data communication mode.

In the audio call mode, the audio signal generated by the microphone 925 is converted to audio data and compressed by the audio codec 923 to be supplied to the communication unit 922. The communication unit 922 performs a modulation process, a frequency conversion process and the like of the audio data to generate a transmitting signal. The communication unit 922 supplies the transmitting signal to the antenna 921 to transmit to a base station not illustrated. The communication unit 922 also amplifies a received signal received by the antenna 921 and performs the frequency conversion process, a demodulation process and the like thereof, then supplies the obtained audio data to the audio codec 923. The audio codec 923 decompresses the audio data and converts the same to an analog audio signal to output to the speaker 924.

Also, when the mail is transmitted in the data communication mode, the controller 931 accepts character data input by operation of the operating unit 932 and displays an input character on the display unit 930. The controller 931 also generates mail data based on a user instruction and the like in the operating unit 932 and supplies the same to the communication unit 922. The communication unit 922 performs the modulation process, the frequency conversion process and the like of the mail data and transmits the obtained transmitting signal from the antenna 921. The communication unit 922 amplifies the received signal received by the antenna 921 and performs the frequency conversion process, the demodulation process and the like thereof, thereby restoring the mail data. The mail data is supplied to the display unit 930 and a mail content is displayed.

Meanwhile, the mobile phone 920 may also store the received mail data in a storage medium by the recording/reproducing unit 929. The storage medium is an optional rewritable storage medium. For example, the storage medium is a semiconductor memory such as a RAM and an embedded flash memory, and a removable medium such as a hard disk, a magnetic disk, a magneto-optical disk, an optical disk, a USB memory, and a memory card.

When the image data is transmitted in the data communication mode, the image data generated by the camera unit 926 is supplied to the image processor 927. The image processor 927 performs an encoding process of the image data to generate encoded data.

The multiplexing/separating unit 928 multiplexes the encoded data generated by the image processor 927 and the audio data supplied from the audio codec 923 using a predetermined system and supplies the same to the communication unit 922. The communication unit 922 performs the modulation process, the frequency conversion process and the like of the multiplexed data and transmits the obtained transmitting signal from the antenna 921. The communication unit 922 also amplifies the received signal received by the antenna 921 and performs the frequency conversion process, the demodulation process and the like thereof, thereby restoring the multiplexed data. The multiplexed data is supplied to the multiplexing/separating unit 928. The multiplexing/separating unit 928 separates the multiplexed data and supplies the encoded data and the audio data to the image processor 927 and the audio codec 923, respectively. The image processor 927 performs a decoding process of the encoded data to generate the image data. The image data is supplied to the display unit 930 and the received image is displayed. The audio codec 923 converts the audio data to the analog audio signal and supplies the same to the speaker 924 to output received audio.

In the mobile phone device configured in this manner, the image processor 927 is provided with a function of the image processing device (image processing method) of this application. Therefore, it is possible to improve the image quality of the decoded image.

### [Configuration Example of Recording/Reproducing Device]

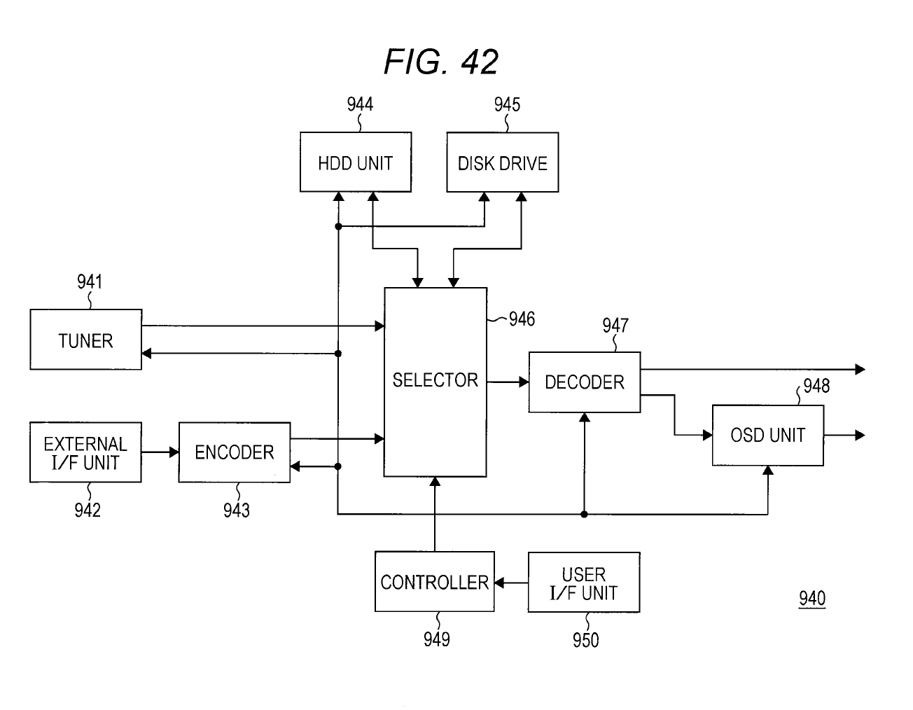

FIG. 42 illustrates a schematic configuration of a recording/reproducing device to which this technology is applied. A recording/reproducing device 940 records audio data and video data of a received broadcast program on a recording medium, for example, and provides the recorded data to the user at timing according to an instruction of the user. The recording/reproducing device 940 may also obtain the audio data and the video data from another device, for example, and record them on the recording medium. Further, the recording/reproducing device 940 may decode the audio data and the video data recorded on the recording medium to output, thereby displaying an image and outputting audio by a monitor device and the like.

The recording/reproducing device 940 includes a tuner 941, an external interface unit 942, an encoder 943, a HDD (Hard Disk Drive) unit 944, a disk drive 945, a selector 946, a decoder 947, an OSD (On-Screen Display) unit 948, a controller 949, and a user interface unit 950.

The tuner 941 selects an intended channel from a broadcast signal received by an antenna not illustrated. The tuner 941 outputs an encoded bit stream obtained by demodulating a received signal of the intended channel to the selector 946.

The external interface unit 942 is composed of at least any one of an IEEE1394 interface, a network interface unit, a USB interface, a flash memory interface and the like. The external interface unit 942 is an interface for connecting to an external device, a network, a memory card and the like, and receives the data such as the video data and the audio data to be recorded.

When the video data and the audio data supplied from the external interface unit 942 are not encoded, the encoder 943 encodes them using a predetermined system and outputs the encoded bit stream to the selector 946.

The HDD unit 944 records contents data such as video and audio, various programs, another data and the like on an embedded hard disk and reads them from the hard disk at the time of reproduction and the like.

The disk drive 945 records and reproduces a signal on and from an optical disk mounted thereon. The optical disk is a DVD (DVD-Video, DVD-RAM, DVD-R, DVD-RW, DVD+R, DVD+RW and the like), a Blu-ray Disc and the like, for example.

The selector 946 selects the encoded bit stream from the tuner 941 or the encoder 943 and supplies the same to the HDD unit 944 or the disk drive 945 when recording the video and the audio. The selector 946 also supplies the encoded bit stream output from the HDD unit 944 or the disk drive 945 to the decoder 947 when reproducing the video and the audio.

The decoder 947 performs a decoding process of the encoded bit stream. The decoder 947 supplies the video data generated by the decoding process to the OSD unit 948. The decoder 947 outputs the audio data generated by the decoding process.

The OSD unit 948 generates the video data for displaying a menu screen and the like for selecting an item and the like and superimposes the same on the video data output from the decoder 947 to output.

The user interface unit 950 is connected to the controller 949. The user interface unit 950 is composed of an operating switch, a remote control signal receiving unit and the like and supplies an operation signal according to a user operation to the controller 949.

The controller 949 is composed of a CPU, a memory and the like. The memory stores a program executed by the CPU and various data necessary for the CPU to perform a process. The program stored in the memory is read by the CPU at predetermined timing such as on start-up of the recording/reproducing device 940 to be executed. The CPU executes the program to control each unit such that the recording/reproducing device 940 operates according to user operation.

In the recording/reproducing device configured in this manner, the decoder 947 is provided with a function of an image processing device (image processing method) of this application. Therefore, it is possible to improve the image quality of the decoded image.

### [Configuration Example of Image Taking Device]

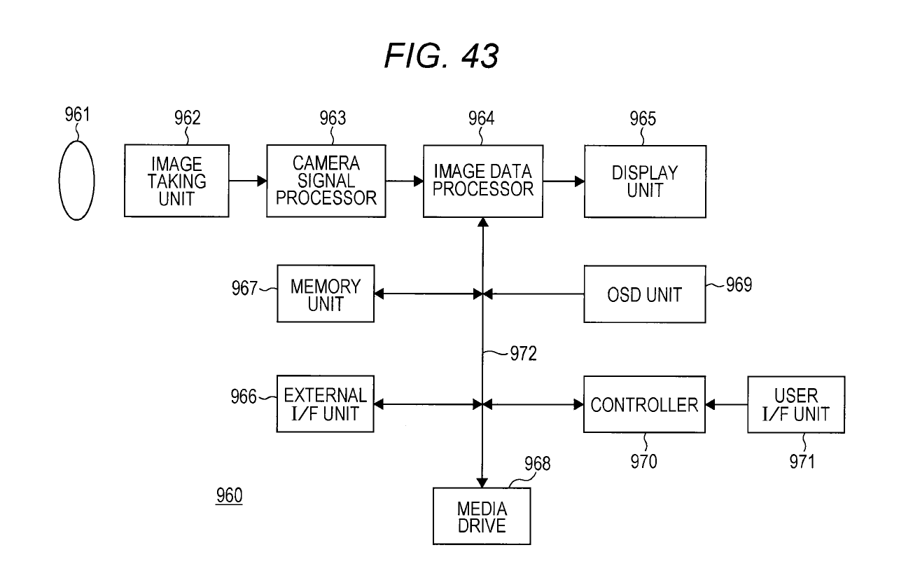

FIG. 43 illustrates a schematic configuration of an image taking device to which this technology is applied. An image taking device 960 takes an image of a subject and displays the image of the subject on a display unit or records the same on a recording medium as image data.

The image taking device 960 includes an optical block 961, an image taking unit 962, a camera signal processor 963, an image data processor 964, a display unit 965, an external interface unit 966, a memory unit 967, a media drive 968, an OSD unit 969, and a controller 970. A user interface unit 971 is connected to the controller 970. Further, the image data processor 964, the external interface unit 966, the memory unit 967, the media drive 968, the OSD unit 969, the controller 970 and the like are connected to each other through a bus 972.

The optical block 961 is composed of a focus lens, a diaphragm mechanism and the like. The optical block 961 forms an optical image of the subject on an imaging area of the image taking unit 962. The image taking unit 962 composed of a CCD or a CMOS image sensor generates an electric signal according to the optical image by photoelectric conversion and supplies the same to the camera signal processor 963.

The camera signal processor 963 applies various camera signal processes such as Knee correction, gamma correction, and color correction to the electric signal supplied from the image taking unit 962. The camera signal processor 963 supplies the image data after the camera signal process to the image data processor 964.

The image data processor 964 performs an encoding process of the image data supplied from the camera signal processor 963. The image data processor 964 supplies encoded data generated by the encoding process to the external interface unit 966 and the media drive 968. The image data processor 964 also performs a decoding process of the encoded data supplied from the external interface unit 966 and the media drive 968. The image data processor 964 supplies the image data generated by the decoding process to the display unit 965. The image data processor 964 performs a process to supply the image data supplied from the camera signal processor 963 to the display unit 965 and superimpose data for display obtained from the OSD unit 969 on the image data to supply to the display unit 965.

The OSD unit 969 generates the data for display such as a menu screen and an icon formed of a sign, a character, or a figure and outputs the same to the image data processor 964.

The external interface unit 966 is composed of a USB input/output terminal and the like, for example, and is connected to a printer when the image is printed. A drive is connected to the external interface unit 966 as needed, a removable medium such as a magnetic disk and an optical disk is appropriately mounted thereon, and a computer program read therefrom is installed as needed. Further, the external interface unit 966 includes a network interface connected to a predetermined network such as a LAN and the Internet. The controller 970 may read the encoded data from the memory unit 967 and supply the same from the external interface unit 966 to another device connected through the network according to an instruction from the user interface unit 971, for example. The controller 970 may also obtain the encoded data and the image data supplied from another device through the network through the external interface unit 966 and supply the same to the image data processor 964.

An optional readable/writable removable medium such as the magnetic disk, a magneto-optical disk, the optical disk, and a semiconductor memory, for example, is used as a recording medium driven by the media drive 968. An optional type of the removable medium may be used as the recording medium: this may be a tape device, a disk, or a memory card. Of course, a non-contact IC card and the like may be used.

It is also possible to integrate the media drive 968 and the recording medium such that this is composed of a non-portable storage medium as an embedded hard disk drive, an SSD (Solid State Drive) and the like, for example.

The controller 970 is composed of a CPU, a memory and the like. The memory stores the program executed by the CPU, various data necessary for the CPU to perform a process and the like. The program stored in the memory is read by the CPU at predetermined timing such as on start-up of the image taking device 960 to be executed. The CPU executes the program to control each unit such that the image taking device 960 operates according to user operation.

In the image taking device configured in this manner, the image data processor 964 is provided with a function of the image processing device (image processing method) of this application. Therefore, it is possible to improve the image quality of the decoded image.

Meanwhile, the embodiment of this technology is not limited to the above-described embodiment and various modifications may be made without departing from the scope of this technology.

That is to say, this technology is not limited to the encoding and the decoding using the MVC of the parallax image (parallax information image).

This technology is applicable to the encoding to at least quantize the image having the value corresponding to predetermined data as the pixel value being the image in which the possible value as the pixel value is defined to a predetermined defined value according to the maximum value and the minimum value of predetermined data and to the decoding to at least inversely quantize an encoded result.

### REFERENCE SIGNS LIST

11, 12, 21, 22 Encoder, 31 DPB, 32 Multiplexing unit, 41, 42 Camera, 43 Multi-view image information generating unit, 111 A/D converting unit, 112 Screen rearrangement buffer, 113 Calculation unit, 114 Orthogonal transform unit, 115 Quantization unit, 116 Variable-length coding unit, 117 Accumulation buffer, 118 Inverse quantization unit, 119 Inverse orthogonal transform unit, 120 Calculation unit, 121 Deblocking filter, 122 In-screen prediction unit, 123 Inter prediction unit, 124 Predicted image selecting unit, 211 A/D converting unit, 212 Screen rearrangement buffer, 213 Calculation unit, 214 Orthogonal transform unit, 215 Quantization unit, 216 Variable-length coding unit, 217 Accumulation buffer, 218 Inverse quantization unit, 219 Inverse orthogonal transform unit, 220 Calculation unit, 221 Deblocking filter, 222 In-screen prediction unit, 223 Inter prediction unit, 224 Predicted image selecting unit, 231 Mapping information generating unit, 232 Correcting unit, 251 Pixel value changing unit, 252 Pixel value correcting unit, 301 Separating unit, 311, 312, 321, 322 Decoder, 331 DPB, 341 Accumulation buffer, 342 Variable-length decoding unit, 343 Inverse quantization unit, 344 Inverse orthogonal transform unit, 345 Calculation unit, 346 Deblocking filter, 347 Screen rearranging unit, 348 D/A converting unit, 349 In-screen prediction unit, 350 Inter prediction unit, 351 Predicted image selecting unit, 441 Accumulation buffer, 442 Variable-length decoding unit, 443 Inverse quantization unit, 444 Inverse orthogonal transform unit, 445 Calculation unit, 446 Deblocking filter, 447 Screen rearranging unit, 448 D/A converting unit, 449 In-screen prediction unit, 450 Inter prediction unit, 451 Predicted image selecting unit, 461 Mapping information generating unit, 462 Correcting unit, 471 Pixel value correcting unit, 501 Threshold setting unit, 532 Correcting unit, 552 Pixel value correcting unit, 601 Threshold setting unit, 662 Correcting unit, 671 Pixel value changing unit, 672 Pixel value correcting unit, 801 Bus, 802 CPU, 803 ROM, 804 RAM, 805 Hard disk, 806 Output unit, 807 Input unit, 808 Communication unit, 809 Drive, 810 Input/output interface, 811 Removable recording medium

1. An image processing device, comprising:
a correcting unit, which corrects a pixel value of a decoded image obtained by at least quantizing and inversely quantizing an image having a value corresponding to predetermined data as a pixel value being the image in which a possible value as the pixel value is defined to a predetermined defined value according to a maximum value and a minimum value of the predetermined data to the defined value.

2. The image processing device according to claim 1, wherein
the correcting unit corrects the pixel value of the decoded image to the defined value the closest to the pixel value.

3. The image processing device according to claim 2, wherein
the correcting unit corrects the pixel value of the decoded image to the defined value the closest to the pixel value or leaves the pixel value unchanged based on a difference between a pixel value after change obtained by changing the pixel value of the decoded image to the defined value the closest to the pixel value and a pixel value of an original image and a difference between the pixel value of the decoded image and the pixel value of the original image.

4. The image processing device according to claim 3, wherein
the correcting unit outputs a correction flag indicating whether to correct the pixel value of the decoded image to the defined value the closest to the pixel value or leave the pixel value unchanged.

5. The image processing device according to claim 2, wherein
the correcting unit obtains a correction flag indicating whether to correct the pixel value of the decoded image to the defined value the closest to the pixel value or leave the pixel value unchanged and corrects the pixel value of the decoded image to the defined value the closest to the pixel value or leaves the pixel value unchanged based on the correction flag.

6. The image processing device according to claim 2, wherein
the correcting unit corrects the pixel value of the decoded image to the defined value the closest to the pixel value or leaves the pixel value unchanged based on a difference between the maximum value and the minimum value of the predetermined data.

7. The image processing device according to claim 2, wherein
the correcting unit corrects the pixel value of the decoded image to the defined value the closest to the pixel value or leaves the pixel value unchanged based on a quantization step to quantize the image.

8. The image processing device according to claim 7, wherein
the correcting unit leaves the pixel value of the decoded image unchanged when the quantization step is larger than a predetermined threshold, and
corrects the pixel value of the decoded image to the defined value the closest to the pixel value when the quantization step is not larger than the predetermined threshold,
the image processing device further comprising:
a threshold setting unit, which sets the predetermined threshold based on a difference between the maximum value and the minimum value of the predetermined data.

9. The image processing device according to claim 1, wherein
the image is a depth image having depth information regarding parallax of each pixel of a color image as the pixel value.

10. An image processing method, comprising a step of:
correcting a pixel value of a decoded image obtained by at least quantizing and inversely quantizing an image having a value corresponding to predetermined data as a pixel value being the image in which a possible value as the pixel value is defined to a predetermined defined value according to a maximum value and a minimum value of the predetermined data to the defined value.

11. A program, which allows a computer to serve as:
a correcting unit, which corrects a pixel value of a decoded image obtained by at least quantizing and inversely quantizing an image having a value corresponding to predetermined data as a pixel value being the image in which a possible value as the pixel value is defined to a predetermined defined value according to a maximum value and a minimum value of the predetermined data to the defined value.
